(19) United States
(12) Patent Application Publication
(10) Pub. No.: US 2026/0155756 A1
(43) Pub. Date: Jun. 4, 2026

(54) ASK MODULATION CIRCUIT AND METHOD, AND WIRELESS CHARGING RECEIVER

(71) Applicant: Zhuhai Nanxin Semiconductor Technology Co., Ltd., Zhuhai City (CN)

(72) Inventors: Lixu Gao, Zhuhai City (CN); Zhuoneng Li, Zhuhai City (CN)

(21) Appl. No.: 19/318,061

(22) Filed: Sep. 3, 2025

(30) Foreign Application Priority Data
Dec. 4, 2024 (CN) 202411776528.8

(51) Int. Cl. H02M 7/219; H02J 50/10

(52) U.S. Cl. CPC H02M 7/219; H02J 50/10

(57) ABSTRACT

An ASK modulation circuit includes a logic control circuit, a rectifier circuit, and a constant-current source circuit. The logic control circuit controls, within a dead time period, a discharging current or an injection current is transmitted through a first node and a second node, such that change rates of voltages at the first node and the second node increase or decrease respectively, that is, the change rates of the voltages at the first node and the second node change respectively. In this way, a current in the receive coil changes, and hence a current in a transmit coil changes, such that ASK modulation is achieved. In this way, ASK modulation is not affected while the off-chip capacitors, the on-chip switching transistors, and the chip pins are reduced or eliminated.

### CROSS-REFERENCE TO RELATED APPLICATION

This application is based upon and claims the priority of Chinese Patent Application No. 202411776528.8, filed on December 4, 2024, the entire content of which is hereby incorporated by reference herein and made a part of this specification.

### TECHNICAL FIELD

The present disclosure relates to the technical field of power management chips, and in particular, relates to an amplitude shift keying (ASK) modulation circuit and method, and a wireless charging receiver.

### BACKGROUND

A wireless charging system typically includes a wireless charging transmitter and a wireless charging receiver. Various control signals may be generated based on operational parameters of the wireless charging receiver. These control signals may be transmitted from the wireless charging receiver to the wireless charging transmitter. In particular, the control signals may be transmitted from a receive coil of the wireless charging receiver to a transmit coil of the wireless charging transmitter in the form of modulated signals using an appropriate modulation scheme. ASK is a widely adopted modulation scheme in the wireless charging system. ASK is achieved by modulating amplitudes of analog signals in the wireless charging system, wherein information is transmitted via the amplitude changes of the analog signals.

Referring to FIG. 1, FIG. (2a), and FIG. 2(b), in the related art of the wireless charging system, by controlling six modulation switches K1 to K6, six capacitors C1 to C6 are connected or disconnected between a first end point AC1_1 and a second end point AC2_1. By connection and disconnection of the capacitors, modulation is implemented to affect waveforms of currents at a receiver and a transmitter, such that a peak voltage of an induced voltage VCOIL changes, and hence ASK modulation is achieved.

### SUMMARY

Embodiments of the present disclosure provide an ASK modulation circuit and method applicable to wireless charging receivers, and a wireless charging receiver. In this way, ASK modulation is not affected while the off-chip capacitors, the on-chip switching transistors, and the chip pins are reduced or eliminated.

In a first aspect, the embodiments of the present disclosure provide an ASK modulation circuit. The ASK modulation circuit includes a logic control circuit, a rectifier circuit, and a constant-current source circuit.

The logic control circuit is electrically connected to the constant-current source circuit; the rectifier circuit includes a first bridge arm and a second bridge arm. The first bridge arm and the second bridge arm are connected in parallel, and the first bridge arm includes a first switching transistor and a second switch transistor, wherein the second bridge arm includes a third switching transistor and a fourth switching transistor, the first switching transistor and the second switching transistor are connected in series, and the third switching transistor and the fourth switching transistor are connected in series. The constant-current source circuit includes a first constant-current assembly, a second constant-current assembly, a third constant-current assembly, and a fourth constant-current assembly, wherein the first constant-current assembly is connected in parallel between a first terminal and a second terminal of the first switching transistor, the second constant-current assembly is connected in parallel between a first terminal and a second terminal of the second switching transistor, the third constant-current assembly is connected in parallel between a first terminal and the second terminal of the third switching transistor, and the fourth constant-current assembly is connected in parallel between a first terminal and a second terminal of the fourth switching transistor. The first constant-current assembly includes a first constant-current source and a first switch, wherein the first constant-current source and the first switch are connected in series. The second constant-current assembly includes a second constant-current source and a second switch, wherein the second constant-current source and the second switch are connected in series. The third constant-current assembly includes a third constant-current source and a third switch, wherein the third constant-current source and the third switch are connected in series. The fourth constant-current assembly includes a fourth constant-current source and a fourth switch, wherein the fourth constant-current source and the fourth switch are connected in series. A connection point between the second terminal of the first switching transistor and the first terminal of the second switching transistor acts as a first node, and a connection point between the second terminal of the third switching transistor and the first terminal of the fourth switching transistor acts as a second node.

The logic control circuit is configured to: within a first dead time period, control the first node to transmit a discharging current to the ground via the second constant-current assembly, or control the first node to transmit a discharging current to the ground via the second constant-current assembly and the third constant-current assembly to transmit an injection current to the second node; or within a second dead time period, control the first constant-current assembly to transmit an injection current to the first node, or control the first constant-current assembly to transmit an injection current to the first node and the second node to transmit a discharging current to the ground via the fourth constant-current assembly.

Alternatively, the logic control circuit is further configured to: within a first dead time period, control the first constant-current assembly to transmit an injection current to the first node, or control the first constant-current assembly to transmit an injection current to the first node and the second node to transmit a discharging current to the ground via the fourth constant-current assembly; or within a second dead time period, control the first node to transmit a discharging current to the ground via the second constant-current assembly, or control the first node to transmit a discharging current to the ground via the second constant-current assembly and the third constant-current assembly to transmit an injection current to the second node.

The first dead time period is a process where a voltage at the first node falls and a voltage at the second node rises, or the second dead time period is a process where a voltage at the first node rises and a voltage at the second node falls.

In some embodiments, with respect to a full-bridge operating state: in a modulation mode, the logic control circuit is configured to: within the first dead time period, control the second switch and the third switch to switch from an off state to an on state, such that the first node transmits the discharging current the ground via the second switch and the second constant-current source and the third constant-current source transmits the injection current to the second node via the third switch; or within the second dead time period, control the first switch and the fourth switch to switch from an off state to an on state, such that the first constant-current source transmits the injection current to the first node via the first switch and the second node transmits the discharging current to the ground via the fourth switch and the fourth constant-current source; or in a non-modulation mode, the logic control circuit is configured to control the first switch, the second switch, the third switch, and the fourth switch to be in an off state.

In some embodiments, with respect to a full-bridge operating state: in a non-modulation mode, the logic control circuit is configured to: within the first dead time period, control the second switch and the third switch to switch from an off state to an on state, such that the first node transmits the discharging current to the ground via the second switch and the second constant-current source and the third constant-current source transmits the injection current to the second node via the third switch; or within the second dead time period, control the first switch and the fourth switch to switch from an off state to an on state, such that the first constant-current source transmits the injection current to the first node via the first switch and the second node transmits the discharging current to the ground via the fourth switch and the fourth constant-current source; or in a modulation mode, the logic control circuit is configured to control the first switch, the second switch, the third switch, and the fourth switch to be in an off state.

In some embodiments, with respect to a full-bridge operating state: in a modulation mode, the logic control circuit is configured to: within the first dead time period, control the first switch and the fourth switch to switch from an off state to an on state, such that the first constant-current source transmits the injection current to the first node via the first switch and the second node transmits the discharging current to the ground via the fourth switch and the fourth constant-current source; or within the second dead time period, control the second switch and the third switch to switch from an off state to an on state, such that the first node transmits the discharging current to the ground via the second switch and the second constant-current source and the third constant-current source transmits the injection current to the second node via the third switch; or in a non-modulation mode, the logic control circuit is configured to control the first switch, the second switch, the third switch, and the fourth switch to be in an off state.

In some embodiments, with respect to a full-bridge operating state: in a non-modulation mode, the logic control circuit is configured to: within the first dead time period, control the first switch and the fourth switch to switch from an off state to an on state, such that the first constant-current source transmits the injection current to the first node via the first switch and the second node transmits the discharging current to the ground via the fourth switch and the fourth constant-current source; or within the second dead time period, control the second switch and the third switch to switch from an off state to an on state, such that the first node transmits the discharging current to the ground via the second switch and the second constant-current source and the third constant-current source transmits the injection current to the second node via the third switch; or in a modulation mode, the logic control circuit is configured to control the first switch, the second switch, the third switch, and the fourth switch to be in an off state.

In some embodiments, with respect to a half-bridge operating state: in a modulation mode, the logic control circuit is configured to: within the first dead time period, control the second switch to switch from an off state to an on state, such that the first node transmits the discharging current to the ground via the second switch and the second constant-current source; or within the second dead time period, control the first switch to switch from an off state to an on state, such that the first constant-current source transmits the injection current to the first node via the first switch; or in a non-modulation mode, the logic control circuit is configured to control the first switch, the second switch, the third switch, and the fourth switch to be in an off state.

In some embodiments, with respect to a half-bridge operating state: in a non-modulation mode, the logic control circuit is configured to: within the first dead time period, control the second switch to switch from an off state to an on state, such that the first node transmits the discharging current to the ground via the second switch and the second constant-current source; or within the second dead time period, control the first switch to switch from an off state to an on state, such that the first constant-current source transmits the injection current to the first node via the first switch; or in a modulation mode, the logic control circuit is configured to control the first switch, the second switch, the third switch, and the fourth switch to be in an off state.

In some embodiments, with respect to a half-bridge operating state: in a modulation mode, the logic control circuit is configured to: within the first dead time period, control the first switch to switch from an off state to an on state, such that the first constant-current source transmits the injection current to the first node via the first switch; or within the second dead time period, control the second switch to switch from an off state to an on state, such that the first node transmits the discharging current to the ground via the second switch and the second constant-current source; or in a non-modulation mode, the logic control circuit is configured to control the first switch, the second switch, the third switch, and the fourth switch to be in an off state.

In some embodiments, with respect to a half-bridge operating state: in a non-modulation mode, the logic control circuit is configured to: within the first dead time period, control the first switch to switch from an off state to an on state, such that the first constant-current source transmits the injection current to the first node via the first switch; or within the second dead time period, control the second switch to switch from an off state to an on state, such that the first node transmits the discharging current to the ground via the second switch and the second constant-current source; or in a modulation mode, the logic control circuit is configured to control the first switch, the second switch, the third switch, and the fourth switch to be in an off state.

In some embodiments, the logic control circuit is configured to, within a non-dead time period, control the first switch, the second switch, the third switch, and the fourth switch to be in an off state, wherein the non-dead time period is a process where the voltage at the first node and the voltage at the second node both remain unchanged.

In a second aspect, the embodiments of the present disclosure provide an ASK modulation method, applicable to the ASK modulation circuit according to the first aspect. The method includes: within a first dead time period, controlling, by the logic control circuit, the first node to transmit a discharging current to the ground via the second constant-current assembly, or controlling, by the logic control circuit, the first node to transmit a discharging current to the ground via the second constant-current assembly and the third constant-current assembly to transmit an injection current to the second node; or within a second dead time period, controlling, by the logic control circuit, the first constant-current assembly to transmit an injection current to the first node, or controlling, by the logic control circuit, the first constant-current assembly to transmit an injection current to the first node and the second node to transmit a discharging current to the ground via the fourth constant-current assembly.

Alternatively, within a first dead time period, controlling, by the logic control circuit, the first constant-current assembly to transmit an injection current to the first node, or controlling, by the logic control circuit, the first constant-current assembly to transmit an injection current to the first node and the second node to transmit a discharging current to the ground via the fourth constant-current assembly; or within a second dead time period, controlling, by the logic control circuit, the first node to transmit a discharging current to the ground via the second constant-current assembly, or controlling, by the logic control circuit, the first node to transmit a discharging current to the ground via the second constant-current assembly and the third constant-current assembly to transmit an injection current to the second node.

The first dead time period is a process where a voltage at the first node falls and a voltage at the second node rises, and the second dead time period is a process where a voltage at the first node rises and a voltage at the second node falls.

In some embodiments, the method includes: with respect to a full-bridge operating state: in a modulation mode, within the first dead time period, controlling, by the logic control circuit, the second switch and the third switch to switch from an off state to an on state, such that the first node transmits the discharging current to the ground via the second switch and the second constant-current source and the third constant-current source transmits the injection current to the second node via the third switch; or within the second dead time period, controlling, by the logic control circuit, the first switch and the fourth switch to switch from an off state to an on state, such that the first constant-current source transmits the injection current to the first node via the first switch and the second node transmits the discharging current to the ground via the fourth switch and the fourth constant-current source; or in a non-modulation mode, controlling, by the logic control circuit, the first switch, the second switch, the third switch, and the fourth switch to be in an off state.

In some embodiments, the method includes: with respect to a full-bridge operating state: in a non-modulation mode, within the first dead time period, controlling, by the logic control circuit, the second switch and the third switch to switch from an off state to an on state, such that the first node transmits the discharging current to the ground via the second switch and the second constant-current source and the third constant-current source transmits the injection current to the second node via the third switch; or within the second dead time period, controlling, by the logic control circuit, the first switch and the fourth switch to switch from an off state to an on state, such that the first constant-current source transmits the injection current to the first node via the first switch and the second node transmits the discharging current to the ground via the fourth switch and the fourth constant-current source; or in a modulation mode, controlling, by the logic control circuit, the first switch, the second switch, the third switch, and the fourth switch to be in an off state.

In some embodiments, the method includes: with respect to a full-bridge operating state: in a modulation mode, within the first dead time period, controlling, by the logic control circuit, the first switch and the fourth switch to switch from an off state to an on state, such that the first constant-current source transmits the injection current to the first node via the first switch and the second node transmits the discharging current to the ground via the fourth switch and the fourth constant-current source; or within the second dead time period, controlling, by the logic control circuit, the second switch and the third switch to switch from an off state to an on state, such that the first node transmits the discharging current to the ground via the second switch and the second constant-current source and the third constant-current source transmits the injection current to the second node via the third switch; or in a non-modulation mode, controlling, by the logic control circuit, the first switch, the second switch, the third switch, and the fourth switch to be in an off state.

In some embodiments, the method includes: with respect to a full-bridge operating state: in a non-modulation mode, within the first dead time period, controlling, by the logic control circuit, the first switch and the fourth switch to switch from an off state to an on state, such that the first constant-current source transmits the injection current to the first node via the first switch and the second node transmits the discharging current to the ground via the fourth switch and the fourth constant-current source; or within the second dead time period, controlling, by the logic control circuit, the second switch and the third switch to switch from an off state to an on state, such that the first node transmits the discharging current to the ground via the second switch and the second constant-current source and the third constant-current source transmits the injection current to the second node via the third switch; or in a modulation mode, controlling the first switch, the second switch, the third switch, and the fourth switch to be in an off state.

In some embodiments, the method includes: with respect to a half-bridge operating state: in a modulation mode, within the first dead time period, controlling, by the logic control circuit, the second switch to switch from an off state to an on state, such that the first node transmits the discharging current to the ground via the second switch and the second constant-current source; or within the second dead time period, controlling, by the logic control circuit, the first switch to switch from an off state to an on state, such that the first constant-current source transmits the injection current to the first node via the first switch; or in a non-modulation mode, controlling the first switch, the second switch, the third switch, and the fourth switch to be in an off state.

In some embodiments, the method includes: with respect to a half-bridge operating state: in a non-modulation mode, within the first dead time period, controlling, by the logic control circuit, the second switch to switch from an off state to an on state, such that the first node transmits the discharging current to the ground via the second switch and the second constant-current source; or within the second dead time period, controlling, by the logic control circuit, the first switch to switch from an off state to an on state, such that the first constant-current source transmits the injection current to the first node via the first switch; or in a modulation mode, controlling the first switch, the second switch, the third switch, and the fourth switch to be in an off state.

In some embodiments, the method includes: with respect to a half-bridge operating state: in a modulation mode, within the first dead time period, controlling, by the logic control circuit, the first switch to switch from an off state to an on state, such that the first constant-current source transmits the injection current to the first node via the first switch; or within the second dead time period, controlling, by the logic control circuit, the second switch to switch from an off state to an on state, such that the first node transmits the discharging current to the ground via the second switch and the second constant-current source; or in a non-modulation mode, controlling the first switch, the second switch, the third switch, and the fourth switch to be in an off state.

In some embodiments, the method includes: with respect to a half-bridge operating state: in a non-modulation mode, within the first dead time period, controlling, by the logic control circuit, the first switch to switch from an off state to an on state, such that the first constant-current source transmits the injection current to the first node via the first switch; or within the second dead time period, controlling, by the logic control circuit, the second switch to switch from an off state to an on state, such that the first node transmits the discharging current to the ground via the second switch and the second constant-current source; or in a modulation mode, controlling the first switch, the second switch, the third switch, and the fourth switch to be in an off state.

In a third aspect, the embodiments of the present disclosure provide a wireless charging receiver. The wireless charging receiver includes a receive coil, and the rectifier circuit, the logic control circuit and the constant-current source circuit according to the first aspect.

The receive coil is electrically connected to the rectifier circuit, the logic control circuit is electrically connected to the constant-current source circuit, and the constant-current source circuit is electrically connected to the rectifier circuit.

The logic control circuit is configured to modulate a control signal using the ASK modulation method according to the second aspect, and transmit, via the receive coil, the modulated control signal to the transmit coil magnetically coupled to the receive coil, wherein the control signal is modulated by controlling the constant-current source circuit to change a current of the receive coil.

However, in the embodiments of the present disclosure, in the modulation mode, the logic control circuit controls, within the dead time period, the constant-current source circuit to introduce the discharging current or the injection current to the first node and the second node, such that the change rates of the voltages at the first node and the second node increase or decrease respectively, that is, the change rates of the voltages at the first node and the second node change respectively, which equivalently changes an output impedance of the receiver. In this way, a current in the receive coil changes, and hence a current in a transmit coil changes, such that ASK modulation is achieved. In this way, ASK modulation is not affected while the off-chip capacitors, the on-chip switching transistors, and the chip pins are reduced or eliminated.

For details about the beneficial effects achieved by the method according to the second aspect and the embodiments of the second aspect, reference may be made to the beneficial effects achieved by the first aspect or any embodiment of the first aspect, which are not described herein any further.

### BRIEF DESCRIPTION OF THE DRAWINGS

For clearer descriptions of the technical solutions according to the embodiments of the present disclosure or in the prior art, drawings that are to be referred for description of the embodiments or the prior art are briefly described hereinafter. Apparently, the drawings described hereinafter merely illustrate some embodiments of the present disclosure. Persons of ordinary skill in the art may also derive other embodiments based on the drawings described herein.

FIG. 1 illustrates an ASK modulation circuit in the related art;

FIG. 2(a) illustrates a schematic diagram of an ASK modulation waveform in the related art;

FIG. 2(b) illustrates a timing diagram of an ASK modulation circuit in the related art;

FIG. 3 is a schematic structural diagram of an ASK modulation circuit according to some embodiments of the present disclosure;

FIG. 4(a) illustrates a schematic circuit control diagram of a first non-dead time period in a non-modulation mode according to a first embodiment of the present disclosure;

FIG. 4(b) illustrates a schematic circuit control diagram of a first dead time period in a non-modulation mode according to the first embodiment of the present disclosure;

FIG. 4(c) illustrates a schematic circuit control diagram of a second non-dead time period in a non-modulation mode according to the first embodiment of the present disclosure;

FIG. 4(d) illustrates a schematic circuit control diagram of a second dead time period in a non-modulation mode according to the first embodiment of the present disclosure;

FIG. 4(e) illustrates a schematic circuit control diagram of a first non-dead time period in a modulation mode according to some embodiments of the present disclosure;

FIG. 4(f) illustrates a schematic circuit control diagram of a first dead time period in a modulation mode according to the first embodiment of the present disclosure;

FIG. 4(g) illustrates a schematic circuit control diagram of a second non-dead time period in a modulation mode according to some embodiments of the present disclosure;

FIG. 4(h) illustrates a schematic circuit control diagram of a second dead time period in a modulation mode according to the first embodiment of the present disclosure;

FIG. 5 illustrates a timing diagram according to the first embodiment of the present disclosure;

FIG. 6 illustrates a logic control circuit according to the first embodiment of the present disclosure;

FIG. 7(a) illustrates a schematic circuit control diagram of a first non-dead time period in a non-modulation mode according to a second embodiment of the present disclosure;

FIG. 7(b) illustrates a schematic circuit control diagram of a first dead time period in a non-modulation mode according to the second embodiment of the present disclosure;

FIG. 7(c) illustrates a schematic circuit control diagram of a second non-dead time period in a non-modulation mode according to the second embodiment of the present disclosure;

FIG. 7(d) illustrates a schematic circuit control diagram of a second dead time period in a non-modulation mode according to the second embodiment of the present disclosure;

FIG. 7(e) illustrates a schematic circuit control diagram of a first non-dead time period in a modulation mode according to the second embodiment of the present disclosure;

FIG. 7(f) illustrates a schematic circuit control diagram of a first dead time period in a modulation mode according to the second embodiment of the present disclosure;

FIG. 7(g) illustrates a schematic circuit control diagram of a second non-dead time period in a modulation mode according to the second embodiment of the present disclosure;

FIG. 7(h) illustrates a schematic circuit control diagram of a second dead time period in a modulation mode according to the second embodiment of the present disclosure;

FIG. 8 illustrates a timing diagram according to the second embodiment of the present disclosure;

FIG. 9 illustrates a logic control circuit according to the second embodiment of the present disclosure;

FIG. 10(a) illustrates a schematic circuit control diagram of a first non-dead time period in a non-modulation mode according to a third embodiment of the present disclosure;

FIG. 10(b) illustrates a schematic circuit control diagram of a first dead time period in a non-modulation mode according to the third embodiment of the present disclosure;

FIG. 10(c) illustrates a schematic circuit control diagram of a second non-dead time period in a non-modulation mode according to the third embodiment of the present disclosure;

FIG. 10(d) illustrates a schematic circuit control diagram of a second dead time period in a non-modulation mode according to the third embodiment of the present disclosure;

FIG. 10(e) illustrates a schematic circuit control diagram of a first non-dead time period in a modulation mode according to the third embodiment of the present disclosure;

FIG. 10(f) illustrates a schematic circuit control diagram of a first dead time period in a modulation mode according to the third embodiment of the present disclosure;

FIG. 10(g) illustrates a schematic circuit control diagram of a second non-dead time period in a modulation mode according to the third embodiment of the present disclosure;

FIG. 10(h) illustrates a schematic circuit control diagram of a second dead time period in a modulation mode according to the third embodiment of the present disclosure;

FIG. 11 illustrates a timing diagram according to the third embodiment of the present disclosure;

FIG. 12 illustrates a logic control circuit according to the third embodiment of the present disclosure;

FIG. 13(a) illustrates a schematic circuit control diagram of a first non-dead time period in a non-modulation mode according to a fourth embodiment of the present disclosure;

FIG. 13(b) illustrates a schematic circuit control diagram of a first dead time period in a non-modulation mode according to the fourth embodiment of the present disclosure;

FIG. 13(c) illustrates a schematic circuit control diagram of a second non-dead time period in a non-modulation mode according to the fourth embodiment of the present disclosure;

FIG. 13(d) illustrates a schematic circuit control diagram of a second dead time period in a non-modulation mode according to the fourth embodiment of the present disclosure;

FIG. 13(e) illustrates a schematic circuit control diagram of a first non-dead time period in a modulation mode according to the fourth embodiment of the present disclosure;

FIG. 13(f) illustrates a schematic circuit control diagram of a first dead time period in a modulation mode according to the fourth embodiment of the present disclosure;

FIG. 13(g) illustrates a schematic circuit control diagram of a second non-dead time period in a modulation mode according to the fourth embodiment of the present disclosure;

FIG. 13(h) illustrates a schematic circuit control diagram of a second dead time period in a modulation mode according to the fourth embodiment of the present disclosure;

FIG. 14 illustrates a timing diagram according to the fourth embodiment of the present disclosure;

FIG. 15 illustrates a logic control circuit according to the fourth embodiment of the present disclosure; and

FIG. 16 is a schematic flowchart of an ASK modulation method according to the fourth embodiment of the present disclosure.

### DETAILED DESCRIPTION

In the present disclosure, the term "at least one" refers to one or more than one, and the term "a plurality of" refers to two or more than two. The term "and/or" is merely an association relationship for describing associated objects, which represents that there may exist three types of relationships. For example, the phrase "A and/or B" means (A), (B), or (A and B), wherein A and B may be single or plural. In addition, the symbol "/" generally represents an "or" relationship between associated objects before and after the symbol. The expression "at least one of the following" or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms "first," "second," and the like are merely for the illustration purpose, and shall not be construed as indicating or implying a relative importance.

In the description of the present disclosure, it should be understood that the terms "central," "transversal," "longitudinal," "upper," "lower," "left," "right," "front," "rear," and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms "connected," "coupled," and derivatives forms thereof shall be understood in a broad sense. For example, the terms "connected," "coupled," and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is conducted, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

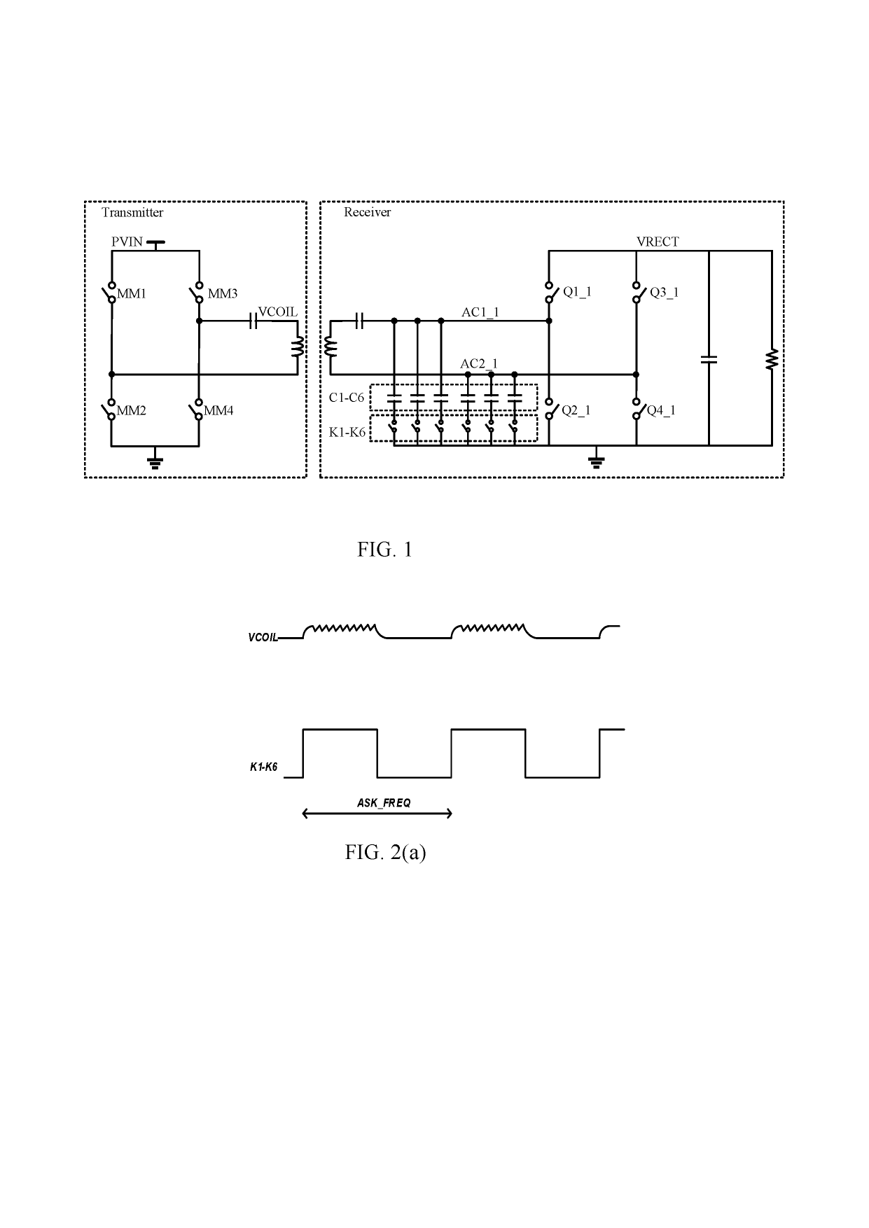

Referring to FIG. 1, in the related art of a wireless charging system, by controlling states of six modulation switches K1 to K6, six capacitors C1 to C6 are connected or disconnected between a first end point AC1_1 and a second end point AC2_1. By connection and disconnection of the capacitors, waveforms of currents at a receiver and a transmitter are affected, as illustrated in FIG. 2(a) and FIG. 2(b), such that a peak voltage of an induced voltage VCOIL changes, and hence ASK modulation is achieved.

As illustrated in FIG. 1, at the receiver, a rectifier circuit includes a first power transistor Q1_1, a second power transistor Q2_1, a third power transistor Q3_1, and a fourth power transistor Q4_1; a first rectifier branch includes the first power transistor Q1_1 and the fourth power transistor Q4_1; and a second rectifier branch includes the second power transistor Q2_1 and the third power transistor Q3_1. The first power transistor Q1_1 acts as an upper transistor of the first rectifier branch and the fourth power transistor Q4_1 acts as a lower transistor of the first rectifier branch, and the second power transistor Q2_1 acts as a lower transistor of the second rectifier branch and the third power transistor Q3_1 acts as an upper transistor of the second rectifier branch. At different phases of an alternating current signal, the first rectifier branch or the second rectifier branch is controlled to be conducted, and the rectifier circuit converts an alternating current signal of the receive coil to a direct current signal.

The capacitors C1 to C6 are off-chip capacitors, which are connected outside an ASK modulation chip by a user during operation. The modulation switches K1 to K6 are on-chip transistors, which are arranged inside the ASK modulation chip. In this case, corresponding chip pins need to be arranged in the ASK modulation chip to connect the off-chip capacitors to the external of the ASK modulation chip, and hence ASK modulation is achieved.

Specific waveforms of ASK modulation are illustrated in FIG. 2. By detecting voltages at the first end point AC1_1 and the second end point AC2_1, states of the first power transistor Q1_1, the second power transistor Q2_1, the third power transistor Q3_1, and the fourth power transistor Q4_1 are controlled. Specifically, according to change regularity of the voltages at the first end point AC1_1 and the second end point AC2_1, as illustrated in FIG. 2, within one cycle, a process where the voltages at the first end point AC1_1 and the second end point AC2_1 remain unchanged is referred to as a non-dead time period, and a process where the voltages at the first end point AC1_1 and the second end point AC2_1 change is referred to as a dead time period. In the non-dead time period, by controlling the first rectifier branch and the second rectifier branch to be alternatively conducted, the alternating current signal of the receive coil is converted to the direct current signal; and within the dead time period, the first rectifier branch and the second rectifier branch perform state switching, and during this course, power switches of the first rectifier branch and the second rectifier branch are all in an off state.

To ensure the effect of ASK modulation, in the related art, typically a plurality of off-chip capacitors, on-chip switching transistors, and chip pins need to be used. As a result, the area of an ASK modulation chip and the cost of the entire circuit are both increased. Where the area of the ASK modulation chip and the cost of the entire circuit are reduced by reducing the off-chip capacitors, on-chip switching transistors, and chip pins, ASK modulation may have a poor effect in some application scenarios.

In view of deficiencies of the related art, some embodiments of the present disclosure provide an ASK modulation circuit and method, a wireless charging receiver, a chip, and an electronic device. In this way, ASK modulation is not affected while the off-chip capacitors, the on-chip switching transistors, and the chip pins are reduced or eliminated.

The ASK modulation circuit applicable to a wireless charging receiver may be a chip or a circuit module.

The ASK modulation circuit applicable to a wireless charging receiver may be integrated in a single chip, or may be integrated in different chips, which is not limited in the embodiments of the present disclosure.

In the present disclosure, the electronic device may include, but is not limited to, a smart phone, a wireless earphone, and an electric toothbrush that are equipped with a wireless charging function.

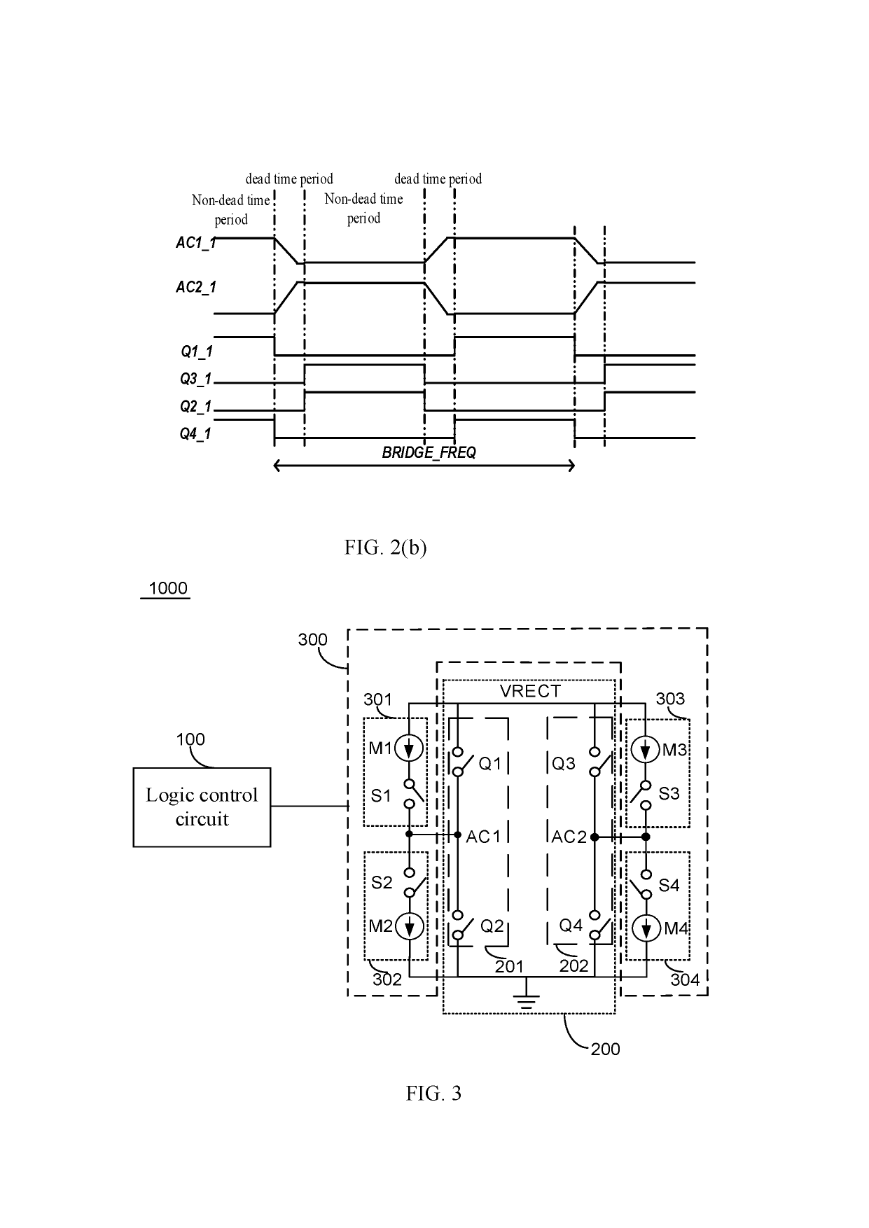

Referring to FIG. 3, an ASK modulation circuit 1000 according to some embodiments of the present disclosure is illustrated. The ASK modulation circuit 1000 is applicable to a wireless charging receiver. As illustrated in FIG. 3, the ASK modulation circuit 1000 may include a logic control circuit 100, a rectifier circuit 200, and a constant-current source circuit 300. The logic control circuit 100 is electrically connected to the constant-current source circuit 300. The rectifier circuit 200 includes a first bridge arm 201 and a second bridge arm 202. The first bridge arm 201 and the second bridge arm 202 are connected in parallel. The first bridge arm 201 includes a first switching transistor Q1 and a second switching transistor Q2. The second bridge arm 202 includes a third switching transistor Q3 and a fourth switching transistor Q4. The first switching transistor Q1 and the second switching transistor Q2 are connected in series. The third switching transistor Q3 and the fourth switching transistor Q4 are connected in series. The constant-current source circuit 300 includes a first constant-current assembly 301, a second constant-current assembly 302, a third constant-current assembly 303, and a fourth constant-current assembly 304. The first constant-current assembly 301 is connected in parallel between a first terminal and a second terminal of the first switching transistor Q1. The second constant-current assembly 302 is connected in parallel between a first terminal and a second terminal of the second switching transistor Q2. The third constant-current assembly 303 is connected in parallel between a first terminal and a second terminal of the third switching transistor Q3. The fourth constant-current assembly 304 is connected in parallel between a first terminal and a second terminal of the fourth switching transistor Q4. The first constant-current assembly 301 includes a first constant-current source M1 and a first switch S1. The first constant-current source M1 and the first switch S1 are connected in series. The second constant-current assembly 302 includes a second constant-current source M2 and a second switch S2. The second constant-current source M2 and the second switch S2 are connected in series. The third constant-current assembly 303 includes a third constant-current source M3 and a third switch S3. The third constant-current source M3 and the third switch S3 are connected in series. The fourth constant-current assembly 304 includes a fourth constant-current source M4 and a fourth switch S4. The fourth constant-current source M4 and the fourth switch S4 are connected in series. A connection point between the second terminal of the first switching transistor Q1 and the first terminal of the second switching transistor Q2 acts as a first node AC1. A connection point between the second terminal of the third switching transistor Q3 and the first terminal of the fourth switching transistor Q4 acts as a second node AC2.

The logic control circuit 100 is configured to: within a first dead time period, control a discharging current is transmitted from the first node AC1 to the ground, or control a discharging current is transmitted from the first node AC1 to the ground and an injection current is transmitted to the second node AC2; or within a second dead time period, control an injection current is transmitted to the first node AC1, or an injection current is transmitted to the first node AC1 and a discharging current is transmitted from the second node AC2 to the ground. In another example, the logic control circuit 100 is configured to: within a first dead time period, control an injection current is transmitted to the first node AC1, or control an injection current is transmitted to the first node AC1 and a discharging current is transmitted from the second node AC2 to the ground; or within a second dead time period, control a discharging current is transmitted from the first node AC1 to the ground, or control a discharging current is transmitted from the first node AC1 to the ground and an injection current is transmitted to the second node AC2; wherein the first dead time period is a process where a voltage at the first node AC1 falls and a voltage at the second node AC2 rises, or the second dead time period is a process where a voltage at the first node AC1 rises and a voltage at the second node AC2 falls.

The rectifier circuit 200 includes a first bridge arm 201 and a second bridge arm 202. The first bridge arm 201 and the second bridge arm 202 are connected in parallel between an output voltage VRECT and a ground. The first node AC1 is defined between the first switching transistor Q1 and the second switching transistor Q2. The second node AC2 is defined between the third switching transistor Q3 and the fourth switching transistor Q4. By controlling the first rectifier branch (i.e., the first switching transistor Q1 and the fourth switching transistor Q4) and the second rectifier branch (i.e., the third switching transistor Q3 and the second switching transistor Q2) to be alternately conducted, an alternating current signal of a receive coil is converted to a direct current signal. Generally, the first switching transistor Q1 and the fourth switching transistor Q4 in the first rectifier branch are simultaneously turned on or turned off, and the third switching transistor Q3 and the second switching transistor Q2 in the second rectifier branch are simultaneously turned on or turned off. The rectifier circuit is well known in the related art, and thus the specific connection and operating principle of the rectifier circuit are not described herein any further.

The process where the voltage at the first node AC1 and the voltage at the second node AC2 remain unchanged is referred to as a non-dead time period, and the process where the voltage at the first node AC1 and the voltage at the second node AC2 change is referred to as a dead time period. According to change regularity of the voltages at the first node AC1 and the second node AC2, within one cycle, the dead time period includes a first dead time period and a second dead time period, wherein the first dead time period is a process where the voltage at the first node AC1 falls and the voltage at the second node AC2 rises, and the second dead time period is a process where the voltage at the first node AC1 rises and the voltage at the second node AC2 falls; and within one cycle, the non-dead time period includes a first non-dead time period and a second non-dead time period, wherein the first non-dead time period is a process where the voltage at the first node AC1 remains unchanged after the voltage at the first node AC1 rises and the voltage at the second node AC2 remains unchanged after the voltage at the second node AC2 falls, and the second non-dead time period is a process where the voltage at the first node AC1 remains unchanged after the voltage at the first node AC1 falls and the voltage at the second node AC2 remains unchanged after the voltage at the second node AC2 rises.

Referring to FIG. 3, in the present disclosure, the constant-current source circuit is added into the conventional rectifier circuit. The constant-current source circuit includes the first constant-current assembly, the second constant-current assembly, the third constant-current assembly, and the fourth constant-current assembly. The first constant-current assembly is connected in parallel between the first terminal and the second terminal of the first switching transistor, the second constant-current assembly is connected in parallel between the first terminal and the second terminal of the second switching transistor, the third constant-current assembly is connected in parallel between the first terminal and the second terminal of the third switching transistor, and the fourth constant-current assembly is connected in parallel between the first terminal and the second terminal of the fourth switching transistor. The logic control circuit is electrically connected to the constant-current source circuit, specifically, the logic control circuit is electrically connected to control terminals of the first switch, the second switch, the third switch, and the fourth switch. By controlling on and off states of the switches, within the dead time period, currents are transmitted to the first node and the second node, such that change rates of the voltages at the first node and the second node change respectively, which equivalently changes an output impedance of a receiver. In this way, a current in the receive coil changes, and hence a current in a transmit coil changes, such that ASK modulation is achieved.

In the related art, in a modulation mode, the capacitors C1 to C6 are connected or disconnected between the first end point AC1_1 and the second end point AC2_1. By modulation based on connection and disconnection of the capacitors, waveforms of currents at the receiver and the transmitter are affected, such that a peak voltage of an induced voltage VCOIL changes, and hence ASK modulation is achieved. However, in the present disclosure, in a modulation mode, the logic control circuit controls, within the dead time period, the currents are transmitted to the first node AC1 and the second node AC2 respectively, such that the change rates of the voltages at the first node AC1 and the second node AC2 change respectively, and hence ASK modulation is achieved

In the present disclosure, specifically, the logic control circuit, within the first dead time period, controls the first node AC1 to transmit a discharging current to the ground via the second constant-current assembly 302, or controls the first node AC1 to transmit a discharging current to the ground via the second constant-current assembly 302 and the third constant-current assembly 303 to transmit an injection current to the second node AC2; or within the second dead time period, controls the first constant-current assembly 301 to transmit an injection current to the first node AC1, or controls the first constant-current assembly 301 to transmit an injection current to the first node AC1 and the second node AC2 to transmit a discharging current to the ground via the fourth constant-current assembly 304. Since the voltage at the first node AC1 falls and the voltage at the second node AC2 rises within the first dead time period, by controlling the first node AC1 to transmit the discharging current to the ground via the second constant-current assembly 302, or controlling the first node AC1 to transmit the discharging current to the ground via the second constant-current assembly 302 and the third constant-current assembly 303 to transmit the injection current to the second node AC2, the voltage fall at the first node AC1 is accelerated, and the voltage rise at the second node AC2 is accelerated. Since the voltage at the first node AC1 rises and the voltage at the second voltage AC2 falls within the second dead time period, by controlling the first constant-current assembly 301 to transmit the injection current to the first node AC1, or controlling the first constant-current assembly 301 to transmit the injection current to the first node AC1 and the second node AC2 to transmit the discharging current to the ground via the fourth constant-current assembly 304, the voltage rise at the first node AC1 is accelerated, and the voltage fall at the second node AC2 is accelerated. In this way, the change rates of the voltages at the first node and the second node increase respectively, such that ASK modulation is achieved.

In the present disclosure, specifically, the logic control circuit, within the first dead time period, controls the first constant-current assembly 301 to transmit an injection current to the first node AC1, or controls the first constant-current assembly 301 to transmit an injection current to the first node AC1 and the second node AC2 to transmit a discharging current to the ground via the fourth constant-current assembly 304; or within the second dead time period, controls the first node AC1 to transmit a discharging current to the ground via the second constant-current assembly 302, or controls the first node AC1 to transmit a discharging current to the ground via the second constant-current assembly 302 and the third constant-current assembly 303 to transmit an injection current to the second node AC2. Since the voltage at the first node AC1 falls and the voltage at the second node AC2 rises within the first dead time period, by controlling the first constant-current assembly 301 to transmit the injection current to the first node AC1, or controlling the first constant-current assembly 301 to transmit the injection current to the first node AC1 and the second node AC2 to transmit the discharging current to the ground via the fourth constant-current assembly 304, the voltage fall at the first node AC1 is decelerated, and the voltage rise at the second node AC2 is decelerated. Since the voltage at the first node AC1 rises and the voltage at the second voltage AC2 falls within the second dead time period, by controlling the first node AC1 to transmit the discharging current to the ground via the second constant-current assembly 302, or controlling the first node AC1 to transmit the discharging current to the ground via the second constant-current assembly 302 and the third constant-current assembly 303 to transmit the injection current to the second node AC2, the voltage rise at the first node AC1 is decelerated, and the voltage fall at the second node AC2 is decelerated. In this way, the change rates of the voltages at the first node and the second node decrease respectively, such that ASK modulation is achieved.

However, in the embodiments of the present disclosure, the logic control circuit controls, within the dead time period, the discharging current or the injection current is transmitted through the first node and the second node, such that the change rates of the voltages at the first node and the second node increase or decrease respectively, that is, the change rates of the voltages at the first node and the second node change respectively, which equivalently changes an output impedance of the receiver. In this way, a current in the receive coil changes, and hence a current in a transmit coil changes, such that ASK modulation is achieved. In this way, ASK modulation is not affected while the off-chip capacitors, the on-chip switching transistors, and the chip pins are reduced or eliminated.

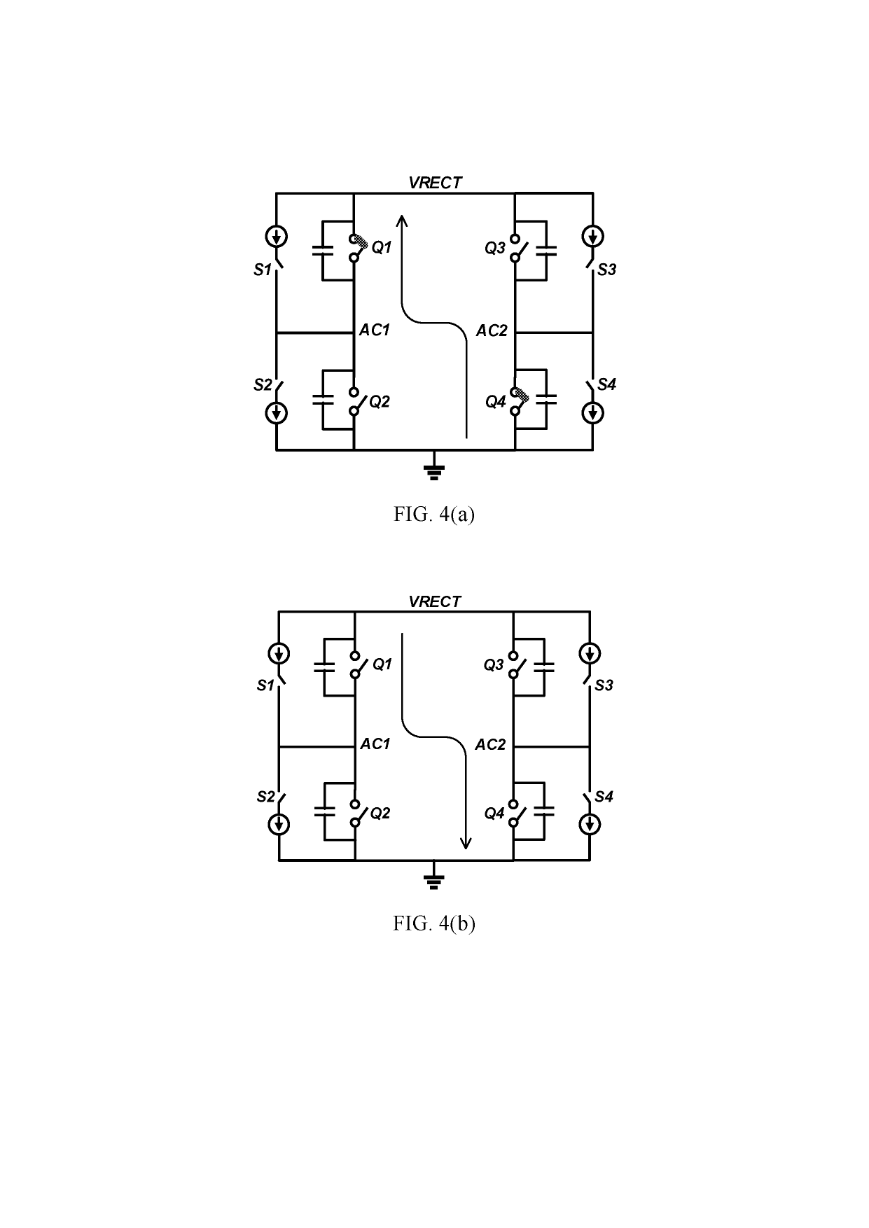

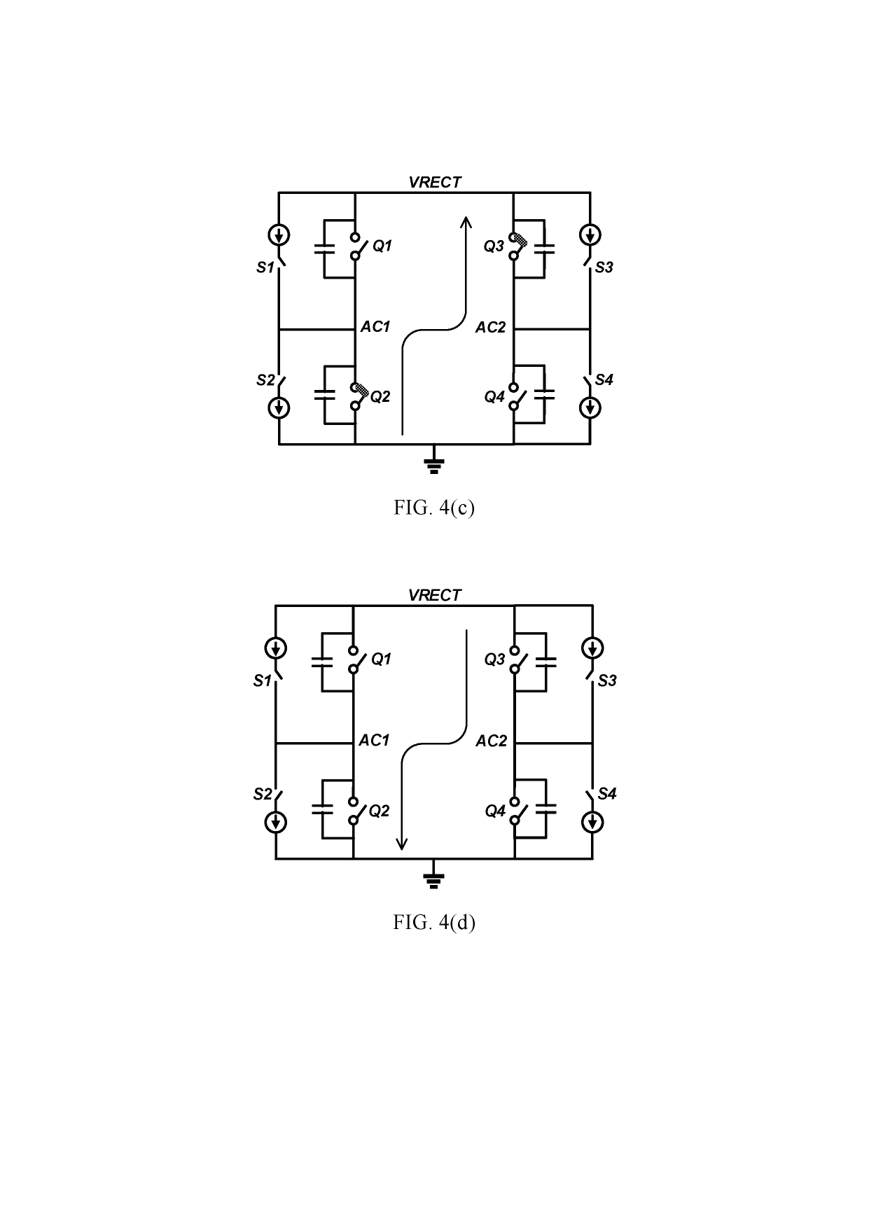

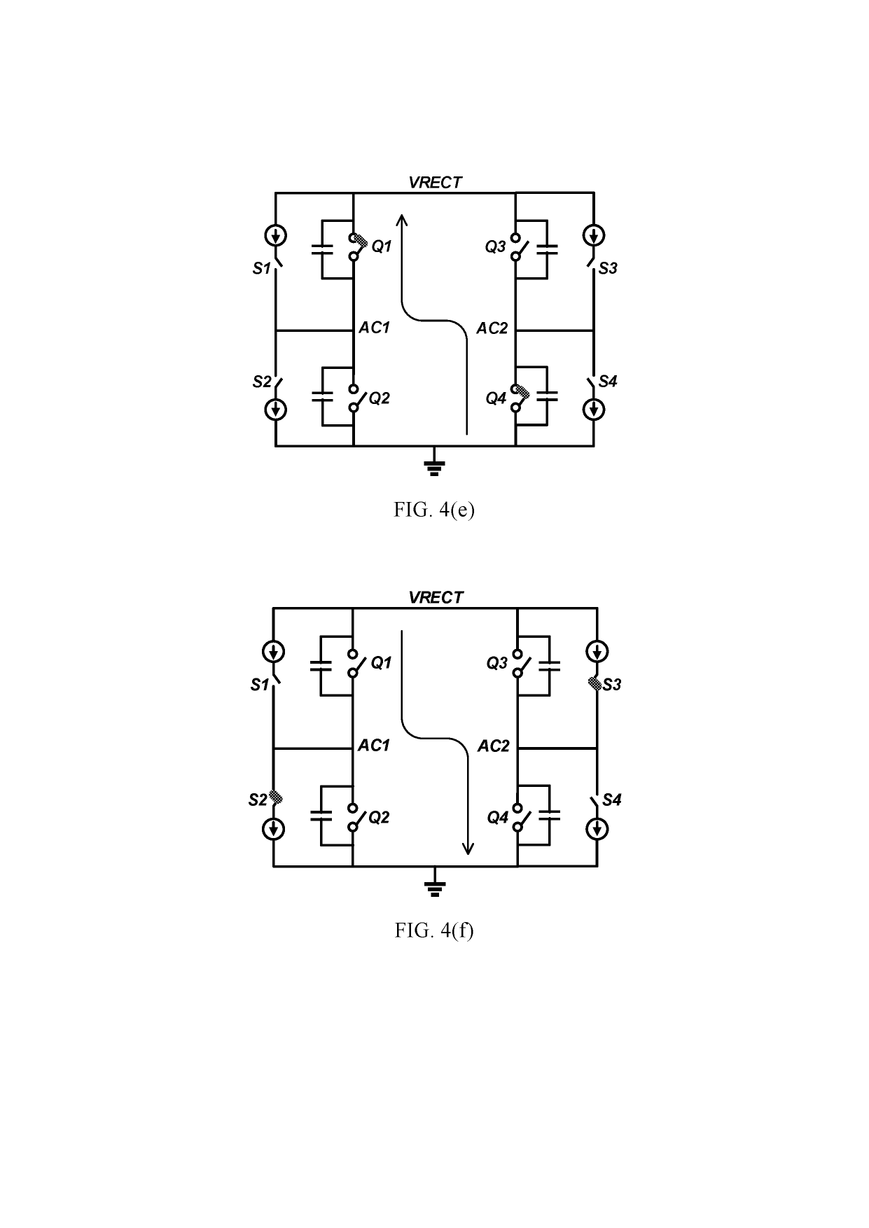

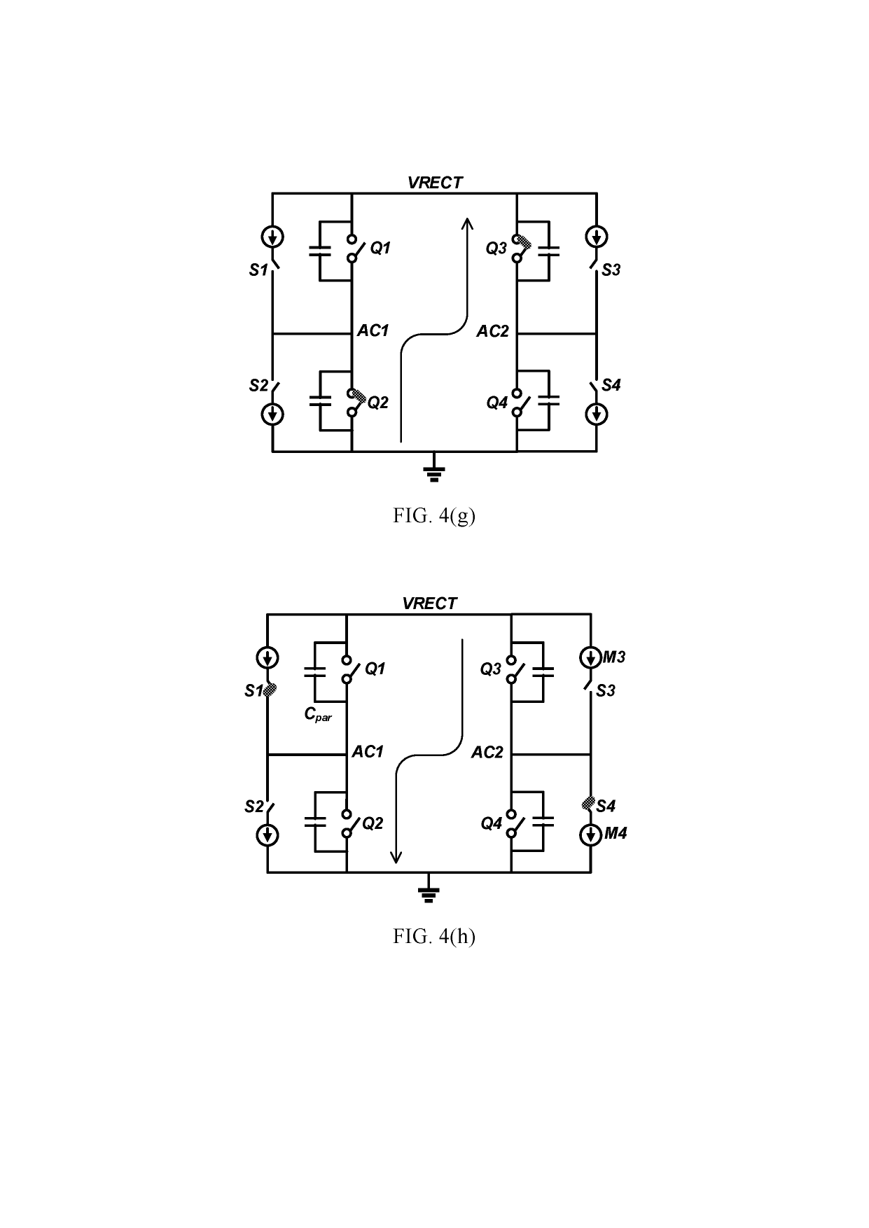

In some embodiments, referring to FIG. 4(a) to FIG. 4(h), schematic circuit control diagrams according to a first embodiment of the present disclosure are illustrated. FIG. 4(a), FIG. 4(b), FIG. 4(c), and FIG. 4(d) illustrates a non-modulation mode. FIG. 4(a) illustrates a first non-dead time period in the non-modulation mode, FIG. 4(c) illustrates a second non-dead time period in the non-modulation mode, FIG. 4(b) illustrates a first dead time period in the non-modulation mode, and FIG. 4(d) illustrates a second dead time period in the non-modulation mode. FIG. 4(e), FIG. 4(f), FIG. 4(g), and FIG. 4(h) illustrate a modulation mode. FIG. 4(e) illustrates a first non-dead time period in the modulation mode, FIG. 4(f) illustrates a second non-dead time period in the modulation mode, FIG. 4(g) illustrates a first dead time period in the modulation mode, and FIG. 4(h) illustrates a second dead time period in the modulation mode.

With respect to the full-bridge operating state: in the modulation mode, the logic control circuit is configured to: within the first dead time period (shown in FIG. 4(f)), control the second switch S2 and the third switch S3 to switch from an off state to an on state, such that the first node AC1 transmits a discharging current to the ground via the second switch S2 and the second constant-current source M2 and the third constant-current source M3 transmits an injection current to the second node AC2 via the third switch S3; or within the second dead time period (shown in FIG. 4(h)), control the first switch S1 and the fourth switch S4 to switch from the off state to the on state, such that the first constant-current source M1 transmits an injection current to the first node AC1 via the first switch S1 and the second node AC2 transmits a discharging current to the ground via the fourth switch S4 and the fourth constant-current source M4.

A capacitor connected in parallel between the first terminal and the second terminal of each of the first switching transistor Q1, the second switching transistor Q2, the third switching transistor Q3, and the fourth switching transistor Q4 is a respective parasitic capacitance of each of these switching transistors. The parasitic capacitances are illustrated in the drawings only for the purpose of explaining the operating principles and do not represent externally added actual capacitors. For clarity, only the reference numbers of the constant-current sources within the dead time period (shown in FIG. 4(f) and FIG. 4(h)) in the modulation mode are illustrated in the drawings. The reference numbers of the constant-current sources within the non-dead time period in the non-modulation mode are not explicitly illustrated. It is understood that the reference numbers of components in FIG. 4(a) to FIG. 4(h) remain consistent.

The full-bridge operating state is that, states of the first switching transistor Q1, the second switching transistor Q2, the third switching transistor Q3, and the fourth switching transistor Q4 all change in one cycle. Specifically, the first rectifier branch (i.e., the first switching transistor Q1 and the fourth switching transistor Q4) and the second rectifier branch (i.e., the second switching transistor Q2 and the third switching transistor Q3) are switched between a conducting state and a non-conducting state.

The specific operation process according to the first embodiment is as follows, in the modulation mode, with respect to the full-bridge operating state, within the first non-dead time period, referring to FIG. 4(e), the first rectifier branch (i.e., the first switching transistor Q1 and the fourth switching transistor Q4) is in the conducting state, while the second rectifier branch (i.e., the second switching transistor Q2 and the third switching transistor Q3) is in the non-conducting state. As a result, the voltage at the first node AC1 is an output voltage VRECT, and the voltage at the second node AC2 is 0. The switches S1 to S4 are all in the off state.

Within the first dead time period, referring to FIG. 4(f), the switching transistors Q1 to Q4 are all in the off state, and the first switch S1 and the fourth switch S4 are both in the off state. In this case, the first node AC1 discharges to the ground via the parasitic capacitance of the second switching transistor Q2, while the second node AC2 is charged by the parasitic capacitance of the third switching transistor Q3. Within the first dead time period, the logic control circuit controls the second switch S2 and the third switch S3 to switch from the off state to the on state, the first node AC1 transmits a discharging current to the ground via the second switch S2 and the second constant-current source M2, such that the voltage fall at the first node AC1 is accelerated. Meanwhile, the third constant-current source M3 transmits an injection current to the second node AC2 via the third switch S3, such that the voltage rise at the second node AC2 is accelerated.

Within the second non-dead time period, referring to FIG. 4(g), the second rectifier branch (i.e., the second switching transistor Q2 and the third switching transistor Q3) is in the conducting state, while the first rectifier branch (i.e., the first switching transistor Q1 and the fourth switching transistor Q4) is in the non-conducting state. The switches S1 to S4 are all in the off state.

Within the second dead time period, referring to FIG. 4(h), the switching transistors Q1 to Q4 are all in the off state, and the second switch S2 and the third switch S3 are both in the off state. In this case, the first node AC1 is charged by the parasitic capacitance of the first switching transistor Q1, while the second node AC2 discharges to the ground via the parasitic capacitance of the fourth switching transistor Q4. Within the second dead time period, the logic control circuit controls the first switch S1 and the fourth switch S4 to switch from the off state to the on state, the first constant-current source M1 transmits an injection current to the first node AC1 via the first switch S1, such that the voltage rise at the first node AC1 is accelerated. Meanwhile, the second node AC2 transmits a discharging current to the ground via the fourth switch S4 and the fourth constant-current source M4, such that the voltage fall at the second node AC2 is accelerated.

In the non-modulation mode, within the first non-dead time period, referring to FIG. 4(a), the first rectifier branch (i.e., the first switching transistor Q1 and the fourth switching transistor Q4) is in the conducting state, while the second rectifier branch (i.e., the second switching transistor Q2 and the third switching transistor Q3) is in the non-conducting state. The switches S1 to S4 are all in the off state.

Within the first dead time period, referring to FIG. 4(b), the switching transistors Q1 to Q4 are all in the off state, and the switches S1 to S4 are all in the off state.

Within the second non-dead time period, referring to FIG. 4(c), the second rectifier branch (i.e., the second switching transistor Q2 and the third switching transistor Q3) is in the conducting state, while the first rectifier branch (i.e., the first switching transistor Q1 and the fourth switching transistor Q4) is in the non-conducting state. The switches S1 to S4 are all in the off state.

Within the second dead time period, referring to FIG. 4(d), the switching transistors Q1 to Q4 are all in the off state, and the switches S1 to S4 are all in the off state.

In the non-modulation mode, the logic control circuit controls the first switch S1, the second switch S2, the third switch S3, and the fourth switch S4 to be in the off state. That is, in the non-modulation mode, the constant-current source circuit does not operate, and there is no need to transmit currents to the first node AC1 and the second node AC2.

In some embodiments, in the modulation mode according to the first embodiment, referring to FIG. 4(e) and FIG. 4(g), the logic control circuit controls, within the first non-dead time period and the second non-dead time period, the first switch S1, the second switch S2, the third switch S3, and the fourth switch S4 to be in the off state. That is, in the modulation mode, within the first non-dead time period and the second non-dead time period, the constant-current source circuit does not operate, and there is no need to transmit currents to the first node AC1 and the second node AC2.

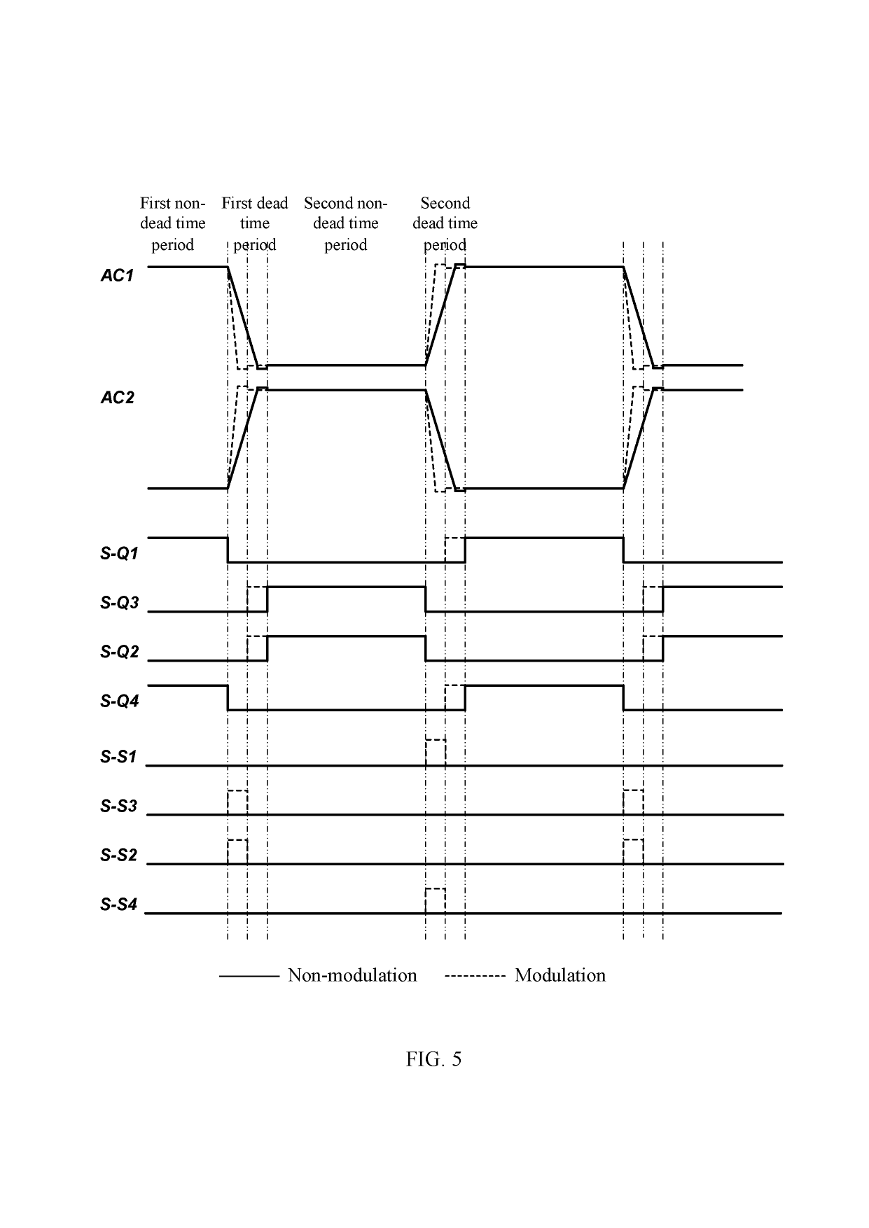

Referring to FIG. 5, FIG. 5 illustrates a timing diagram according to the first embodiment of the present disclosure. As illustrated in FIG. 5, in the non-modulation mode, within the first non-dead time period and the second non-dead time period, the timing of the switching transistors Q1 to Q4 is as follows: in a case that a body diode of any one of the switching transistors Q1 to Q4 is detected to be turned on, a switching transistor, whose body diode is detected to be turned on, of the switching transistors Q1 to Q4 is controlled to be turned on; or in a case that a current flowing through any one of the switching transistors Q1 to Q4 is detected to cross zero, a switching transistor, whose current is detected to cross zero, of the switching transistors Q1 to Q4 is controlled to be turned off.

Within the first non-dead time period, the first rectifier branch (i.e., the first switching transistor Q1 and the fourth switching transistor Q4) is in the conducting state, and the second rectifier branch (i.e., the second switching transistor Q2 and the third switching transistor Q3) is in the non-conducting state. The switches S1 to S4 are all in the off state. Therefore, the first switching transistor Q1 (i.e., S-Q1 in FIG. 5) and the fourth switching transistor Q4 (i.e., S-Q4 in FIG. 5) are at a high level, the second switching transistor Q2 (i.e., S-Q2 in FIG. 5) and the third switching transistor Q3 (i.e., S-Q3 in FIG. 5) are at a low level, and the switches S1 to S4 (i.e., S-S1, S-S2, S-S3, and S-S4 in FIG. 5) are all at a low level.

Within the second non-dead time period, the second rectifier branch (i.e., the second switching transistor Q2 and the third switching transistor Q3) is in the conducting state, and the first rectifier branch (i.e., the first switching transistor Q1 and the fourth switching transistor Q4) is in the non-conducting state. The switches S1 to S4 are all in the off state. Therefore, the first switching transistor Q1 (i.e., S-Q1 in FIG. 5) and the fourth switching transistor Q4 (i.e., S-Q4 in FIG. 5) are at a low level, the second switching transistor Q2 (i.e., S-Q2 in FIG. 5) and the third switching transistor Q3 (i.e., S-Q3 in FIG. 5) are at a high level, and the switches S1 to S4 (i.e., S-S1, S-S2, S-S3, and S-S4 in FIG. 5) are all at a low level.

With respect to the dead time period, the switches S1 to S4 are all in the off state, and there is no need to transmit currents to the first node AC1 and the second node AC2. In addition, the switching transistors Q1 to Q4 are all in the off state.

Within the first dead time period, the first rectifier branch (i.e., the first switching transistor Q1 and the fourth switching transistor Q4) and the second rectifier branch (i.e., the second switching transistor Q2 and the third switching transistor Q3) are both in the non-conducting state, and the switches S1 to S4 are all in the off state. Therefore, the first switching transistor Q1 (i.e., S-Q1 in FIG. 5), the fourth switching transistor Q4 (i.e., S-Q4 in FIG. 5), the second switching transistor Q2 (i.e., S-Q2 in FIG. 5), and the third switching transistor Q3 (i.e., S-Q3 in FIG. 5) are all at a low level, and the switches S1 to S4 (i.e., S-S1, S-S2, S-S3, and S-S4 in FIG. 5) are all at a low level.

Within the second dead time period, the first rectifier branch (i.e., the first switching transistor Q1 and the fourth switching transistor Q4) and the second rectifier branch (i.e., the second switching transistor Q2 and the third switching transistor Q3) are both in the non-conducting state, and the switches S1 to S4 are all in the off state. Therefore, the first switching transistor Q1 (i.e., S-Q1 in FIG. 5), the fourth switching transistor Q4 (i.e., S-Q4 in FIG. 5), the second switching transistor Q2 (i.e., S-Q2 in FIG. 5), and the third switching transistor Q3 (i.e., S-Q3 in FIG. 5) are all at a low level, and the switches S1 to S4 (i.e., S-S1, S-S2, S-S3, and S-S4 in FIG. 5) are all at a low level.

Still referring to FIG. 5, in the modulation mode, within the non-dead time period, the timing of the switching transistors Q1 to Q4 is as follows: in a case that a body diode of any one of the switching transistors Q1 to Q4 is detected to be turned on, a switching transistor, whose body diode is detected to be turned on, of the switching transistors Q1 to Q4 is controlled to be turned on; or in a case that a current flowing through any one of the switching transistors Q1 to Q4 is detected to cross zero, a switching transistor, whose current is detected to cross zero, of the switching transistors Q1 to Q4 is controlled to be turned off.

Within the first non-dead time period, the first rectifier branch (i.e., the first switching transistor Q1 and the fourth switching transistor Q4) is in the conducting state, and the second rectifier branch (i.e., the second switching transistor Q2 and the third switching transistor Q3) is in the non-conducting state. The switches S1 to S4 are all in the off state. Therefore, the first switching transistor Q1 (i.e., S-Q1 in FIG. 5) and the fourth switching transistor Q4 (i.e., S-Q4 in FIG. 5) are at a high level, the second switching transistor Q2 (i.e., S-Q2 in FIG. 5) and the third switching transistor Q3 (i.e., S-Q3 in FIG. 5) are at a low level, and the switches S1 to S4 (i.e., S-S1, S-S2, S-S3, and S-S4 in FIG. 5) are all at a low level.

Within the second non-dead time period, the second rectifier branch (i.e., the second switching transistor Q2 and the third switching transistor Q3) is in the conducting state, and the first rectifier branch (i.e., the first switching transistor Q1 and the fourth switching transistor Q4) is in the non-conducting state. The switches S1 to S4 are all in the off state. Therefore, the first switching transistor Q1 (i.e., S-Q1 in FIG. 5) and the fourth switching transistor Q4 (i.e., S-Q4 in FIG. 5) are at a low level, the second switching transistor Q2 (i.e., S-Q2 in FIG. 5) and the third switching transistor Q3 (i.e., S-Q3 in FIG. 5) are at a high level, and the switches S1 to S4 (i.e., S-S1, S-S2, S-S3, and S-S4 in FIG. 5) are all at a low level.

Within the first dead time period, the voltage at the first node AC1 falls and the voltage at the second node AC2 rises. In this case, the first switch S1 and the fourth switch S4 are controlled to be turned off, and the second switch S2 and the third switch S3 are controlled to be turned on. The first node AC1 transmits a discharging current to the ground via the second switch S2, and the third constant-current source M3 transmits an injection current to the second node AC2 via the third switch S3, such that the voltage fall at the first node AC1 is accelerated, and the voltage rise at the second node AC2 is accelerated. Therefore, the first switch S1 (i.e., S-S1 in FIG. 5) and the fourth switch S4 (i.e., S-S4 in FIG. 5) are at a low level, and the second switch S2 (i.e., S-S2 in FIG. 5) and the third switch S3 (i.e., S-S3 in FIG. 5) are at a high level.

Within the second dead time period, the voltage at the first node AC1 rises and the voltage at the second node AC2 falls. In this case, the second switch S2 and the third switch S3 are controlled to be turned off, and the first switch S1 and the fourth switch S4 are controlled to be turned on. The first constant-current source M1 transmits an injection current to the first node AC1 via the first switch S1, and the second node AC2 transmits a discharging current to the ground via the fourth switch S4, such that the voltage rise at the first node AC1 is accelerated, and the voltage fall at the second node AC2 is accelerated. Therefore, the first switch S1 (i.e., S-S1 in FIG. 5) and the fourth switch S4 (i.e., S-S4 in FIG. 5) are at a high level, and the second switch S2 (i.e., S-S2 in FIG. 5) and the third switch S3 (i.e., S-S3 in FIG. 5) are at a low level.

It can be understood that the high level in the timing of the switching transistors Q1 to Q4 in FIG. 5 corresponds to the on state, and the low level corresponds to the off state. Similarly, the high level in the timing of the switches S1 to S4 in FIG. 5 corresponds to the on state, and the low level corresponds to the off state.

In the method according to the first embodiment, in the modulation mode, the change rates of the voltages at the first node AC1 and the second node AC2 increase respectively. As illustrated by dashed-line portions of the first node AC1 and the second node AC2 in FIG. 5, a slope of the voltage rise and fall at the first node AC1 and the second node AC2 becomes larger within the dead time period. As illustrated by dashed-line portions of S-Q2 and S-Q3 within the first dead time period in FIG. 5, the second switching transistor Q2 and the third switching transistor Q3 are turned on in advance. As illustrated by dashed-line portions of S-Q1 and S-Q4 within the second dead time period in FIG. 5, the first switching transistor Q1 and the fourth switching transistor Q4 are turned on in advance.

With respect to the first embodiment, the present disclosure provides a logic control circuit 100. The logic control circuit 100 is configured to acquire control signals (i.e., S-S1, S-S2, S-S3, S-S4) of the switches S1 to S4 based on the state signals (i.e., S-Q1, S-Q2, S-Q3, S-Q4) of the switching transistors Q1 to Q4 respectively.

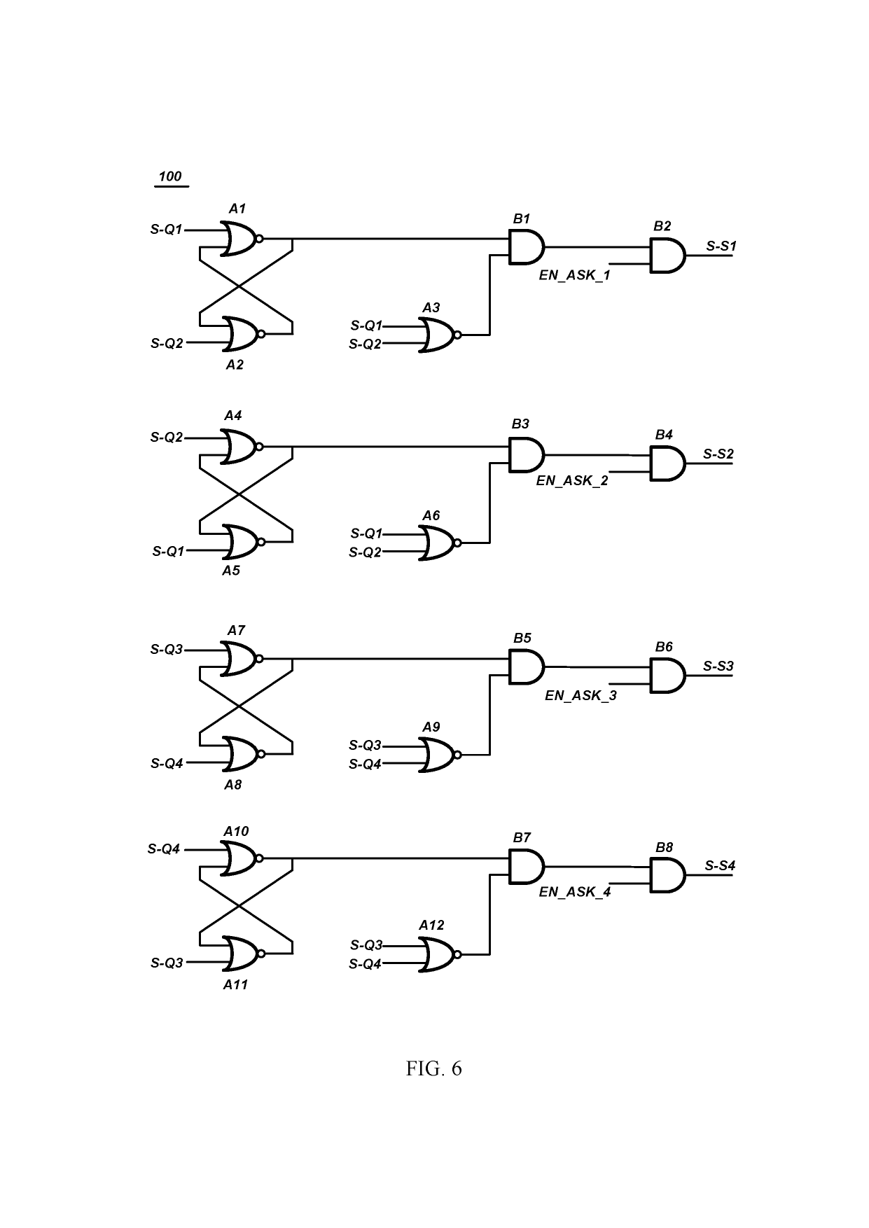

Specifically, referring to FIG. 6, the logic control circuit 100 includes a first NOR gate A1, a second NOR gate A2, a third NOR gate A3, a fourth NOR gate A4, a fifth NOR gate A5, a sixth NOR gate A6, a seventh NOR gate A7, an eighth NOR gate A8, a ninth NOR gate A9, a tenth NOR gate A10, an eleventh NOR gate A11, a twelfth NOR gate A12, a first AND gate B1, a second AND gate B2, a third AND gate B3, a fourth AND gate B4, a fifth AND gate B5, a sixth AND gate B6, a seventh AND gate B7, and an eighth AND gate B8.

A first input terminal of the first NOR gate A1 is configured to receive a state signal S-Q1 of the first switching transistor Q1, a second input terminal of the first NOR gate A1 is electrically connected to an output terminal of the second NOR gate A2, and an output terminal of the first NOR gate A1 is electrically connected to a first input terminal of the second NOR gate A2 and a first input terminal of the first AND gate B1.

A second input terminal of the second NOR gate A2 is configured to receive a state signal S-Q2 of the second switching transistor Q2.

A first input terminal of the third NOR gate A3 is configured to receive the state signal S-Q1 of the first switching transistor Q1, a second input terminal of the third NOR gate A3 is configured to receive a state signal S-Q2 of the second switching transistor Q2, and an output terminal of the third NOR gate A3 is electrically connected to a second input terminal of the first AND gate B1.

An output terminal of the first AND gate B1 is electrically connected to a first input terminal of the second AND gate B2, a second input terminal of the second AND gate B2 is configured to receive a first modulation enable signal EN_ASK_1, and an output terminal of the second AND gate B2, as a control signal terminal of the first switch S1, is configured to output a control signal S-S1 of the first switch S1.

A first input terminal of the fourth NOR gate A4 is configured to receive the state signal S-Q2 of the second switching transistor Q2, a second input terminal of the fourth NOR gate A4 is electrically connected to an output terminal of the fifth NOR gate A5, and an output terminal of the fourth NOR gate A4 is electrically connected to a first input terminal of the fifth NOR gate A5 and a first input terminal of the third AND gate B3.

A second input terminal of the fifth NOR gate A5 is configured to receive the state signal S-Q1 of the first switching transistor Q1.

A first input terminal of the sixth NOR gate A6 is configured to receive the state signal S-Q1 of the first switching transistor Q1, a second input terminal of the sixth NOR gate A6 is configured to receive the state signal S-Q2 of the second switching transistor Q2, and an output terminal of the sixth NOR gate A6 is electrically connected to a second input terminal of the third AND gate B3.

An output terminal of the third AND gate B3 is electrically connected to a first input terminal of the fourth AND gate B4, a second input terminal of the fourth AND gate B4 is configured to receive a second modulation enable signal EN_ASK_2, and an output terminal of the fourth AND gate B4, as a control signal terminal of the second switch S2, is configured to output a control signal S-S2 of the second switch S2.

A first input terminal of the seventh NOR gate A7 is configured to receive a state signal S-Q3 of the third switching transistor Q3, a second input terminal of the seventh NOR gate A7 is electrically connected to an output terminal of the eighth NOR gate A8, and an output terminal of the seventh NOR gate A7 is electrically connected to a first input terminal of the eighth NOR gate A8 and a first input terminal of the fifth AND gate B5.

A second input terminal of the eighth NOR gate A8 is configured to receive a state signal S-Q4 of the fourth switching transistor Q4.

A first input terminal of the ninth NOR gate A9 is configured to receive the state signal S-Q3 of the third switching transistor Q3, a second input terminal of the ninth NOR gate A9 is configured to receive the state signal S-Q4 of the fourth switching transistor Q4, and an output terminal of the ninth NOR gate A9 is electrically connected to a second input terminal of the fifth AND gate B5.

An output terminal of the fifth AND gate B5 is electrically connected to a first input terminal of the sixth AND gate B6, a second input terminal of the sixth AND gate B6 is configured to receive a third modulation enable signal EN_ASK_3, and an output terminal of the sixth AND gate B6, as a control signal terminal of the third switch S3, is configured to output a control signal S-S3 of the third switch S3.

A first input terminal of the tenth NOR gate A10 is configured to receive the state signal S-Q4 of the fourth switching transistor Q4, a second input terminal of the tenth NOR gate A10 is electrically connected to an output terminal of the eleventh NOR gate A11, and an output terminal of the tenth NOR gate A10 is electrically connected to a first input terminal of the eleventh NOR gate A11 and a first input terminal of the seventh AND gate B7.

A second input terminal of the eleventh NOR gate A11 is configured to receive the state signal S-Q3 of the third switching transistor Q3.

A first input terminal of the twelfth NOR gate A12 is configured to receive the state signal S-Q3 of the third switching transistor Q3, a second input terminal of the twelfth NOR gate A12 is configured to receive the state signal S-Q4 of the fourth switching transistor Q4, and an output terminal of the twelfth NOR gate A12 is electrically connected to a second input terminal of the seventh AND gate B7.

An output terminal of the seventh AND gate B7 is electrically connected to a first input terminal of the eighth AND gate B8, a second input terminal of the eighth AND gate B8 is configured to receive a fourth modulation enable signal EN_ASK_4, and an output terminal of the eighth AND gate B8, as a control signal terminal of the fourth switch S4, is configured to output a control signal S-S4 of the fourth switch S4.

In the first embodiment, the first modulation enable signal EN_ASK_1, the second modulation enable signal EN_ASK_2, the third modulation enable signal EN_ASK_3, and the fourth modulation enable signal EN_ASK_4 in the logic control circuit are configured to gate or enable the modulation mode and the non-modulation mode. The logic control circuit acquires control signals (i.e., S-S1, S-S2, S-S3, S-S4) of the switches S1 to S4 based on the state signals (i.e., S-Q1, S-Q2, S-Q3, S-Q4) of the switching transistors Q1 to Q4 respectively, and controls the states of the switches S1 to S4 based on the control signals of the switches S1 to S4 respectively. Within the dead time period, the constant-current source circuit is controlled that the injection current is transmitted to one of the first node and the second node or the discharging current is transmitted from the first node or the second node to the ground via the second switch S2 or the fourth switch S4 respectively, such that the change rates of the voltages at the first node and the second node increase respectively, that is, the change rates of the voltages at the first node and the second node change respectively, which equivalently changes an output impedance of the receiver. In this way, a current in the receive coil changes, and hence a current in a transmit coil changes, such that ASK modulation is achieved. In this way, ASK modulation is not affected while the off-chip capacitors, the on-chip switching transistors, and the chip pins are reduced or eliminated.

In some embodiments, with respect to the full-bridge operating state: in a non-modulation mode, the logic control circuit is configured to: within the first dead time period, control the second switch and the third switch to switch from the off state to the on state, such that the first node transmits a discharging current to the ground via the second switch and the third constant-current source transmits an injection current to the second node via the third switch; or within the second dead time period, control the first switch and the fourth switch to switch from the off state to the on state, such that the first constant-current source transmits an injection current to the first node via the first switch and the second node transmits a discharging current to the ground via the fourth switch.

In the modulation mode, the logic control circuit is configured to control the first switch, the second switch, the third switch, and the fourth switch to be in the off state.

The embodiment herein differs from the first embodiment only in that the modulation mode and the non-modulation mode may be interchanged. Specifically, the modulation mode in the first embodiment is replaced with the non-modulation mode, and the non-modulation mode in the first embodiment is replaced with the modulation mode. That is, in the modulation mode, the constant-current source circuit does not operate, and there is no need to transmit currents through the first node AC1 and the second node AC2; and in the non-modulation mode, the constant-current source circuit is controlled that currents are transmitted through the first node AC1 and the second node AC2 respectively. The control logic of the embodiments of the present disclosure is the same as that in the first embodiment, which is thus not described herein any further.

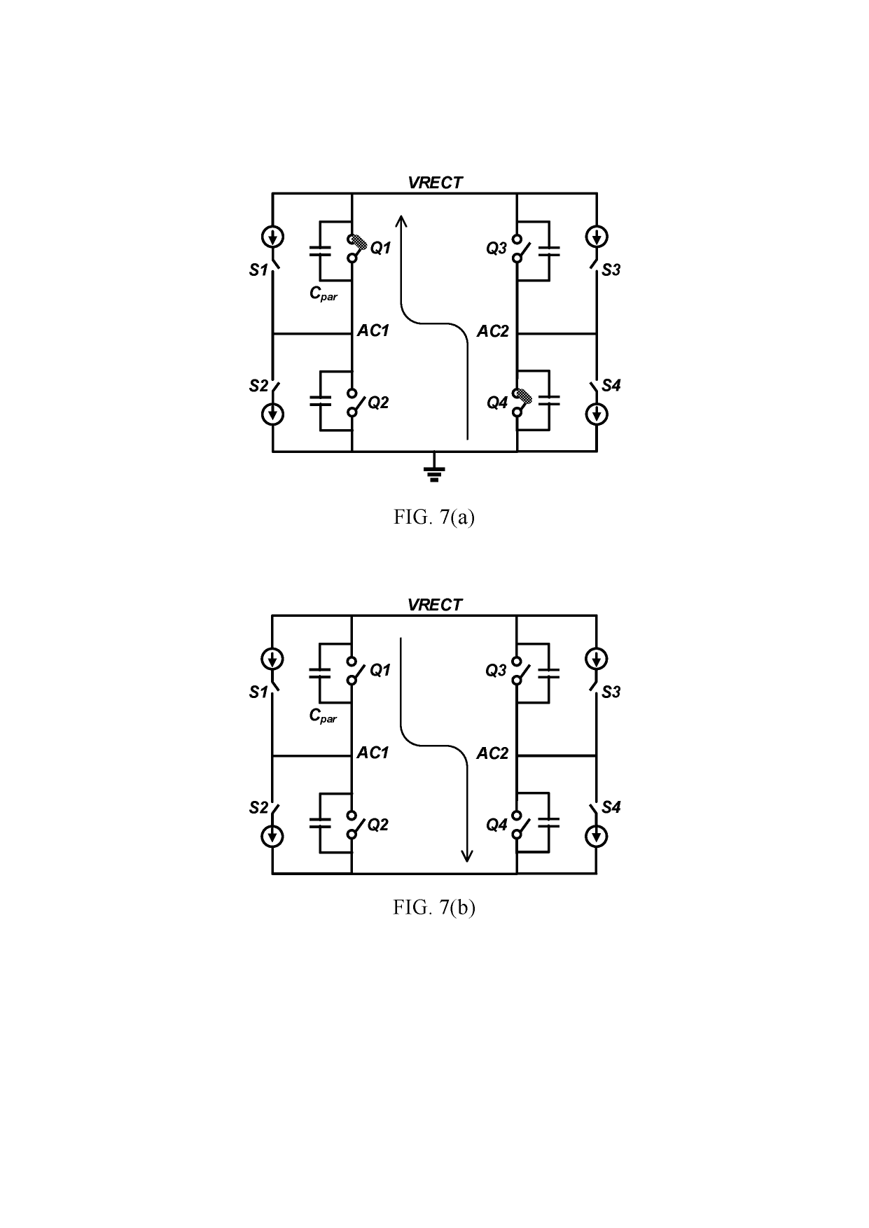

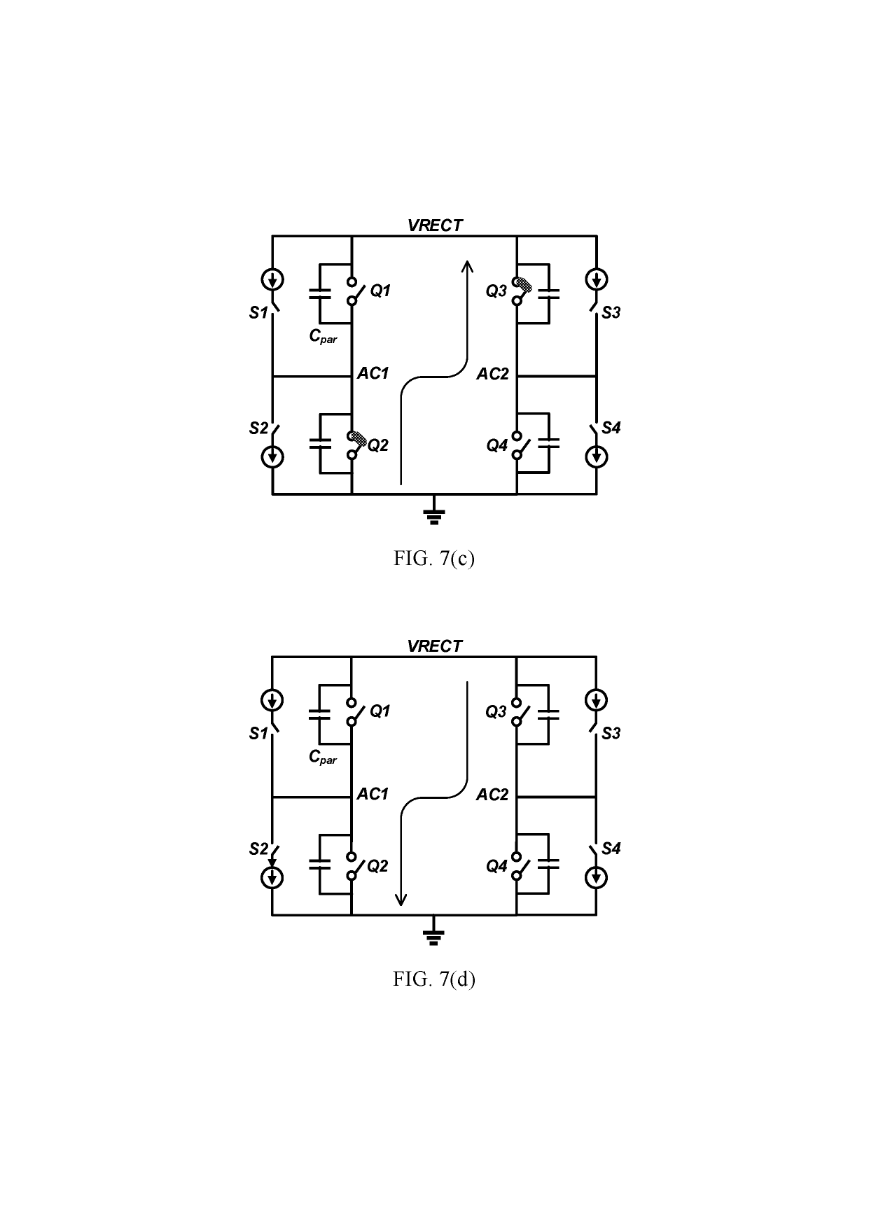

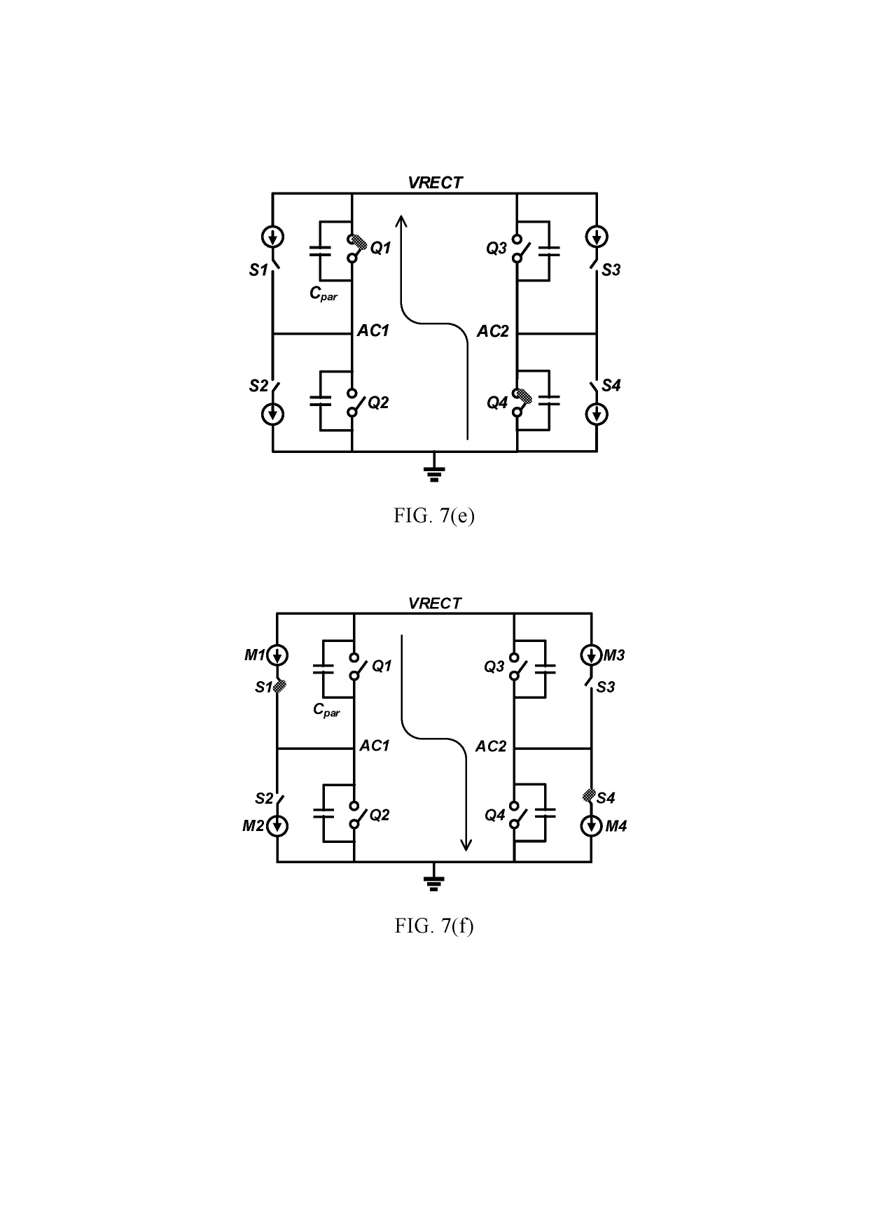

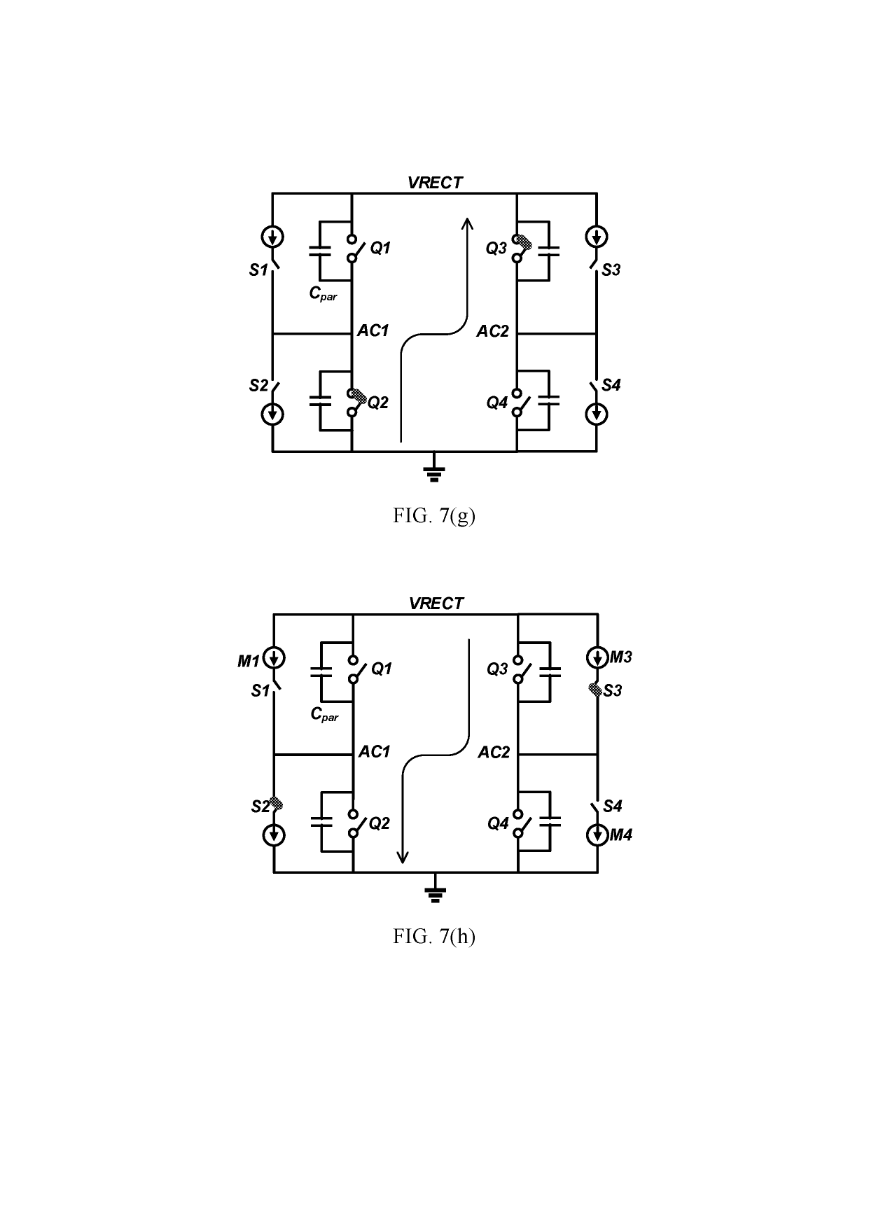

In some embodiments, referring to FIG. 7(a) to FIG. 7(h), schematic circuit control diagrams according to some embodiments of the present disclosure are illustrated. FIG. 7(a), FIG. 7(b), FIG. 7(c), and FIG. 7(d) illustrates a non-modulation mode. FIG. 7(a) illustrates a first non-dead time period in the non-modulation mode, FIG. 7(c) illustrates a second non-dead time period in the non-modulation mode, FIG. 7(b) illustrates a first dead time period in the non-modulation mode, and FIG. 7(d) illustrates a second dead time period in the non-modulation mode. FIG. 7(e), FIG. 7(f), FIG. 7(g), and FIG. 7(h) illustrate a modulation mode. FIG. 7(e) illustrates a first non-dead time period in the modulation mode, FIG. 7(f) illustrates a second non-dead time period in the modulation mode, FIG. 7(g) illustrates a first dead time period in the modulation mode, and FIG. 7(h) illustrates a second dead time period in the modulation mode.

With respect to the full-bridge operating state: in the modulation mode, the logic control circuit is configured to: within the first dead time period (i.e., FIG. 7(f)), control the first switch S1 and the fourth switch S4 to switch from the off state to the on state, such that the first constant-current source M1 transmits an injection current to the first node AC1 via the first switch S1 and the second node AC2 transmits a discharging current to the ground via the fourth switch S4 and the fourth constant-current source M4; or within the second dead time period (i.e., FIG. 7(h)), control the second switch S2 and the third switch S3 to switch from the off state to the on state, such that the first node AC1 transmits a discharging current to the ground via the second switch S2 and the second constant-current source M2 and the third constant-current source M3 transmits an injection current to the second node AC2 via the third switch S3.

A capacitor connected in parallel between the first terminal and the second terminal of each of the first switching transistor Q1, the second switching transistor Q2, the third switching transistor Q3, and the fourth switching transistor Q4 is a respective parasitic capacitance of the each of these switching transistors. The parasitic capacitances are illustrated in the drawings only for the purpose of explaining the operating principles and do not represent externally added actual capacitors. For clarity, only the reference numbers of the constant-current sources within the dead time period (i.e., FIG. 7(f) and FIG. 7(h)) in the modulation mode are illustrated in the drawings. The reference numbers of the constant-current sources within the non-dead time period in the non-modulation mode are not explicitly illustrated. It is understood that the reference numbers of components in FIG. 7(a) to FIG. 7(h) remain consistent.

During the full-bridge operating state, states of the first switching transistor Q1, the second switching transistor Q2, the third switching transistor Q3, and the fourth switching transistor Q4 all change in one cycle. Specifically, the first rectifier branch (i.e., the first switching transistor Q1 and the fourth switching transistor Q4) and the second rectifier branch (i.e., the second switching transistor Q2 and the third switching transistor Q3) are switched between a conducting state and a non-conducting state.

The specific operation process according to the second embodiment is as follows, in the modulation mode, with respect to the full-bridge operating state, within the first non-dead time period, referring to FIG. 7(e), the first rectifier branch (i.e., the first switching transistor Q1 and the fourth switching transistor Q4) is in the conducting state, while the second rectifier branch (i.e., the second switching transistor Q2 and the third switching transistor Q3) is in the non-conducting state. As a result, the voltage at the first node AC1 is an output voltage VRECT, and the voltage at the second node AC2 is 0. The switches S1 to S4 are all in the off state.

Within the first dead time period, referring to FIG. 7(f), the switching transistors Q1 to Q4 are all in the off state, and the second switch S2 and the third switch S3 are both in the off state. In this case, the first node AC1 discharges to the ground via the parasitic capacitance of the second switching transistor Q2, while the second node AC2 is charged by the parasitic capacitance of the third switching transistor Q3. Within the first dead time period, the logic control circuit controls the first switch S1 and the fourth switch S4 to switch from the off state to the on state. The first constant-current source M1 transmits an injection current to the first node AC1 via the first switch S1, such that the voltage fall at the first node AC1 is decelerated. Meanwhile, the second node AC2 transmits a discharging current to the ground via the fourth switch S4 and the fourth constant-current source M4, such that the voltage rise at the second node AC2 is decelerated.

Within the second non-dead time period, referring to FIG. 7(g), the second rectifier branch (i.e., the second switching transistor Q2 and the third switching transistor Q3) is in the conducting state, while the first rectifier branch (i.e., the first switching transistor Q1 and the fourth switching transistor Q4) is in the non-conducting state. The switches S1 to S4 are all in the off state.

Within the second dead time period, referring to FIG. 7(h), the switching transistors Q1 to Q4 are all in the off state, and the first switch S1 and the fourth switch S4 are both in the off state. In this case, the first node AC1 is charged by the parasitic capacitance of the first switching transistor Q1, while the second node AC2 discharges to the ground via the parasitic capacitance of the fourth switching transistor Q4. Within the second dead time period, the logic control circuit controls the second switch S2 and the third switch S3 to switch from the off state to the on state. The first node AC1 transmits a discharging current to the ground via the second switch S2 and the second constant-current source M2, such that the voltage rise at the first node AC1 is decelerated. Meanwhile, the third constant-current source M3 transmits the injection current to the second node AC2 via the third switch S3, such that the voltage fall at the second node AC2 is decelerated.

In the non-modulation mode, within the first non-dead time period, referring to FIG. 7(a), the first rectifier branch (i.e., the first switching transistor Q1 and the fourth switching transistor Q4) is in the conducting state, while the second rectifier branch (i.e., the second switching transistor Q2 and the third switching transistor Q3) is in the non-conducting state. The switches S1 to S4 are all in the off state.

Within the first dead time period, referring to FIG. 7(b), the switching transistors Q1 to Q4 are all in the off state, and the switches S1 to S4 are all in the off state.

Within the second non-dead time period, referring to FIG. 7(c), the second rectifier branch (i.e., the second switching transistor Q2 and the third switching transistor Q3) is in the conducting state, while the first rectifier branch (i.e., the first switching transistor Q1 and the fourth switching transistor Q4) is in the non-conducting state. The switches S1 to S4 are all in the off state.

Within the second dead time period, referring to FIG. 7(d), the switching transistors Q1 to Q4 are all in the off state, and the switches S1 to S4 are all in the off state.

In the non-modulation mode, the logic control circuit controls the first switch S1, the second switch S2, the third switch S3, and the fourth switch S4 to be in the off state. That is, in the non-modulation mode, the constant-current source circuit does not operate, and there is no need to transmit currents through the first node AC1 and the second node AC2.

In some embodiments, in the modulation mode according to the second embodiment, referring to FIG. 7(e) and FIG. 7(g), the logic control circuit controls, within the first non-dead time period and the second non-dead time period, the first switch S1, the second switch S2, the third switch S3, and the fourth switch S4 to be in the off state. That is, in the modulation mode, within the first non-dead time period and the second non-dead time period, the constant-current source circuit does not operate, and there is no need to transmit currents through the first node AC1 and the second node AC2.

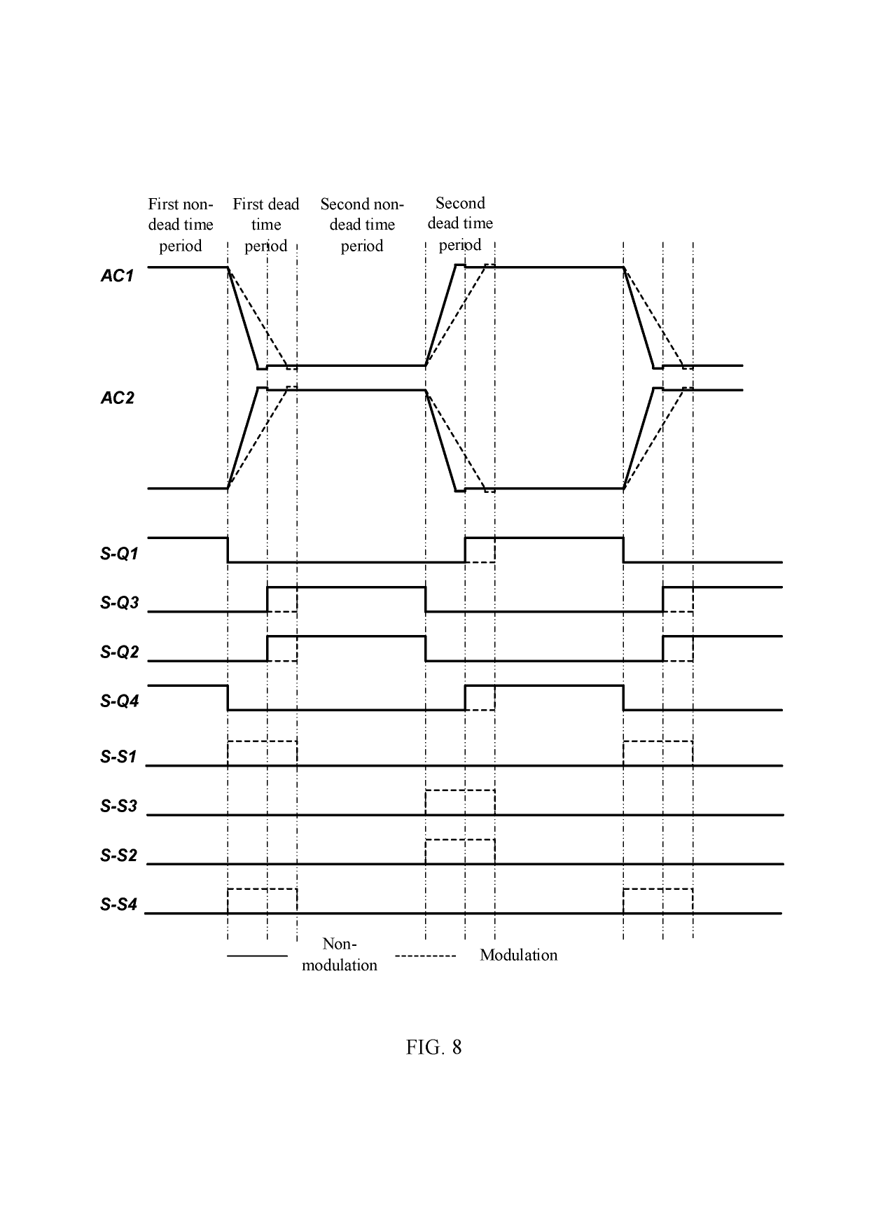

Referring to FIG. 8, FIG. 8 illustrates a timing diagram according to the second embodiment of the present disclosure. As illustrated in FIG. 8, in the non-modulation mode, within the first non-dead time period and the second non-dead time period, the timing of the switching transistors Q1 to Q4 is as follows: in a case that a body diode of any one of the switching transistors Q1 to Q4 is detected to be turned on, a switching transistor, whose body diode is detected to be turned on, of the switching transistors Q1 to Q4 is controlled to be turned on; or in a case that a current flowing through any one of the switching transistors Q1 to Q4 is detected to cross zero, a switching transistor, whose current is detected to cross zero, of the switching transistors Q1 to Q4 is controlled to be turned off.

Within the first non-dead time period, the first rectifier branch (i.e., the first switching transistor Q1 and the fourth switching transistor Q4) is in the conducting state, and the second rectifier branch (i.e., the second switching transistor Q2 and the third switching transistor Q3) is in the non-conducting state. The switches S1 to S4 are all in the off state. Therefore, the first switching transistor Q1 (i.e., S-Q1 in FIG. 8) and the fourth switching transistor Q4 (i.e., S-Q4 in FIG. 8) are at a high level, the second switching transistor Q2 (i.e., S-Q2 in FIG. 8) and the third switching transistor Q3 (i.e., S-Q3 in FIG. 8) are at a low level, and the switches S1 to S4 (i.e., S-S1, S-S2, S-S3, and S-S4 in FIG. 8) are all at a low level.

Within the second non-dead time period, the second rectifier branch (i.e., the second switching transistor Q2 and the third switching transistor Q3) is in the conducting state, and the first rectifier branch (i.e., the first switching transistor Q1 and the fourth switching transistor Q4) is in the non-conducting state. The switches S1 to S4 are all in the off state. Therefore, the first switching transistor Q1 (i.e., S-Q1 in FIG. 8) and the fourth switching transistor Q4 (i.e., S-Q4 in FIG. 8) are at a low level, the second switching transistor Q2 (i.e., S-Q2 in FIG. 8) and the third switching transistor Q3 (i.e., S-Q3 in FIG. 8) are at a high level, and the switches S1 to S4 (i.e., S-S1, S-S2, S-S3, and S-S4 in FIG. 8) are all at a low level.

With respect to the dead time period, the switches S1 to S4 are all in the off state, and there is no need to transmit currents through the first node AC1 and the second node AC2. In addition, the switching transistors Q1 to Q4 are all in the off state.

Within the first dead time period, the first rectifier branch (i.e., the first switching transistor Q1 and the fourth switching transistor Q4) and the second rectifier branch (i.e., the second switching transistor Q2 and the third switching transistor Q3) are both in the non-conducting state, and the switches S1 to S4 are all in the off state. Therefore, the first switching transistor Q1 (i.e., S-Q1 in FIG. 8), the fourth switching transistor Q4 (i.e., S-Q4 in FIG. 8), the second switching transistor Q2 (i.e., S-Q2 in FIG. 8), and the third switching transistor Q3 (i.e., S-Q3 in FIG. 8) are all at a low level, and the switches S1 to S4 (i.e., S-S1, S-S2, S-S3, and S-S4 in FIG. 8) are all at a low level.

Within the second dead time period, the first rectifier branch (i.e., the first switching transistor Q1 and the fourth switching transistor Q4) and the second rectifier branch (i.e., the second switching transistor Q2 and the third switching transistor Q3) are both in the non-conducting state, and the switches S1 to S4 are all in the off state. Therefore, the first switching transistor Q1 (i.e., S-Q1 in FIG. 8), the fourth switching transistor Q4 (i.e., S-Q4 in FIG. 8), the second switching transistor Q2 (i.e., S-Q2 in FIG. 8), and the third switching transistor Q3 (i.e., S-Q3 in FIG. 8) are all at a low level, and the switches S1 to S4 (i.e., S-S1, S-S2, S-S3, and S-S4 in FIG. 8) are all at a low level.

Still referring to FIG. 8, in the modulation mode, within the non-dead time period, the timing of the switching transistors Q1 to Q4 is as follows: in a case that a body diode of any one of the switching transistors Q1 to Q4 is detected to be turned on, a switching transistor, whose body diode is detected to be turned on, of the switching transistors Q1 to Q4 is controlled to be turned on; or in a case that a current flowing through any one of the switching transistors Q1 to Q4 is detected to cross zero, whose current is detected to cross zero, of the switching transistors Q1 to Q4 a corresponding switching transistor is controlled to be turned off.

Within the first non-dead time period, the first rectifier branch (i.e., the first switching transistor Q1 and the fourth switching transistor Q4) is in the conducting state, and the second rectifier branch (i.e., the second switching transistor Q2 and the third switching transistor Q3) is in the non-conducting state. The switches S1 to S4 are all in the off state. Therefore, the first switching transistor Q1 (i.e., S-Q1 in FIG. 8) and the fourth switching transistor Q4 (i.e., S-Q4 in FIG. 8) are at a high level, the second switching transistor Q2 (i.e., S-Q2 in FIG. 8) and the third switching transistor Q3 (i.e., S-Q3 in FIG. 8) are at a low level, and the switches S1 to S4 (i.e., S-S1, S-S2, S-S3, and S-S4 in FIG. 8) are all at a low level.

Within the second non-dead time period, the second rectifier branch (i.e., the second switching transistor Q2 and the third switching transistor Q3) is in the conducting state, and the first rectifier branch (i.e., the first switching transistor Q1 and the fourth switching transistor Q4) is in the non-conducting state. The switches S1 to S4 are all in the off state. Therefore, the first switching transistor Q1 (i.e., S-Q1 in FIG. 8) and the fourth switching transistor Q4 (i.e., S-Q4 in FIG. 8) are at a low level, the second switching transistor Q2 (i.e., S-Q2 in FIG. 8) and the third switching transistor Q3 (i.e., S-Q3 in FIG. 8) are at a high level, and the switches S1 to S4 (i.e., S-S1, S-S2, S-S3, and S-S4 in FIG. 8) are all at a low level.

Within the first dead time period, the voltage at the first node AC1 falls and the voltage at the second node AC2 rises. In this case, the first switch S1 and the fourth switch S4 are controlled to be turned on, and the second switch S2 and the third switch S3 are controlled to be turned off. The first constant-current source M1 transmits the injection current to the first node AC1 via the first switch S1, and the second node AC2 transmits the discharging current to the ground via the fourth switch S4, such that the voltage falls at the first node AC1 is decelerated, and the voltage rise at the second node AC2 is decelerated. Therefore, the first switch S1 (i.e., S-S1 in FIG. 8) and the fourth switch S4 (i.e., S-S4 in FIG. 8) are at a high level, and the second switch S2 (i.e., S-S2 in FIG. 8) and the third switch S3 (i.e., S-S3 in FIG. 8) are at a low level.

Within the second dead time period, the voltage at the first node AC1 rises and the voltage at the second node AC2 falls. In this case, the second switch S2 and the third switch S3 are controlled to be turned on, and the first switch S1 and the fourth switch S4 are controlled to be turned off. The first node AC1 transmits the discharging current to the ground via the second switch S2, and the third constant-current source M3 transmits the injection current to the second node AC2 via the third switch S3, such that the voltage rise at the first node AC1 is decelerated, and the voltage fall at the second node AC2 is decelerated. Therefore, the first switch S1 (i.e., S-S1 in FIG. 8) and the fourth switch S4 (i.e., S-S4 in FIG. 8) are at a low level, and the second switch S2 (i.e., S-S2 in FIG. 8) and the third switch S3 (i.e., S-S3 in FIG. 8) are at a high level.

It can be understood that the high level in the timing of the switching transistors Q1 to Q4 in FIG. 8 corresponds to the on state, and the low level corresponds to the off state. Similarly, the high level in the timing of the switches S1 to S4 in FIG. 8 corresponds to the on state, and the low level corresponds to the off state.

In the method according to the second embodiment, in the modulation mode, the change rates of the voltages at the first node AC1 and the second node AC2 decrease respectively. As illustrated by dashed-line portions of the first node AC1 and the second node AC2 in FIG. 8, a slope of the voltage rise and voltage fall at the first node AC1 and the second node AC2 becomes smaller within the dead time period. As illustrated by dashed-line portions of S-Q2 and S-Q3 within the first dead time period in FIG. 8, the second switching transistor Q2 and the third switching transistor Q3 are turned on with a delay. As illustrated by dashed-line portions of S-Q1 and S-Q4 within the second dead time period in FIG. 8, the first switching transistor Q1 and the fourth switching transistor Q4 are turned on with a delay.

With respect to the second embodiment, the present disclosure provides a logic control circuit 100. The logic control circuit 100 is configured to acquire control signals (i.e., S-S1, S-S2, S-S3, S-S4) of the switches S1 to S4 based on the state signals (i.e., S-Q1, S-Q2, S-Q3, S-Q4) of the switching transistors Q1 to Q4 respectively.

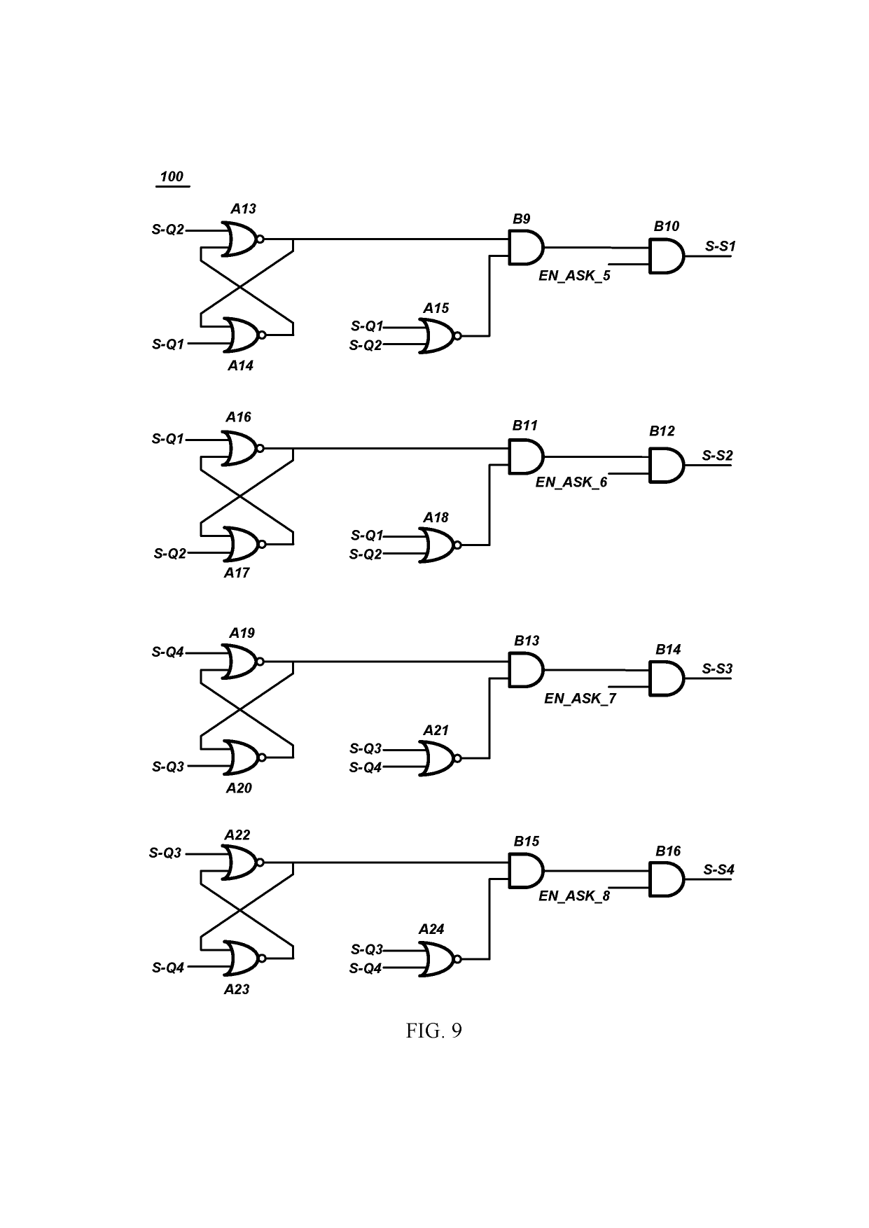

Specifically, referring to FIG. 9, the logic control circuit 100 includes a thirteenth NOR gate A13, a fourteenth NOR gate A14, a fifteenth NOR gate A15, a sixteenth NOR gate A16, a seventeenth NOR gate A17, an eighteenth NOR gate A18, a nineteenth NOR gate A19, a twentieth NOR gate A20, a twenty-first NOR gate A21, a twenty-second NOR gate A22, a twenty-third NOR gate A23, a twenty-fourth NOR gate A24, a ninth AND gate B9, a tenth AND gate B10, an eleventh AND gate B11, a twelfth AND gate B12, a thirteenth AND gate B13, a fourteenth AND gate B14, a fifteenth AND gate B15, and a sixteenth AND gate B16.

A first input terminal of the thirteenth NOR gate A13 is configured to receive the state signal S-Q2 of the second switching transistor Q2, a second input terminal of the thirteenth NOR gate A13 is electrically connected to an output terminal of the fourteenth NOR gate A14, and an output terminal of the thirteenth NOR gate A13 is electrically connected to a first input terminal of the fourteenth NOR gate A14 and a first input terminal of the ninth AND gate B9.

A second input terminal of the fourteenth NOR gate A14 is configured to receive the state signal S-Q1 of the first switching transistor Q1.

A first input terminal of the fifteenth NOR gate A15 is configured to receive the state signal S-Q1 of the first switching transistor Q1, a second input terminal of the fifteenth NOR gate A15 is configured to receive the state signal S-Q2 of the second switching transistor Q2, and an output terminal of the fifteenth NOR gate A15 is electrically connected to a second input terminal of the ninth AND gate B9.

An output terminal of the ninth AND gate B9 is electrically connected to a first input terminal of the tenth AND gate B10, a second input terminal of the tenth AND gate B10 is configured to receive a fifth modulation enable signal EN_ASK_5, and an output terminal of the tenth AND gate B10, as the control signal terminal of the first switch S1, is configured to output the control signal S-S1 of the first switch S1.

A first input terminal of the sixteenth NOR gate A16 is configured to receive the state signal S-Q1 of the first switching transistor Q1, a second input terminal of the sixteenth NOR gate A16 is electrically connected to an output terminal of the seventeenth NOR gate A17, and an output terminal of the sixteenth NOR gate A16 is electrically connected to a first input terminal of the seventeenth NOR gate A17 and a first input terminal of the eleventh AND gate B11.

A second input terminal of the seventeenth NOR gate A17 is configured to receive the state signal S-Q2 of the second switching transistor Q2.

A first input terminal of the eighteenth NOR gate A18 is configured to receive the state signal S-Q1 of the first switching transistor Q1, a second input terminal of the eighteenth NOR gate A18 is configured to receive the state signal S-Q2 of the second switching transistor Q2, and an output terminal of the eighteenth NOR gate A18 is electrically connected to a second input terminal of the eleventh AND gate B11.

An output terminal of the eleventh AND gate B11 is electrically connected to a first input terminal of the twelfth AND gate B12, a second input terminal of the twelfth AND gate B12 is configured to receive a sixth modulation enable signal EN_ASK_6, and an output terminal of the twelfth AND gate B12, as the control signal terminal of the second switch S2, is configured to output the control signal S-S2 of the second switch S2.

A first input terminal of the nineteenth NOR gate A19 is configured to receive the state signal S-Q4 of the fourth switching transistor Q4, a second input terminal of the nineteenth NOR gate A19 is electrically connected to an output terminal of the twentieth NOR gate A20, and an output terminal of the nineteenth NOR gate A19 is electrically connected to a first input terminal of the twentieth NOR gate A20 and a first input terminal of the thirteenth AND gate B13.

A second input terminal of the twentieth NOR gate A20 is configured to receive the state signal S-Q3 of the third switching transistor Q3.

A first input terminal of the twenty-first NOR gate A21 is configured to receive the state signal S-Q3 of the third switching transistor Q3, a second input terminal of the twenty-first NOR gate A21 is configured to receive the state signal S-Q4 of the fourth switching transistor Q4, and an output terminal of the twenty-first NOR gate A21 is electrically connected to a second input terminal of the thirteenth AND gate B13.

An output terminal of the thirteenth AND gate B13 is electrically connected to a first input terminal of the fourteenth AND gate B14, a second input terminal of the fourteenth AND gate B14 is configured to receive a seventh modulation enable signal EN_ASK_7, and an output terminal of the fourteenth AND gate B14, as the control signal terminal of the third switch S3, is configured to output the control signal S-S3 of the third switch S3.

A first input terminal of the twenty-second NOR gate A22 is configured to receive the state signal S-Q3 of the third switching transistor Q3, a second input terminal of the twenty-second NOR gate A22 is electrically connected to an output terminal of the twenty-third NOR gate A23, and an output terminal of the twenty-second NOR gate A22 is electrically connected to a first input terminal of the twenty-third NOR gate A23 and a first input terminal of the fifteenth AND gate B15.

A second input terminal of the twenty-third NOR gate A23 is configured to receive the state signal S-Q4 of the fourth switching transistor Q4.

A first input terminal of the twenty-fourth NOR gate A24 is configured to receive the state signal S-Q3 of the third switching transistor Q3, a second input terminal of the twenty-fourth NOR gate A24 is configured to receive the state signal S-Q4 of the fourth switching transistor Q4, and an output terminal of the twenty-fourth NOR gate A24 is electrically connected to a second input terminal of the fifteenth AND gate B15.

An output terminal of the fifteenth AND gate B15 is electrically connected to a first input terminal of the sixteenth AND gate B16, a second input terminal of the sixteenth AND gate B16 is configured to receive an eighth modulation enable signal EN_ASK_8, and an output terminal of the sixteenth AND gate B16, as the control signal terminal of the fourth switch S4, is configured to output the control signal S-S4 of the fourth switch S4.

In the second embodiment, each of the fifth modulation enable signal EN_ASK_5, the sixth modulation enable signal EN_ASK_6, the seventh modulation enable signal EN_ASK_7, and the eighth modulation enable signal EN_ASK_8 in the logic control circuit is configured to gate or enable the modulation mode and the non-modulation mode. The logic control circuit acquires control signals (i.e., S-S1, S-S2, S-S3, S-S4) of the switches S1 to S4 based on the state signals (i.e., S-Q1, S-Q2, S-Q3, S-Q4) of the switching transistors Q1 to Q4 respectively, and controls the states of the switches S1 to S4 based on the control signals of the switches S1 to S4 respectively. Within the dead time period, the constant-current source circuit is controlled such that the discharging current is transmitted from the first node or the second node to the ground or the injection current is transmitted to the first node or the second node, such that the change rates of the voltages at the first node and the second node are decelerated respectively, that is, the change rates of the voltages at the first node and the second node change respectively, which equivalently changes an output impedance of the receiver. In this way, a current in the receive coil changes, and hence a current in a transmit coil changes, such that ASK modulation is achieved. In this way, ASK modulation is not affected while the off-chip capacitors, the on-chip switching transistors, and the chip pins are reduced or eliminated.

In some embodiments, with respect to the full-bridge operating state: in a non-modulation mode, the logic control circuit is configured to: within the first dead time period, control the first switch and the fourth switch to switch from the off state to the on state, such that the first constant-current source transmits an injection current to the first node via the first switch and the second node transmits a discharging current to the ground via the fourth switch and the fourth constant-current source; or within the second dead time period, control the second switch and the third switch to switch from the off state to the on state, such that the first node transmits a discharging current to the ground via the second switch and the second constant-current source and the third constant-current source transmits an injection current to the second node via the third switch.

In the modulation mode, the logic control circuit is configured to control the first switch, the second switch, the third switch, and the fourth switch to be in the off state.

The embodiment herein differs from the second embodiment only in that the modulation mode and the non-modulation mode may be interchanged. Specifically, the modulation mode in the second embodiment is replaced with the non-modulation mode, and the non-modulation mode in the second embodiment is replaced with the modulation mode. That is, in the modulation mode, the constant-current source circuit does not operate, and there is no need to transmit currents through the first node AC1 and the second node AC2; and in the non-modulation mode, the constant-current source circuit is controlled such that currents are transmitted through the first node AC1 and the second node AC2. Control logic in the embodiment herein of the present disclosure is the same as that in the second embodiment, which is thus not described herein any further.

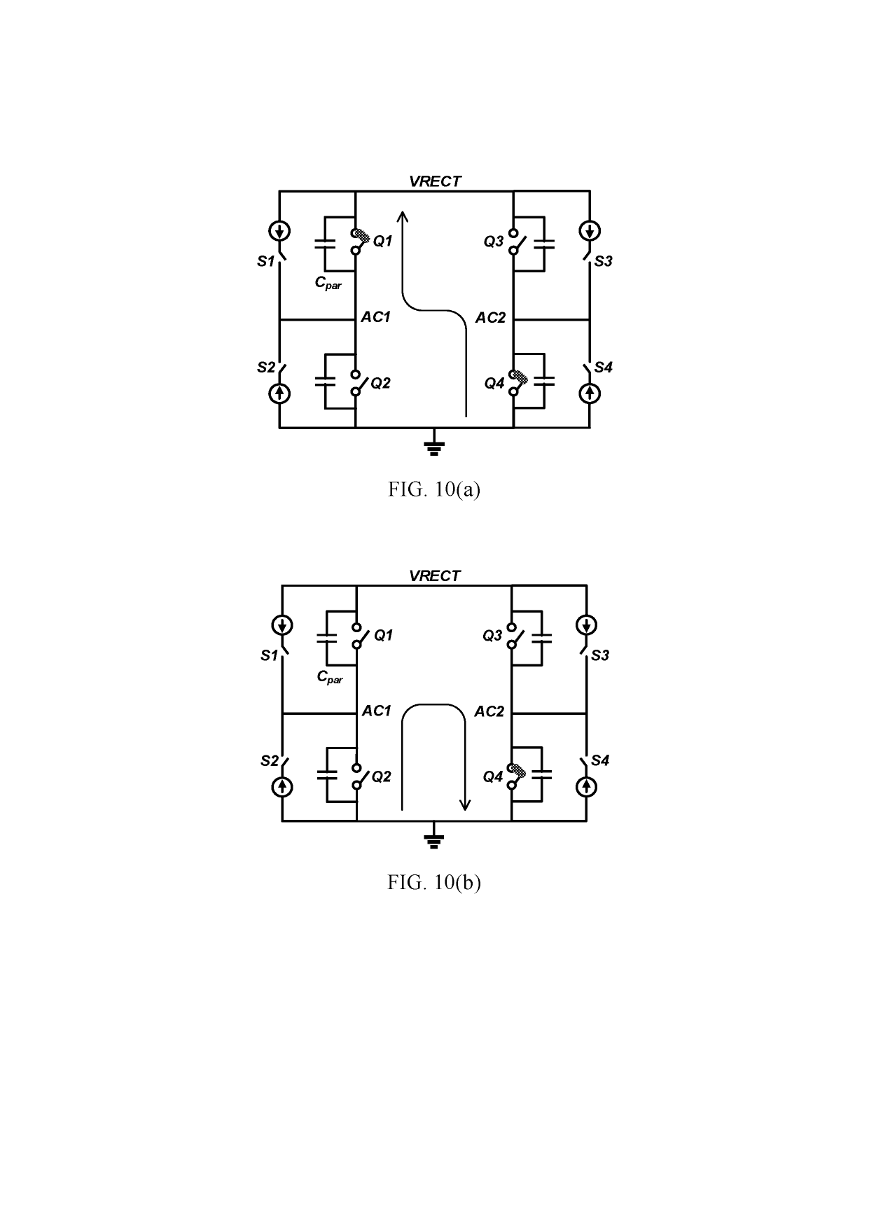

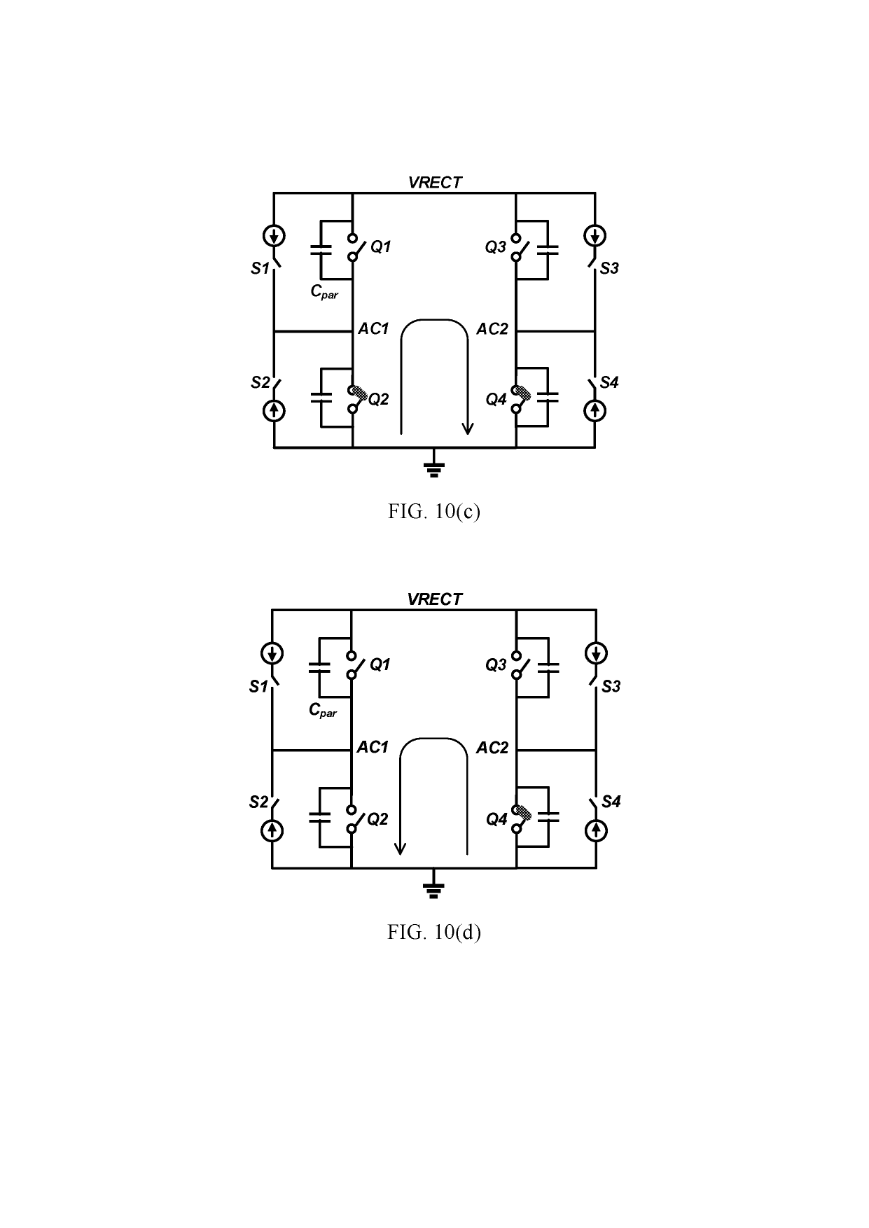

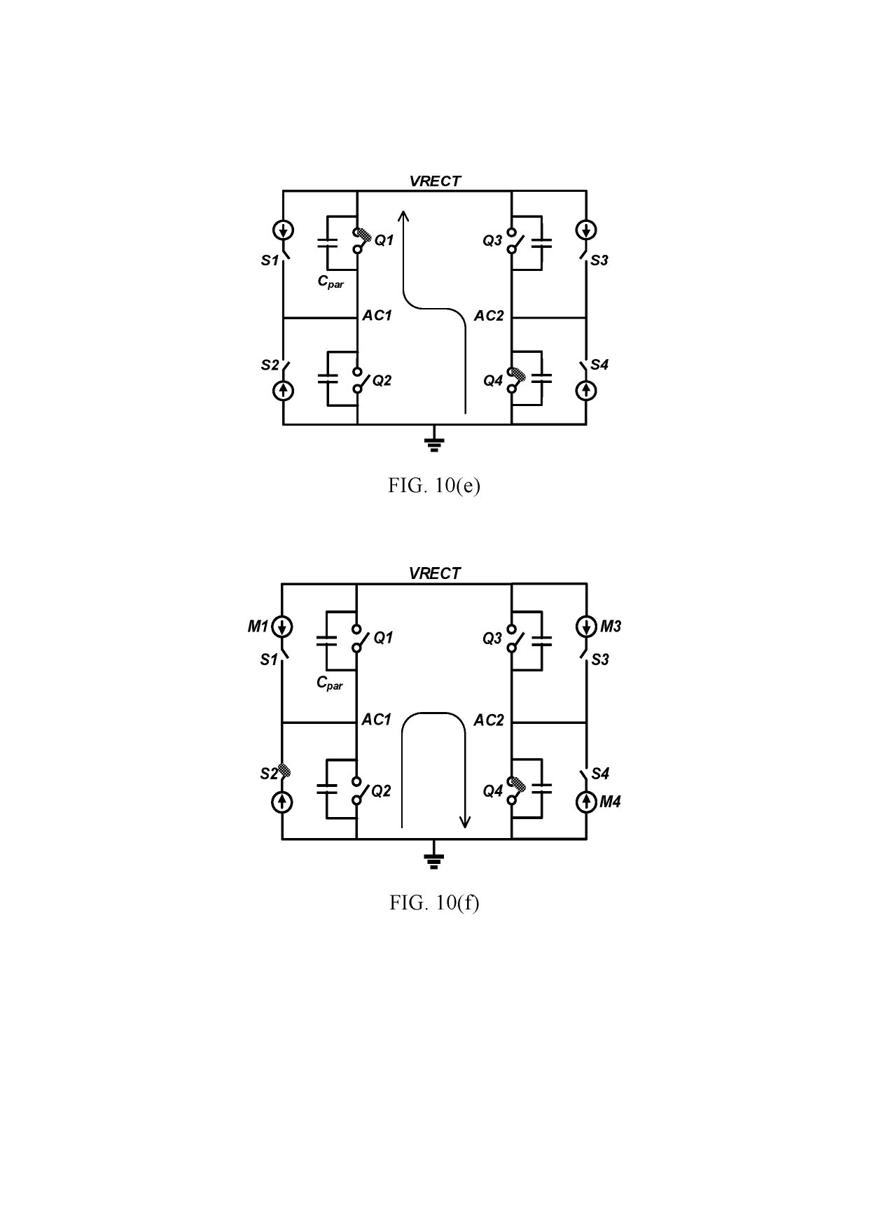

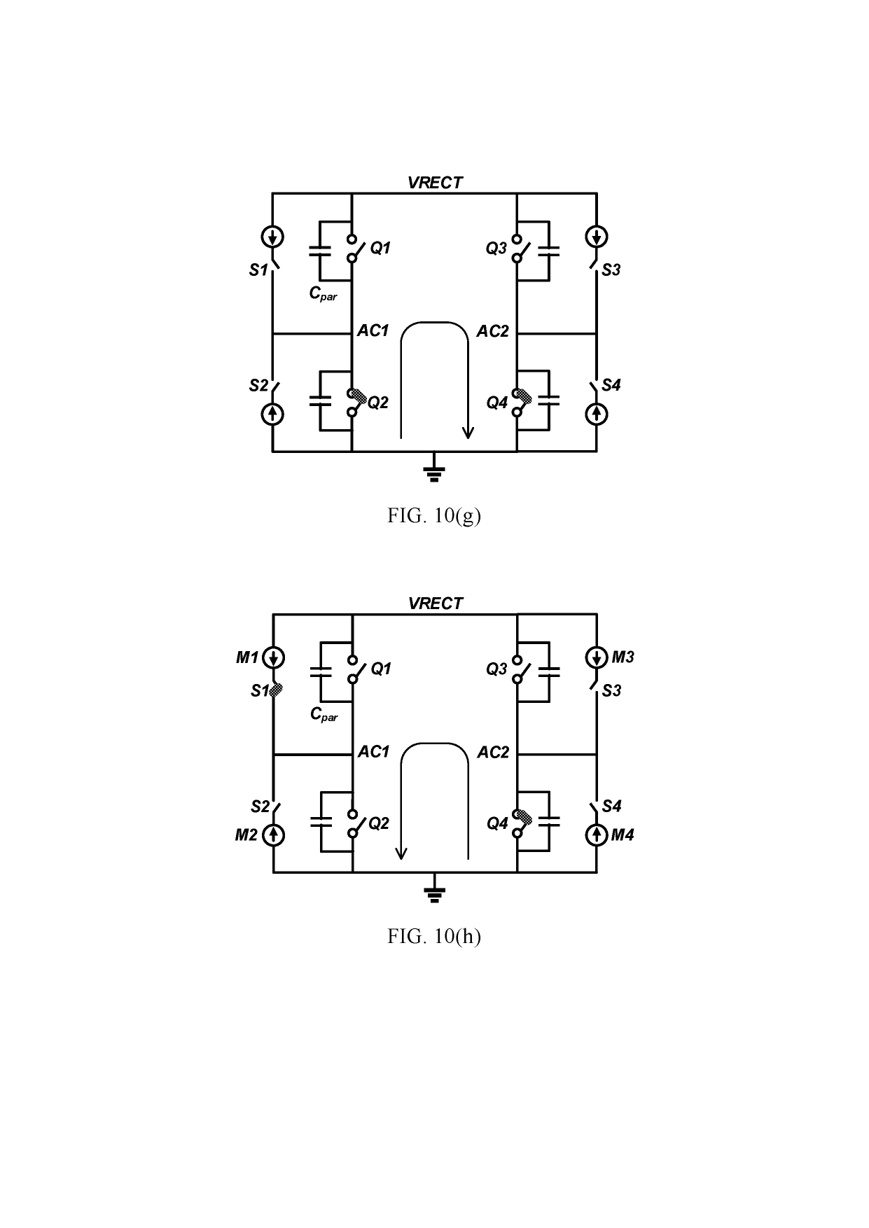

In some embodiments, referring to FIG. 10(a) to FIG. 10(h), schematic circuit control diagrams according to a third embodiment of the present disclosure are illustrated. FIG. 10(a), FIG. 10(b), FIG. 10(c), and FIG. 10(d) illustrates a non-modulation mode. FIG. 10(a) illustrates a first non-dead time period in the non-modulation mode, FIG. 10(c) illustrates a second non-dead time period in the non-modulation mode, FIG. 10(b) illustrates a first dead time period in the non-modulation mode, and FIG. 10(d) illustrates a second dead time period in the non-modulation mode. FIG. 10(e), FIG. 10(f), FIG. 10(g), and FIG. 10(h) illustrate a modulation mode. FIG. 10(e) illustrates a first non-dead time period in the modulation mode, FIG. 10(f) illustrates a second non-dead time period in the modulation mode, FIG. 10(f) illustrates a first dead time period in the modulation mode, and FIG. 10(h) illustrates a second dead time period in the modulation mode.

With respect to the half-bridge operating state: in the modulation mode, the logic control circuit is configured to: within the first dead time period (i.e., FIG. 7(f)), control the second switch S2 to switch from the off state to the on state, such that the first node AC1 transmits a discharging current to the ground via the second switch S2 and the second constant-current source M2; or within the second dead time period (i.e., FIG. 10(h)), control the first switch S1 to switch from the off state to the on state, such that the first constant-current source M1 transmits the injection current to the first node AC1 via the first switch S1.

A capacitor connected in parallel between the first terminal and the second terminal of each of the first switching transistor Q1, the second switching transistor Q2, the third switching transistor Q3, and the fourth switching transistor Q4 is a respective parasitic capacitance of these switching transistors. The parasitic capacitances are illustrated in the drawings only for the purpose of explaining the operating principles and do not represent externally added actual capacitors. For clarity, only the reference numbers of the constant-current sources within the dead time period (i.e., FIG. 10(f) and FIG. 10(h)) in the modulation mode are illustrated in the drawings. The reference numbers of the constant-current sources within the non-dead time period in the non-modulation mode are not explicitly illustrated. It is understood that the reference numbers of components in FIG. 10(a) to FIG. 10(h) remain consistent.

Compared to the full-bridge operating state, a higher voltage is output in the half-bridge operating state. In the embodiments of the present disclosure, the half-bridge operating state is as follows: the third switching transistor Q3 is constantly in the off state (or constantly turned off), the fourth switching transistor Q4 is constantly in the on state (or constantly turned on), and the alternating current signal of the receive coil is converted to the direct current signal by controlling the first switching transistor Q1 and the second switching transistor Q2 to be alternately turned on. Considering the fact that the switching transistors Q1 to Q4 in the rectifier circuit are symmetrically arranged, with respect to another half-bridge operating state: the first switching transistor Q1 is constantly in the off state (or constantly turned off), the second switching transistor Q2 is constantly in the on state (or constantly turned on), and the alternating current signal of the receive coil is converted to the direct current signal by controlling the third switching transistor Q3 and the fourth switching transistor Q4 to be alternately turned on. The corresponding ASK modulation circuit and method applicable to the wireless charging receiver also fall within the protection scope of the present disclosure.

The specific operation process according to the third embodiment is as follows, in the modulation mode, with respect to the half-bridge operating state, within the first non-dead time period, referring to FIG. 10(e), the first switching transistor Q1 and the fourth switching transistor Q4 are in the on state, and the second switching transistor Q2 and the third switching transistor Q3 are in the off state. As a result, the voltage at the first node AC1 is an output voltage VRECT.

Within the first dead time period, referring to FIG. 10(f), the first switching transistor Q1, the second switching transistor Q2, and the third switching transistor Q3 are all in the off state, and the fourth switching transistor Q4 is in the on state. In this case, the first node AC1 discharges to the ground via the parasitic capacitance of the second switching transistor Q2. Within the first dead time period, the logic control circuit controls the second switch S2 to switch from the off state to the on state. The first node AC1 transmits a discharging current to the ground via the second switch S2 and the second constant-current source M2, such that the voltage fall at the first node AC1 is accelerated.

Within the first non-dead time period, referring to FIG. 10(g), the second switching transistor Q2 and the fourth switching transistor Q4 are in the on state, and the first switching transistor Q1 and the third switching transistor Q3 are in the off state. The switches S1 to S4 are all in the off state.

Within the second dead time period, referring to FIG. 10(h), the first switching transistor Q1, the second switching transistor Q2, and the third switching transistor Q3 are all in the off state, and the fourth switching transistor Q4 is in the on state. In this case, the first node AC1 is charged by the parasitic capacitance of the first switching transistor Q1. Within the second dead time period, the logic control circuit controls the first switch S1 to switch from the off state to the on state. The first constant-current source M1 transmits an injection current to the first node AC1 via the first switch S1, such that the voltage rise at the first node AC1 is accelerated.

In the non-modulation mode, within the first non-dead time period, referring to FIG. 10(a), the first switching transistor Q1 and the fourth switching transistor Q4 are in the on state, and the second switching transistor Q2 and the third switching transistor Q3 are in the off state. The switches S1 to S4 are all in the off state.

Within the first dead time period, referring to FIG. 10(b), the first switching transistor Q1, the second switching transistor Q2, and the third switching transistor Q3 are all in the off state, the fourth switching transistor Q4 is in the on state, and the switches S1 to S4 are all in the off state.

Within the second non-dead time period, referring to FIG. 10(c), the second switching transistor Q2 and the fourth switching transistor Q4 are in the on state, and the first switching transistor Q1 and the third switching transistor Q3 are in the off state. The switches S1 to S4 are all in the off state.

Within the second dead time period, referring to FIG. 10(d), the first switching transistor Q1, the second switching transistor Q2, and the third switching transistor Q3 are all in the off state, the fourth switching transistor Q4 is in the on state, and the switches S1 to S4 are all in the off state.

In the non-modulation mode, the logic control circuit controls the first switch S1, the second switch S2, the third switch S3, and the fourth switch S4 to be in the off state. That is, in the non-modulation mode, the constant-current source circuit does not operate, and there is no need to transmit currents through the first node AC1 and the second node AC2.

In some embodiments, in the modulation mode according to the third embodiment, referring to FIG. 10(e) and FIG. 10(g), the logic control circuit controls, within the first non-dead time period and the second non-dead time period, the first switch S1, the second switch S2, the third switch S3, and the fourth switch S4 to be in the off state. That is, in the modulation mode, within the first non-dead time period and the second non-dead time period, the constant-current source circuit does not operate, and there is no need to transmit currents through the first node AC1 and the second node AC2.

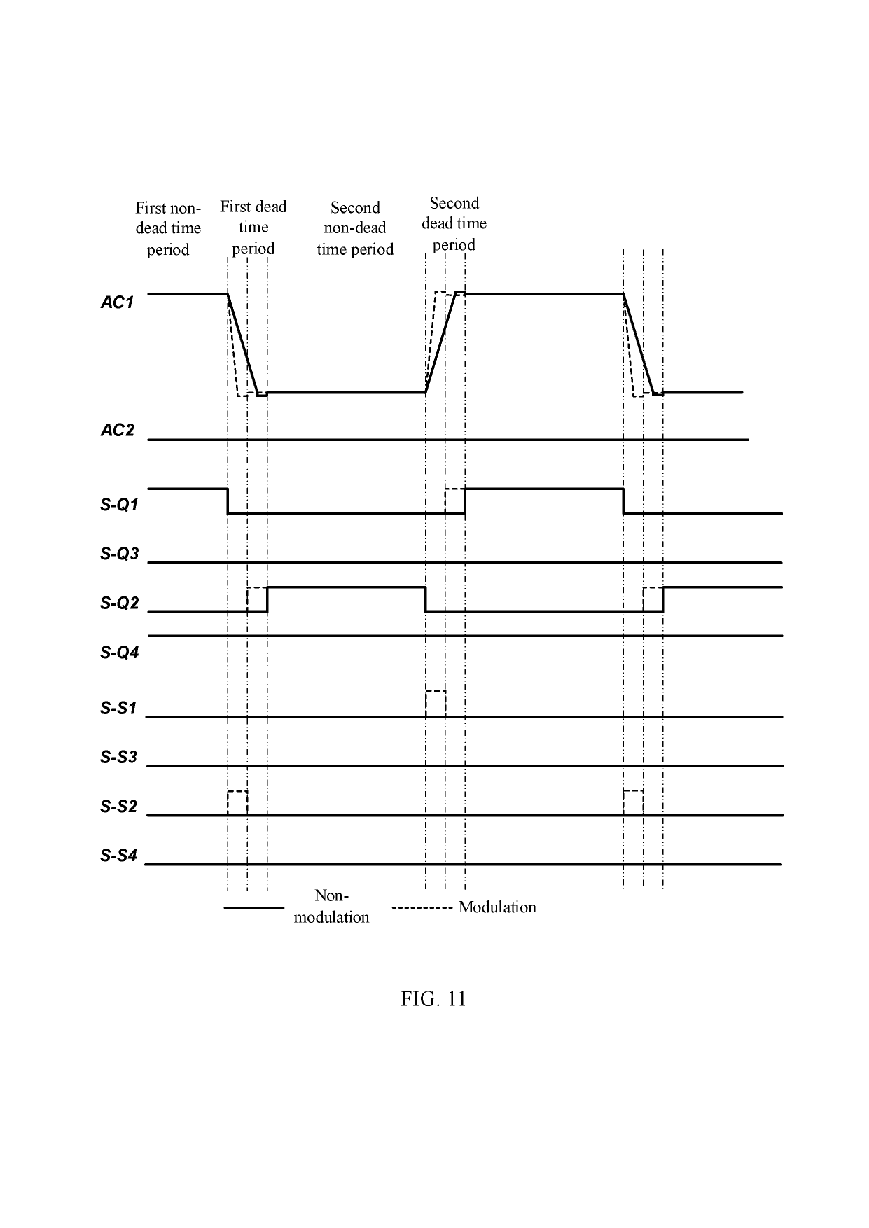

Referring to FIG. 11, FIG. 11 illustrates a timing diagram according to the third embodiment of the present disclosure. As illustrated in FIG. 11, in the non-modulation mode, within the first non-dead time period and the second non-dead time period, the third switching transistor Q3 is constantly in the off state (or constantly turned off), the fourth switching transistor Q4 is constantly in the on state (or constantly turned on), and the timing of the first switching transistor Q1 and the second switching transistor Q2 is as follows: in a case that a body diode of one of the first switching transistor Q1 and the second switching transistor Q2 is detected to be turned on, a switching transistor, whose body diode is detected to be turned on, is controlled to be turned on; or in a case that a current flowing through one of the first switching transistor Q1 and the second switching transistor Q2 is detected to cross zero, a switching transistor, whose current is detected to cross zero, is controlled to be turned off.

Within the first non-dead time period, the first switching transistor Q1 and the fourth switching transistor Q4 are in the on state, and the second switching transistor Q2 and the third switching transistor Q3 are in the off state. The switches S1 to S4 are all in the off state. Therefore, the first switching transistor Q1 (i.e., S-Q1 in FIG. 11) and the fourth switching transistor Q4 (i.e., S-Q4 in FIG. 11) are at a high level, the second switching transistor Q2 (i.e., S-Q2 in FIG. 11) and the third switching transistor Q3 (i.e., S-Q3 in FIG. 11) are at a low level, and the switches S1 to S4 (i.e., S-S1, S-S2, S-S3, and S-S4 in FIG. 11) are all at a low level.

Within the second non-dead time period, the second switching transistor Q2 and the fourth switching transistor Q4 are in the on state, and the first switching transistor Q1 and the third switching transistor Q3 are in the off state. The switches S1 to S4 are all in the off state. Therefore, the second switching transistor Q2 (i.e., S-Q2 in FIG. 11) and the fourth switching transistor Q4 (i.e., S-Q4 in FIG. 11) are at a high level, the first switching transistor Q1 (i.e., S-Q1 in FIG. 11) and the third switching transistor Q3 (i.e., S-Q3 in FIG. 11) are at a low level, and the switches S1 to S4 (i.e., S-S1, S-S2, S-S3, and S-S4 in FIG. 11) are all at a low level.

With respect to the dead time period, the switches S1 to S4 are all in the off state, and there is no need to transmit currents through the first node AC1 and the second node AC2.

Within the first dead time period, the first switching transistor Q1, the second switching transistor Q2, and the third switching transistor Q3 are all in the off state, the fourth switching transistor Q4 is in the on state, and the switches S1 to S4 are all in the off state. Therefore, the first switching transistor Q1 (i.e., S-Q1 in FIG. 11), the second switching transistor Q2 (i.e., S-Q2 in FIG. 11), and the third switching transistor Q3 (i.e., S-Q3 in FIG. 11) are all at a low level, the fourth switching transistor Q4 (i.e., S-Q4 in FIG. 11) is at a high level, and the switches S1 to S4 (i.e., S-S1, S-S2, S-S3, and S-S4 in FIG. 11) are all at a low level.

Within the second dead time period, the first switching transistor Q1, the second switching transistor Q2, and the third switching transistor Q3 are all in the off state, the fourth switching transistor Q4 is in the on state, and the switches S1 to S4 are all in the off state. Therefore, the first switching transistor Q1 (i.e., S-Q1 in FIG. 11), the second switching transistor Q2 (i.e., S-Q2 in FIG. 11), and the third switching transistor Q3 (i.e., S-Q3 in FIG. 11) are all at a low level, the fourth switching transistor Q4 (i.e., S-Q4 in FIG. 11) is at a high level, and the switches S1 to S4 (i.e., S-S1, S-S2, S-S3, and S-S4 in FIG. 11) are all at a low level.

Still referring to FIG. 11, in the modulation mode, within the non-dead time period, the third switching transistor Q3 is constantly in the off state (or constantly turned off), the fourth switching transistor Q4 is constantly in the on state (or constantly turned on), and the timing of the first switching transistor Q1 and the second switching transistor Q2 is as follows: in a case that a body diode of one of the first switching transistor Q1 and the second switching transistor Q2 is detected to be turned on, a switching transistor, whose body diode is detected to be turned on, is controlled to be turned on; or in a case that a current flowing through one of the first switching transistor Q1 and the second switching transistor Q2 is detected to cross zero, a switching transistor, whose current is detected to cross zero, is controlled to be turned off.

Within the first non-dead time period, the first switching transistor Q1, the second switching transistor Q2, and the third switching transistor Q3 are all in the off state, the fourth switching transistor Q4 is in the on state, and the switches S1 to S4 are all in the off state. Therefore, the first switching transistor Q1 (i.e., S-Q1 in FIG. 11), the second switching transistor Q2 (i.e., S-Q2 in FIG. 11), and the third switching transistor Q3 (i.e., S-Q3 in FIG. 11) are all at a low level, the fourth switching transistor Q4 (i.e., S-Q4 in FIG. 11) is at a high level, and the switches S1 to S4 (i.e., S-S1, S-S2, S-S3, and S-S4 in FIG. 11) are all at a low level.

Within the second non-dead time period, the first switching transistor Q1, the second switching transistor Q2, and the third switching transistor Q3 are all in the off state, the fourth switching transistor Q4 is in the on state, and the switches S1 to S4 are all in the off state. Therefore, the first switching transistor Q1 (i.e., S-Q1 in FIG. 11), the second switching transistor Q2 (i.e., S-Q2 in FIG. 11), and the third switching transistor Q3 (i.e., S-Q3 in FIG. 11) are all at a low level, the fourth switching transistor Q4 (i.e., S-Q4 in FIG. 11) is at a high level, and the switches S1 to S4 (i.e., S-S1, S-S2, S-S3, and S-S4 in FIG. 11) are all at a low level.

Within the first dead time period, the voltage at the first node AC1 falls. In this case, the first switch S1, the third switch S3, and the fourth switch S4 are controlled to be turned off, and the second switch S2 is controlled to be turned on. The first node AC1 transmits the discharging current to the ground via the second switch S2, such that the voltage fall at the first node AC1 is accelerated. Therefore, the first switch S1 (i.e., S-S1 in FIG. 11), the third switch S3 (i.e., S-S3 in FIG. 11), and the fourth switch S4 (i.e., S-S4 in FIG. 11) are all at a low level, and the second switch S2 (i.e., S-S2 in FIG. 11) is at a high level.

Within the second dead time period, the voltage at the first node AC1 rises. In this case, the second switch S2, the third switch S3, and the fourth switch S4 are controlled to be turned off, and the first switch S1 is controlled to be turned on. The first constant-current source M1 transmits an injection current to the first node AC1 via the first switch S1, such that the voltage rise at the first node AC1 is accelerated. Therefore, the first switch S1 (i.e., S-S1 in FIG. 11) is at a high level, and the second switch S2 (i.e., S-S2 in FIG. 11), the third switch S3 (i.e., S-S3 in FIG. 11), and the fourth switch S4 (i.e., S-S4 in FIG. 11) are all at a low level.

It can be understood that the high level in the timing of the switching transistors Q1 to Q4 in FIG. 11 corresponds to the on state, and the low level corresponds to the off state. Similarly, the high level in the timing of the switches S1 to S4 in FIG. 11 corresponds to the on state, and the low level corresponds to the off state.

In the method according to the third embodiment, in the modulation mode, the change rate of the voltage at the first node AC1 increases. As illustrated by dashed-line portions of the first node AC1 in FIG. 11, a slope of the voltage rise and voltage fall at the first node AC1 becomes larger within the dead time period. As illustrated by dashed-line portions of S-Q1 within the second dead time period in FIG. 11, the first switching transistor Q1 is turned on in advance. As illustrated by dashed-line portions of S-Q2 within the first dead time period in FIG. 11, the second switching transistor Q2 is turned on in advance.

With respect to the third embodiment, the present disclosure provides a logic control circuit 100. The logic control circuit 100 is configured to acquire the control signals (i.e., S-S1, S-S2, S-S3, S-S4) of the switches S1 to S4 based on the state signals (i.e., S-Q1, S-Q2, S-Q3, S-Q4) of the switching transistors Q1 to Q4 respectively.

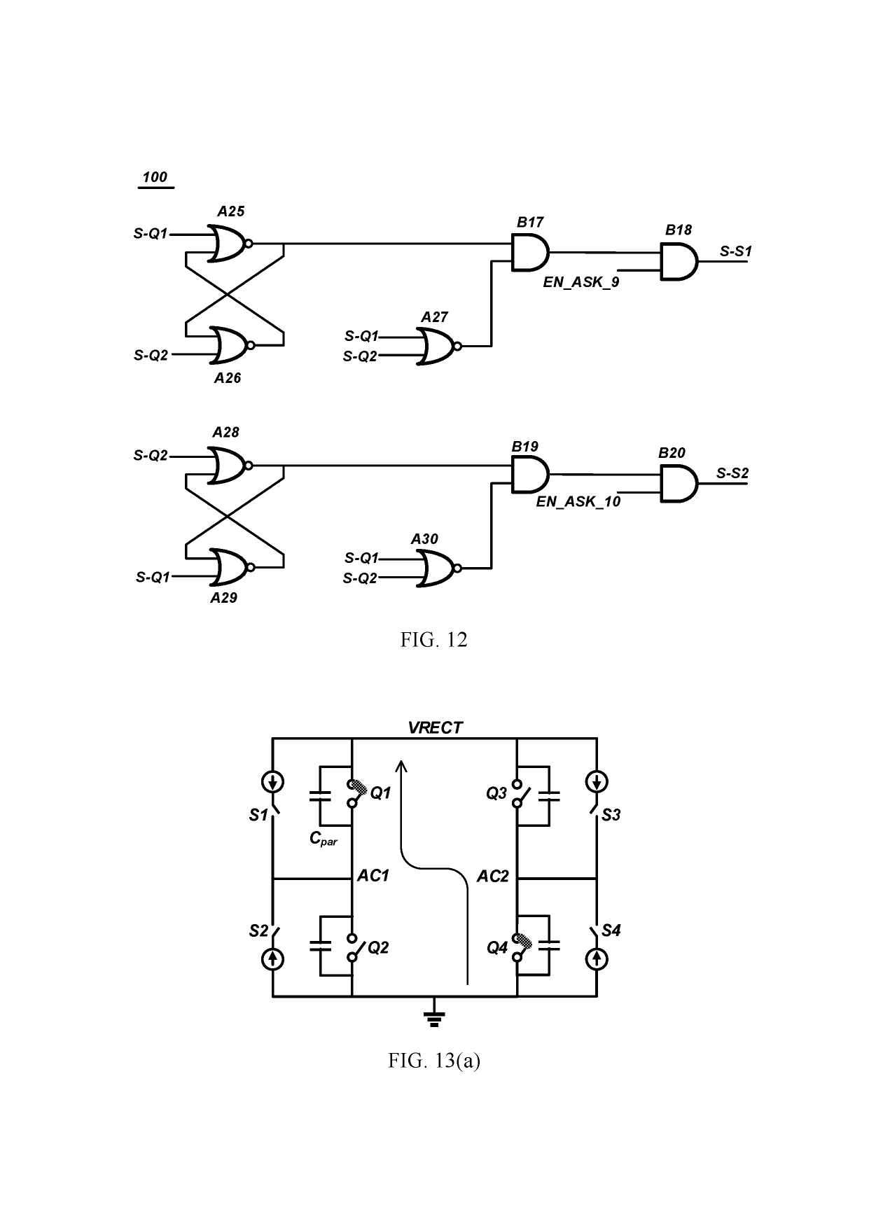

Specifically, referring to FIG. 12, the circuit 100 includes a twenty-fifth NOR gate A25, a twenty-sixth NOR gate A26, a twenty-seventh NOR gate A27, a twenty-eighth NOR gate A28, a twenty-ninth NOR gate A29, a thirtieth NOR gate A30, a seventeenth AND gate B17, an eighteenth AND gate B18, a nineteenth AND gate B19, and a twentieth AND gate B20.

A first input terminal of the twenty-fifth NOR gate A25 is configured to receive the state signal S-Q1 of the first switching transistor Q1, a second input terminal of the twenty-fifth NOR gate A25 is electrically connected to an output terminal of the twenty-sixth NOR gate A26, and an output terminal of the twenty-fifth NOR gate A25 is electrically connected to a first input terminal of the twenty-sixth NOR gate A26 and a first input terminal of the seventeenth AND gate B17.

A second input terminal of the twenty-sixth NOR gate A26 is configured to receive the state signal S-Q2 of the second switching transistor Q2.

A first input terminal of the twenty-seventh NOR gate A27 is configured to receive the state signal S-Q1 of the first switching transistor Q1, a second input terminal of the twenty-seventh NOR gate A27 is configured to receive the state signal S-Q2 of the second switching transistor Q2, and an output terminal of the twenty-seventh NOR gate A27 is electrically connected to a second input terminal of the seventeenth AND gate B17.

An output terminal of the seventeenth AND gate B17 is electrically connected to a first input terminal of the eighteenth AND gate B18, a second input terminal of the eighteenth AND gate B18 is configured to receive a ninth modulation enable signal EN_ASK_9, and an output terminal of the eighteenth AND gate B18, as the control signal terminal of the first switch S1, is configured to output the control signal S-S1 of the first switch S1.

A first input terminal of the twenty-eighth NOR gate A28 is configured to receive the state signal S-Q2 of the second switching transistor Q2, a second input terminal of the twenty-eighth NOR gate A28 is electrically connected to an output terminal of the twenty-ninth NOR gate A29, and an output terminal of the twenty-eighth NOR gate A28 is electrically connected to a first input terminal of the twenty-ninth NOR gate A29 and a first input terminal of the nineteenth AND gate B19.

A second input terminal of the twenty-ninth NOR gate A29 is configured to receive the state signal S-Q1 of the first switching transistor Q1.

A first input terminal of the thirtieth NOR gate A30 is configured to receive the state signal S-Q1 of the first switching transistor Q1, a second input terminal of the thirtieth NOR gate A30 is configured to receive the state signal S-Q2 of the second switching transistor Q2, and an output terminal of the thirtieth NOR gate A30 is electrically connected to a second input terminal of the nineteenth AND gate B19.

An output terminal of the nineteenth AND gate B19 is electrically connected to a first input terminal of the twentieth AND gate B20, a second input terminal of the twentieth AND gate B20 is configured to receive a tenth modulation enable signal EN_ASK_10, and an output terminal of the twentieth AND gate B20, as the control signal terminal of the second switch S2, is configured to output the control signal S-S2 of the second switch S2.

In the third embodiment, the ninth modulation enable signal EN_ASK_9 and the tenth modulation enable signal EN_ASK_10 in the logic control circuit are configured to gate or enable the modulation mode and the non-modulation mode. The logic control circuit acquires the control signals (i.e., S-S1, S-S2) of the first switch S1 and the second switch S2 based on the state signals (i.e., S-Q1, S-Q2) of the first switching transistor Q1 and the second transistor Q2 respectively, and controls the states of the first switch S1 and the second switch S2 based on the control signals of the first switch S1 and the second switch S2 respectively. Within the dead time period, the constant-current source circuit is controlled that the discharging current is transmitted from the first node to the ground or the injection current is transmitted to the first node, such that the change rate of the voltage at the first node increases, that is, the change rate of the voltage at the first node changes, which equivalently changes an output impedance of the receiver. In this way, a current in the receive coil changes, and hence a current in a transmit coil changes, such that ASK modulation is achieved. In this way, ASK modulation is not affected while the off-chip capacitors, the on-chip switching transistors, and the chip pins are reduced or eliminated.

In some embodiments, with respect to the half-bridge operating state: in the non-modulation mode, the logic control circuit is configured to: within the first dead time period, control the second switch to switch from the off state to the on state, such that the first node transmits the discharging current to the ground via the second switch and the second constant-current source; or within the second dead time period, control the first switch to switch from the off state to the on state, such that the first constant-current source transmits the injection current to the first node via the first switch.

In the modulation mode, the logic control circuit is configured to control the first switch, the second switch, the third switch, and the fourth switch to be in the off state.

The embodiment herein differs from the third embodiments only in that the modulation mode and the non-modulation mode may be interchanged. Specifically, the modulation mode in the third embodiment is replaced with the non-modulation mode, and the non-modulation mode in the third embodiment is replaced with the modulation mode. That is, in the modulation mode, the constant-current source circuit does not operate, and there is no need to transmit currents through the first node AC1 and the second node AC2; and in the non-modulation mode, the constant-current source circuit is controlled such that currents are transmitted through the first node AC1 and the second node AC2. Control logic in the embodiment herein of the present disclosure is the same as that in the third embodiment, which is thus not described herein any further.

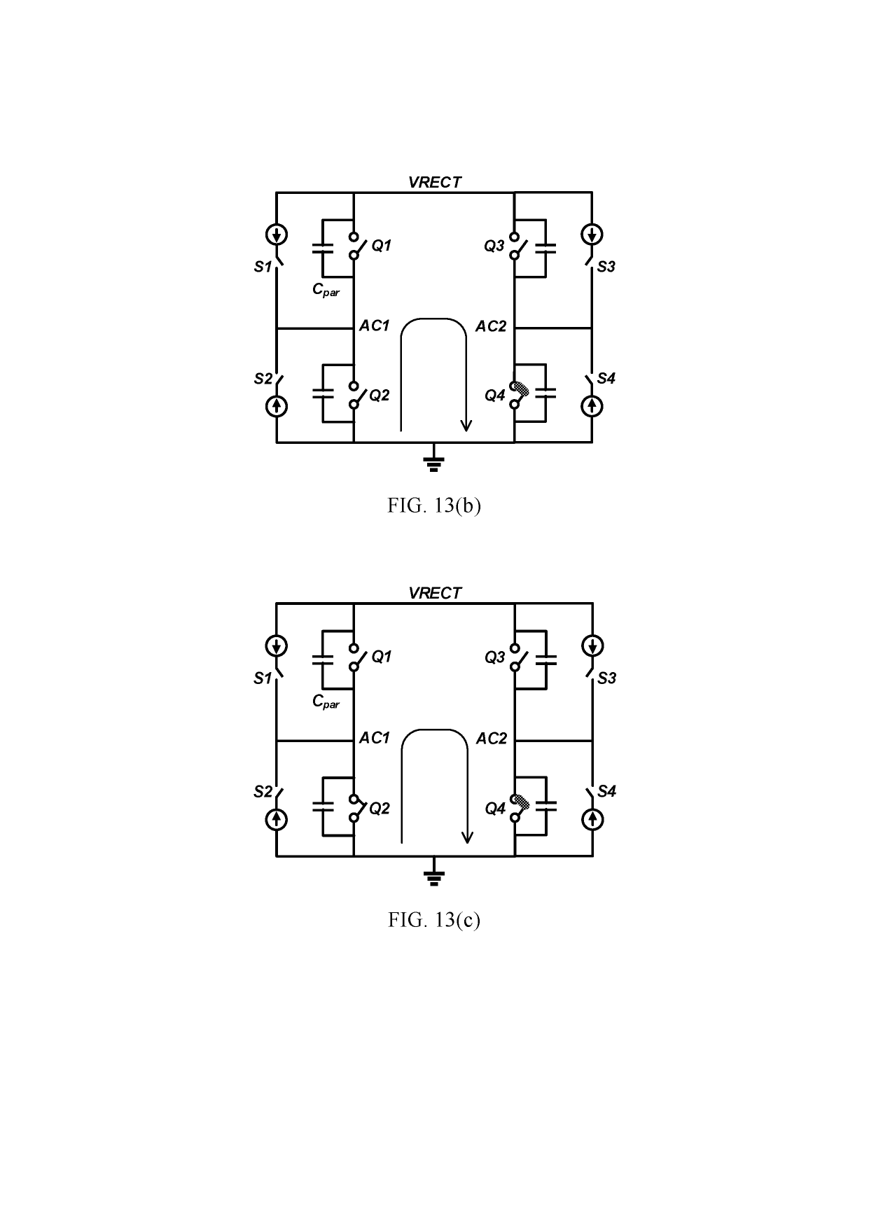

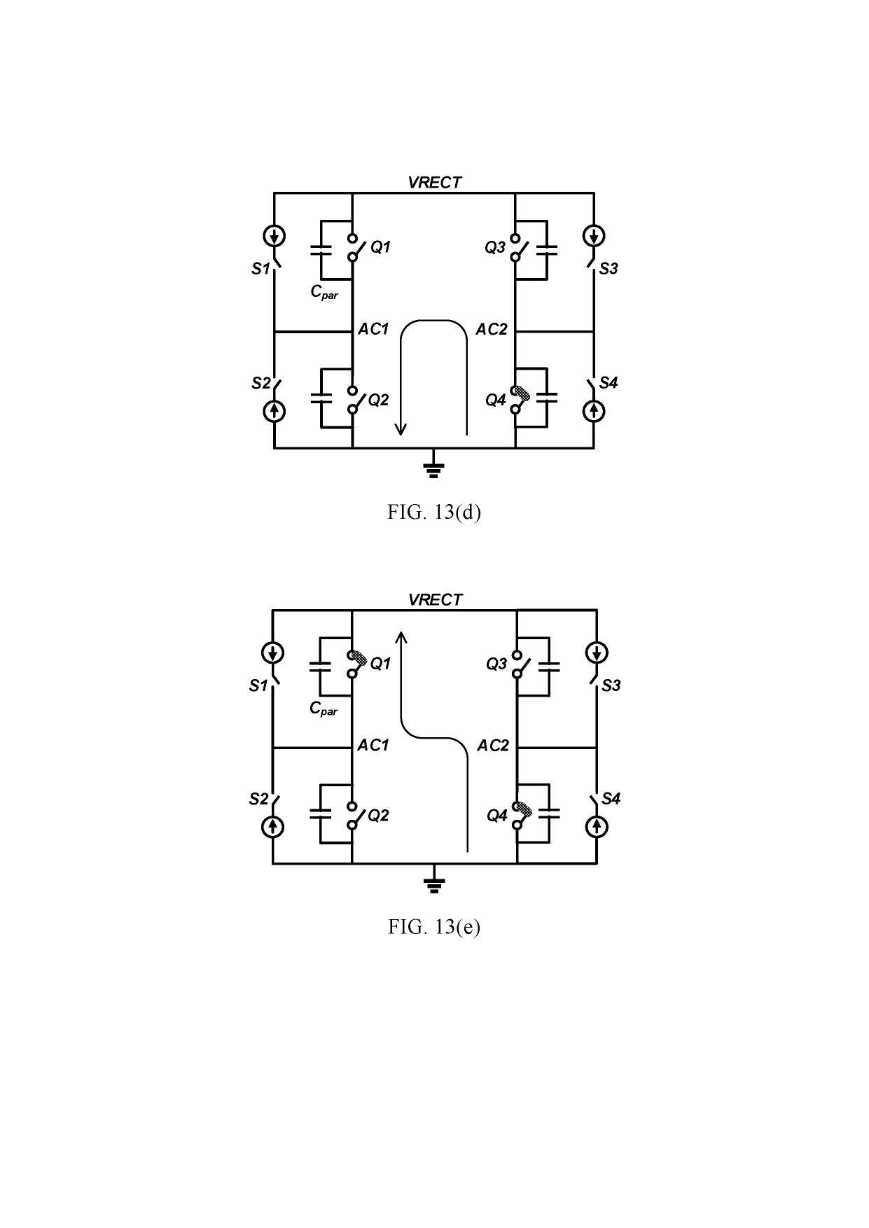

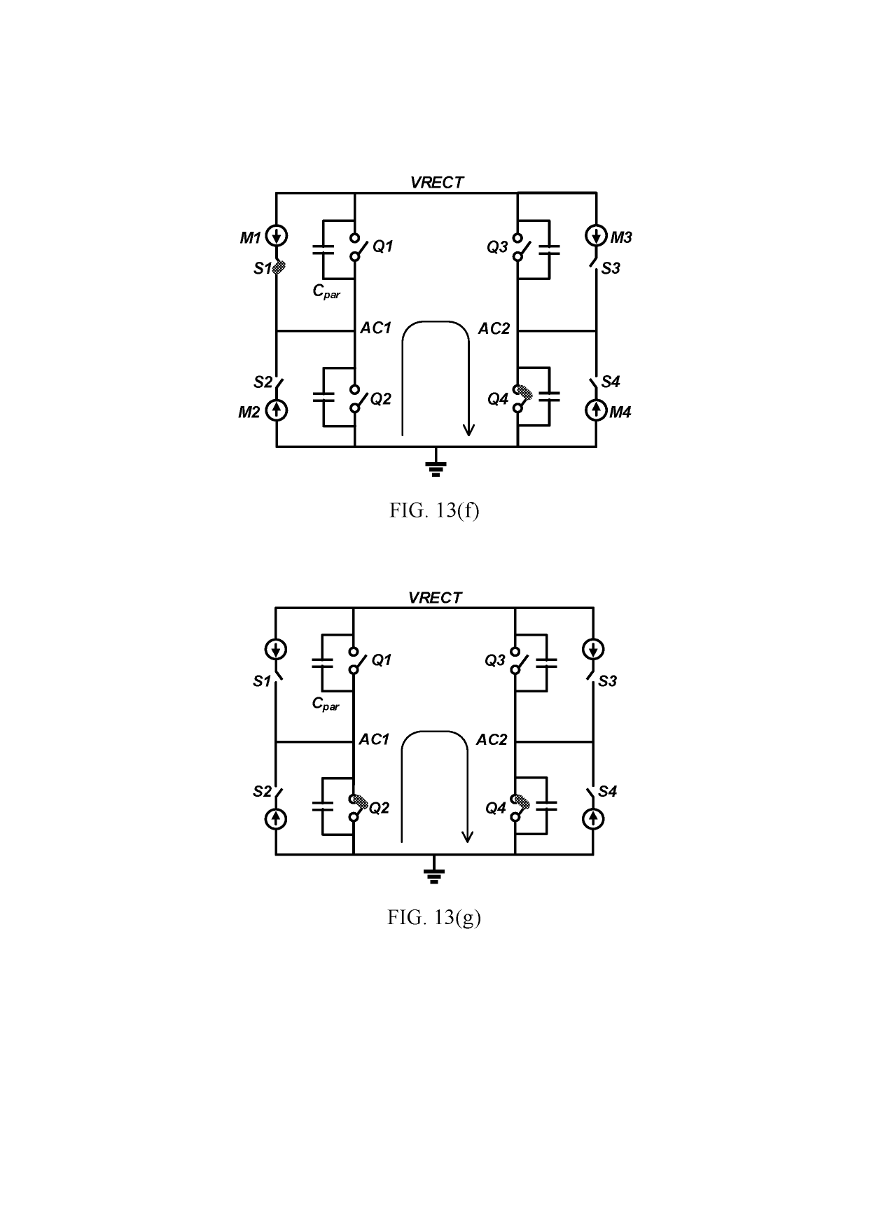

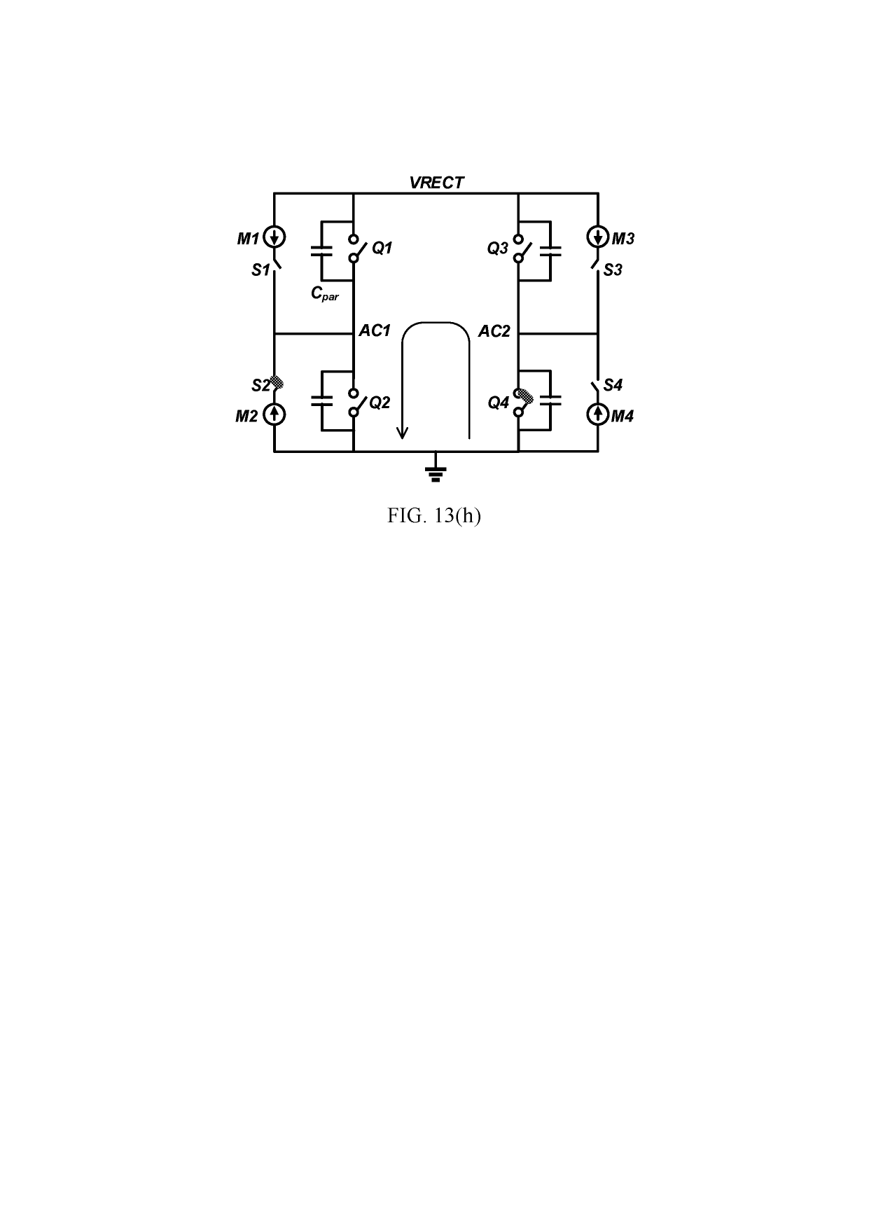

In some embodiments, referring to FIG. 13(a) to FIG. 13(h), schematic circuit control diagrams according to a fourth embodiment of the present disclosure are illustrated. FIG. 13(a), FIG. 13(b), FIG. 13(c), and FIG. 13(d) illustrates a non-modulation mode. FIG. 13(a) illustrates a first non-dead time period in the non-modulation mode, FIG. 13(c) illustrates a second non-dead time period in the non-modulation mode, FIG. 13(b) illustrates a first dead time period in the non-modulation mode, and FIG. 13(d) illustrates a second dead time period in the non-modulation mode. FIG. 13(e), FIG. 13(f), FIG. 13(g), and FIG. 13(h) illustrate a modulation mode. FIG. 13(e) illustrates a first non-dead time period in the modulation mode, FIG. 13(f) illustrates a second non-dead time period in the modulation mode, FIG. 13(f) illustrates a first dead time period in the modulation mode, and FIG. 13(h) illustrates a second dead time period in the modulation mode.

With respect to the half-bridge operating state: in the modulation mode, the logic control circuit is configured to: within the first dead time period (i.e., FIG. 13(f)), control the first switch S1 to switch from the off state to the on state, such that the first constant-current source M1 transmits the injection current to the first node AC1 via the first switch S1; or within the second dead time period (i.e., FIG. 13(h)), control the second switch S2 to switch from the off state to the on state, such that the first node AC1 transmits the discharging current to the ground via the second switch S2 and the second constant-current source M2.

A capacitor connected in parallel between the first terminal and the second terminal of each of the first switching transistor Q1, the second switching transistor Q2, the third switching transistor Q3, and the fourth switching transistor Q4 is a respective parasitic capacitance of the each of these switching transistors thereof. The parasitic capacitances are illustrated in the drawings only for the purpose of explaining the operating principles and do not represent externally added actual capacitors. For clarity, only the reference numbers of the constant-current sources within the dead time period (i.e., FIG. 13(f) and FIG. 13(h)) in the modulation mode are illustrated in the drawings. The reference numbers of the constant-current sources within the non-dead time period in the non-modulation mode are not explicitly illustrated. It is understood that the reference numbers of components in FIG. 13(a) to FIG. 13(h) remain consistent.

Compared to the full-bridge operating state, a higher voltage is output in the half-bridge operating state. In the embodiments of the present disclosure, the half-bridge operating state is as follows: the third switching transistor Q3 is constantly in the off state (or constantly turned off), the fourth switching transistor Q4 is constantly in the on state (or constantly turned on), and the alternating current signal of the receive coil is converted to the direct current signal by controlling the first switching transistor Q1 and the second switching transistor Q2 to be alternately turned on. Considering the fact that the switching transistors Q1 to Q4 in the rectifier circuit are symmetrically arranged, with respect to another half-bridge operating state: the first switching transistor Q1 is constantly in the off state (or constantly turned off), the second switching transistor Q2 is constantly in the on state (or constantly turned on), and the alternating current signal of the receive coil is converted to the direct current signal by controlling the third switching transistor Q3 and the fourth switching transistor Q4 to be alternately turned on. The corresponding ASK modulation circuit and method applicable to the wireless charging receiver also fall within the protection scope of the present disclosure.

The specific operation process according to the fourth embodiment is as follows, in the modulation mode, with respect to the half-bridge operating state, within the first non-dead time period, referring to FIG. 13(e), the first switching transistor Q1 and the fourth switching transistor Q4 are in the on state, and the second switching transistor Q2 and the third switching transistor Q3 are in the off state. As a result, the voltage at the first node AC1 is an output voltage VRECT.

Within the first dead time period, referring to FIG. 13(f), the first switching transistor Q1, the second switching transistor Q2, and the third switching transistor Q3 are all in the off state, and the fourth switching transistor Q4 is in the on state. In this case, the first node AC1 discharges to the ground via the parasitic capacitance of the second switching transistor Q2. Within the first dead time period, the logic control circuit controls the first switch S1 to switch from the off state to the on state, and the first constant-current source M1 transmits an injection current to the first node AC1 via the first switch S1, such that the voltage fall at the first node AC1 is decelerated.

Within the second non-dead time period, referring to FIG. 13(g), the second switching transistor Q2 and the fourth switching transistor Q4 are in the on state, and the first switching transistor Q1 and the third switching transistor Q3 are in the off state. The switches S1 to S4 are all in the off state.

Within the second dead time period, referring to FIG. 13(h), the first switching transistor Q1, the second switching transistor Q2, and the third switching transistor Q3 are all in the off state, and the fourth switching transistor Q4 is in the on state. In this case, the first node AC1 is charged by the parasitic capacitance of the first switching transistor Q1. Within the second dead time period, the logic control circuit controls the second switch S2 to switch from the off state to the on state, and the first node AC1 transmits a discharging current to the ground via the second switch S2 and the second constant-current source M2, such that the voltage rise at the first node AC1 is decelerated.

Within the first non-dead time period, referring to FIG. 13(a), the first switching transistor Q1 and the fourth switching transistor Q4 are in the on state, and the second switching transistor Q2 and the third switching transistor Q3 are in the off state. The switches S1 to S4 are all in the off state.

Within the first dead time period, referring to FIG. 13(b), the first switching transistor Q1, the second switching transistor Q2, and the third switching transistor Q3 are all in the off state, the fourth switching transistor Q4 is in the on state, and the switches S1 to S4 are all in the off state.

Within the second non-dead time period, referring to FIG. 13(c), the second switching transistor Q2 and the fourth switching transistor Q4 are in the on state, and the first switching transistor Q1 and the third switching transistor Q3 are in the off state. The switches S1 to S4 are all in the off state.

Within the second dead time period, referring to FIG. 13(d), the first switching transistor Q1, the second switching transistor Q2, and the third switching transistor Q3 are all in the off state, the fourth switching transistor Q4 is in the on state, and the switches S1 to S4 are all in the off state.

In the non-modulation mode, the logic control circuit controls the first switch S1, the second switch S2, the third switch S3, and the fourth switch S4 to be in the off state. That is, in the non-modulation mode, the constant-current source circuit does not operate, and there is no need to transmit currents through the first node AC1 and the second node AC2.

In some embodiments, in the modulation mode according to the fourth embodiment, referring to FIG. 13(e) and FIG. 13(g), the logic control circuit controls, within the first non-dead time period and the second non-dead time period, the first switch S1, the second switch S2, the third switch S3, and the fourth switch S4 to be in the off state. That is, in the modulation mode, within the first non-dead time period and the second non-dead time period, the constant-current source circuit does not operate, and there is no need to transmit currents through the first node AC1 and the second node AC2.

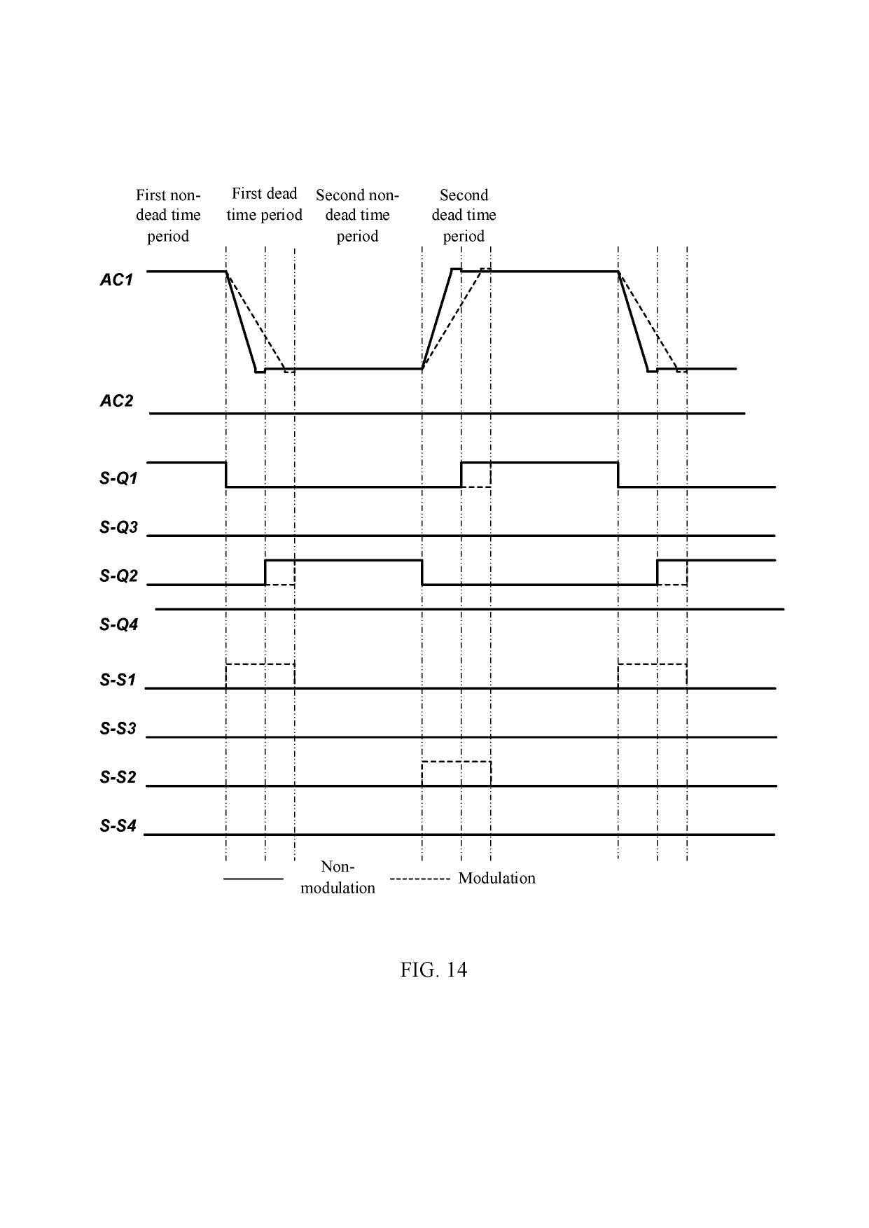

Referring to FIG. 14, FIG. 14 illustrates a timing diagram according to the fourth embodiment of the present disclosure. As illustrated in FIG. 14, in the non-modulation mode, within the first non-dead time period and the second non-dead time period, the third switching transistor Q3 is constantly in the off state (or constantly turned off), the fourth switching transistor Q4 is constantly in the on state (or constantly turned on), and the timing of the first switching transistor Q1 and the second switching transistor Q2 is as follows: in a case where the body diode of one of the first switching transistor Q1 and the second switching transistor Q2 is detected to be turned on, a switching transistor, whose body diode is detected to be turned on, is controlled to be turned on; or in a case that a current flowing through one of the first switching transistor Q1 and the second switching transistor Q2 is detected to cross zero, a switching transistor, whose current is detected to cross zero, is controlled to be turned off.

Within the first non-dead time period, the first switching transistor Q1 and the fourth switching transistor Q4 are in the on state, and the second switching transistor Q2 and the third switching transistor Q3 are in the off state. The switches S1 to S4 are all in the off state. Therefore, the first switching transistor Q1 (i.e., S-Q1 in FIG. 14) and the fourth switching transistor Q4 (i.e., S-Q4 in FIG. 14) are at a high level, the second switching transistor Q2 (i.e., S-Q2 in FIG. 14) and the third switching transistor Q3 (i.e., S-Q3 in FIG. 14) are at a low level, and the switches S1 to S4 (i.e., S-S1, S-S2, S-S3, and S-S4 in FIG. 14) are all at a low level.

Within the second non-dead time period, the second switching transistor Q2 and the fourth switching transistor Q4 are in the on state, and the first switching transistor Q1 and the third switching transistor Q3 are in the off state. The switches S1 to S4 are all in the off state. Therefore, the second switching transistor Q2 (i.e., S-Q2 in FIG. 14) and the fourth switching transistor Q4 (i.e., S-Q4 in FIG. 14) are at a high level, the first switching transistor Q1 (i.e., S-Q1 in FIG. 14) and the third switching transistor Q3 (i.e., S-Q3 in FIG. 14) are at a low level, and the switches S1 to S4 (i.e., S-S1, S-S2, S-S3, and S-S4 in FIG. 14) are all at a low level.

With respect to the dead time period, the switches S1 to S4 are all in the off state, and there is no need to transmit currents through the first node AC1 and the second node AC2.

Within the first dead time period, the first switching transistor Q1, the second switching transistor Q2, and the third switching transistor Q3 are all in the off state, the fourth switching transistor Q4 is in the on state, and the switches S1 to S4 are all in the off state. Therefore, the first switching transistor Q1 (i.e., S-Q1 in FIG. 14), the second switching transistor Q2 (i.e., S-Q2 in FIG. 14), and the third switching transistor Q3 (i.e., S-Q3 in FIG. 14) are all at a low level, the fourth switching transistor Q4 (i.e., S-Q4 in FIG. 14) is at a high level, and the switches S1 to S4 (i.e., S-S1, S-S2, S-S3, and S-S4 in FIG. 14) are all at a low level.

Within the second dead time period, the first switching transistor Q1, the second switching transistor Q2, and the third switching transistor Q3 are all in the off state, the fourth switching transistor Q4 is in the on state, and the switches S1 to S4 are all in the off state. Therefore, the first switching transistor Q1 (i.e., S-Q1 in FIG. 14), the second switching transistor Q2 (i.e., S-Q2 in FIG. 14), and the third switching transistor Q3 (i.e., S-Q3 in FIG. 14) are all at a low level, the fourth switching transistor Q4 (i.e., S-Q4 in FIG. 14) is at a high level, and the switches S1 to S4 (i.e., S-S1, S-S2, S-S3, and S-S4 in FIG. 14) are all at a low level.

Still referring to FIG. 14, in the modulation mode, within the non-dead time period, the third switching transistor Q3 is constantly in the off state (or constantly turned off), the fourth switching transistor Q4 is constantly in the on state (or constantly turned on), and the timing of the first switching transistor Q1 and the second switching transistor Q2 is as follows: in a case that a body diode of one of the first switching transistor Q1 and the second switching transistor Q2 is detected to be turned on, a switching transistor, whose body diode is detected to be turned on, is controlled to be turned on; or in a case that a current flowing through one of the first switching transistor Q1 and the second switching transistor Q2 is detected to cross zero, a switching transistor, whose current is detected to cross zero, is controlled to be turned off.

Within the first non-dead time period, the first switching transistor Q1 and the fourth switching transistor Q4 are in the on state, and the second switching transistor Q2 and the third switching transistor Q3 are in the off state. The switches S1 to S4 are all in the off state. Therefore, the first switching transistor Q1 (i.e., S-Q1 in FIG. 14) and the fourth switching transistor Q4 (i.e., S-Q4 in FIG. 14) are at a high level, the second switching transistor Q2 (i.e., S-Q2 in FIG. 14) and the third switching transistor Q3 (i.e., S-Q3 in FIG. 14) are at a low level, and the switches S1 to S4 (i.e., S-S1, S-S2, S-S3, and S-S4 in FIG. 14) are all at a low level.

Within the second non-dead time period, the second switching transistor Q2 and the fourth switching transistor Q4 are in the on state, and the first switching transistor Q1 and the third switching transistor Q3 are in the off state. The switches S1 to S4 are all in the off state. Therefore, the second switching transistor Q2 (i.e., S-Q2 in FIG. 14) and the fourth switching transistor Q4 (i.e., S-Q4 in FIG. 14) are at a high level, the first switching transistor Q1 (i.e., S-Q1 in FIG. 14) and the third switching transistor Q3 (i.e., S-Q3 in FIG. 14) are at a low level, and the switches S1 to S4 (i.e., S-S1, S-S2, S-S3, and S-S4 in FIG. 14) are all at a low level.

Within the first dead time period, the voltage at the first node AC1 falls. In this case, the second switch S2, the third switch S3, and the fourth switch S4 are controlled to be turned off, and the first switch S1 is controlled to be turned on. The first constant-current source M1 transmits an injection current is to the first node AC1 via the first switch S1, such that the voltage fall at the first node AC1 is decelerated. Therefore, the first switch S1 (i.e., S-S1 in FIG. 14) is at a high level, and the second switch S2 (i.e., S-S2 in FIG. 14), the third switch S3 (i.e., S-S3 in FIG. 14), and the fourth switch S4 (i.e., S-S4 in FIG. 14) are all at a low level.

Within the second dead time period, the voltage at the first node AC1 rises. In this case, the first switch S1, the third switch S3, and the fourth switch S4 are controlled to be turned off, and the second switch S2 is controlled to be turned on. The first node AC1 transmits the discharging current to the ground via the second switch S2, such that the voltage rise at the first node AC1 is decelerated. Therefore, the first switch S1 (i.e., S-S1 in FIG. 11), the third switch S3 (i.e., S-S3 in FIG. 11), and the fourth switch S4 (i.e., S-S4 in FIG. 11) are all at a low level, and the second switch S2 (i.e., S-S2 in FIG. 11) is at a high level.

It can be understood that the high level in the timing of the switching transistors Q1 to Q4 in FIG. 14 corresponds to the on state, and the low level corresponds to the off state. Similarly, the high level in the timing of the switches S1 to S4 in FIG. 14 corresponds to the on state, and the low level corresponds to the off state.

In the method according to the fourth embodiment, in the modulation mode, the change rate of the voltage at the first node AC1 decreases. As illustrated by dashed-line portions of the first node AC1 in FIG. 14, a slope of the voltage rise and voltage fall at the first node AC1 becomes smaller within the dead time period. As illustrated by dashed-line portions of S-Q1 within the second dead time period in FIG. 14, the first switching transistor Q1 is turned on with a delay. As illustrated by dashed-line portions of S-Q2 within the first dead time period in FIG. 14, the second switching transistor Q2 is turned on with a delay.

With respect to the fourth embodiment, the present disclosure provides a logic control circuit 100. The logic control circuit 100 is configured to acquire the control signals (i.e., S-S1, S-S2, S-S3, S-S4) of the switches S1 to S4 based on the state signals (i.e., S-Q1, S-Q2, S-Q3, S-Q4) of the switching transistors Q1 to Q4 respectively.

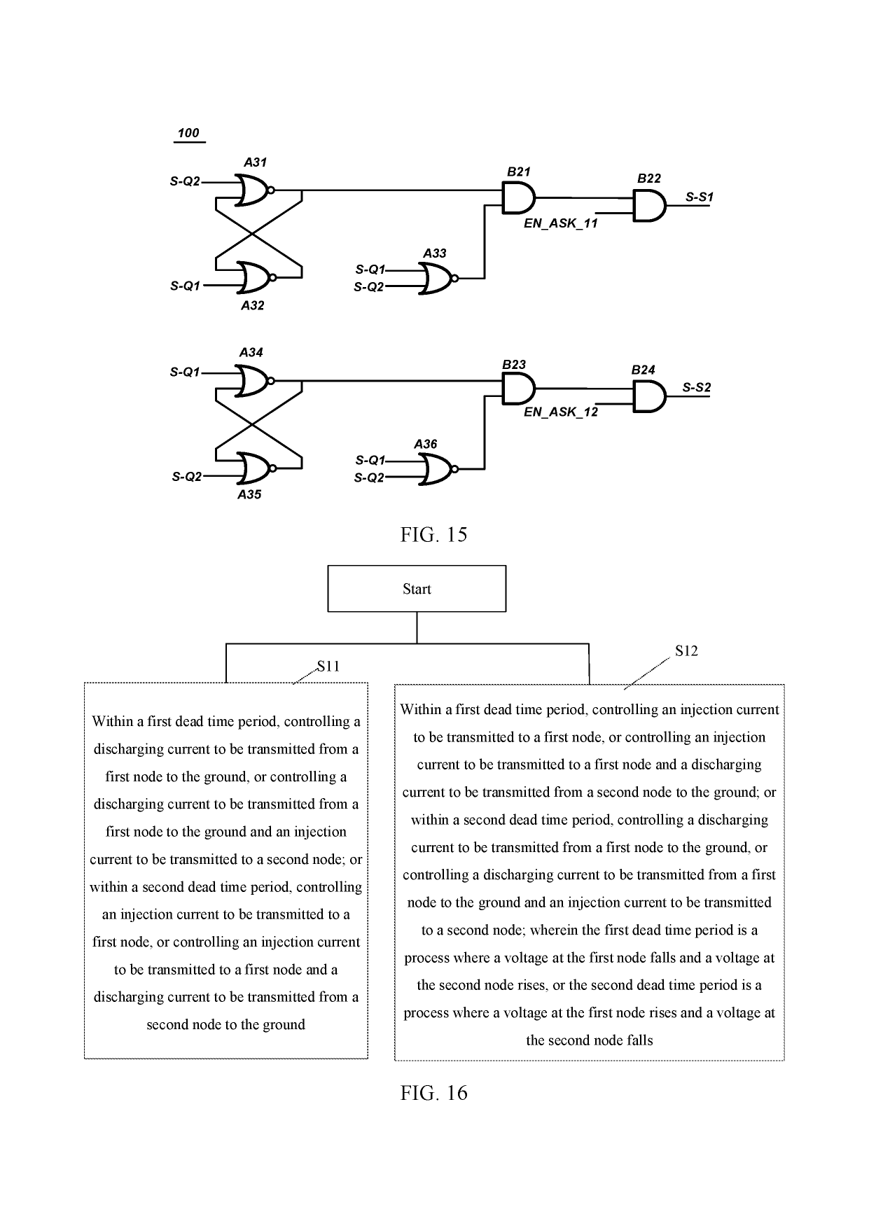

Referring to FIG. 15, the logic control circuit 100 includes a thirty-first NOR gate A31, a thirty-second NOR gate A32, a thirty-third NOR gate A33, a thirty-fourth NOR gate A34, a thirty-fifth NOR gate A35, a thirty-sixth NOR gate A36, a twenty-first AND gate B21, a twenty-second AND gate B22, a twenty-third AND gate B23, and a twenty-fourth AND gate B24.

A first input terminal of the thirty-first NOR gate A31 is configured to receive the state signal S-Q2 of the second switching transistor Q2, a second input terminal of the thirty-first NOR gate A31 is electrically connected to an output terminal of the thirty-second NOR gate A32, and an output terminal of the thirty-first NOR gate A31 is electrically connected to a first input terminal of the thirty-second NOR gate A32 and a first input terminal of the twenty-first AND gate B21.

A second input terminal of the thirty-second NOR gate A32 is configured to receive the state signal S-Q1 of the first switching transistor Q1.

A first input terminal of the thirty-third NOR gate A33 is configured to receive the state signal S-Q1 of the first switching transistor Q1, a second input terminal of the thirty-third NOR gate A33 is configured to receive the state signal S-Q2 of the second switching transistor Q2, and an output terminal of the thirty-third NOR gate A33 is electrically connected to a second input terminal of the twenty-first AND gate B21.

An output terminal of the twenty-first AND gate B21 is electrically connected to a first input terminal of the twenty-second AND gate B22, a second input terminal of the twenty-second AND gate B22 is configured to receive an eleventh modulation enable signal EN_ASK_11, and an output terminal of the twenty-second AND gate B22, as the control signal terminal of the first switch S1, is configured to output the control signal S-S1 of the first switch S1.

A first input terminal of the thirty-fourth NOR gate A34 is configured to receive the state signal S-Q1 of the first switching transistor Q1, a second input terminal of the thirty-fourth NOR gate A34 is electrically connected to an output terminal of the thirty-fifth NOR gate A35, and an output terminal of the thirty-fourth NOR gate A34 is electrically connected to a first input terminal of the thirty-fifth NOR gate A35 and a first input terminal of the twenty-third AND gate B23.

A second input terminal of the thirty-fifth NOR gate A35 is configured to receive the state signal S-Q2 of the second switching transistor Q2.

A first input terminal of the thirty-sixth NOR gate A36 is configured to receive the state signal S-Q1 of the first switching transistor Q1, a second input terminal of the thirty-sixth NOR gate A36 is configured to receive the state signal S-Q2 of the second switching transistor Q2, and an output terminal of the thirty-sixth NOR gate A36 is electrically connected to a second input terminal of the twenty-third AND gate B23.

An output terminal of the twenty-third AND gate B23 is electrically connected to a first input terminal of the twenty-fourth AND gate B24, a second input terminal of the twenty-fourth AND gate B24 is configured to receive a twelfth modulation enable signal EN_ASK_12, and an output terminal of the twenty-fourth AND gate B24, as the control signal terminal of the second switch S2, is configured to output the control signal S-S2 of the second switch S2.

In the fourth embodiment, the eleventh modulation enable signal EN_ASK_11 and the twelfth modulation enable signal EN_ASK_12 in the logic control circuit are configured to gate or enable the modulation mode and the non-modulation mode. The logic control circuit acquires the control signals (i.e., S-S1, S-S2) of the first switch S1 and the second switch S2 based on the state signals (i.e., S-Q1, S-Q2) of the first switching transistor Q1 and the second transistor Q2 respectively, and controls the states of the first switch S1 and the second switch S2 based on the control signals of the first switch S1 and the second switch S2 respectively. Within the dead time period, the constant-current source circuit is controlled that the discharging current is transmitted from the first node to the ground or the injection current is transmitted to the first node, such that the change rate of the voltage at the first node decreases, that is, the change rate of the voltage at the first node changes, which equivalently changes an output impedance of the receiver. In this way, a current in the receive coil changes, and hence a current in a transmit coil changes, such that ASK modulation is achieved. In this way, ASK modulation is not affected while the off-chip capacitors, the on-chip switching transistors, and the chip pins are reduced or eliminated.

In all the embodiments of the present disclosure, with respect to the full-bridge operating mode and the half-bridge operating mode, in the modulation mode, within the dead time period, the constant-current source circuit is controlled that the discharging current is transmitted from the first node or the second node to the ground or the injection current is transmitted to the first node or the second node, such that the change rates of the voltages at the first node and the second node change respectively, which is equivalent to the capacitance modulation method for changing off-chip capacitors. In this way, ASK modulation is achieved. Specifically, the first embodiment and the second embodiment are directed to the full-bridge operating state, and the constant-current source circuit is controlled that the discharging current is transmitted from the first node or the second node to the ground or the injection current is transmitted to the first node or the second node within the dead time period, such that the change rates of the voltages at the first node and the second node increase or decrease respectively, and hence ASK modulation is achieved. The third embodiment and the fourth embodiment are directed to the half-bridge operating state, and the constant-current source circuit is controlled that the discharging current is transmitted from the first node or the second node to the ground or the injection current is transmitted to the first node or the second node within the dead time period, such that the change rates of the voltages at the first node and the second node increase or decrease respectively, and hence ASK modulation is achieved. In the methods according to the four embodiments of the present disclosure, the change rates of the voltages at the first node and the second node change respectively, which equivalently changes an output impedance of the receiver. In this way, a current in the receive coil changes, and hence a current in a transmit coil changes, such that ASK modulation is achieved. In this way, ASK modulation is not affected while the off-chip capacitors, the on-chip switching transistors, and the chip pins are reduced or eliminated.

In some embodiments, with respect to the half-bridge operating state: in the non-modulation mode, the logic control circuit is configured to: within the first dead time period, control the first switch to switch from the off state to the on state, such that the first constant-current source transmits an injection current to the first node via the first switch; or within the second dead time period, control the second switch to switch from the off state to the on state, such that the first node transmits the discharging current to the ground via the second switch and the second constant-current source.

In the modulation mode, the logic control circuit is configured to control the first switch, the second switch, the third switch, and the fourth switch to be in the off state.

The embodiment herein differs from the fourth embodiment only in that the modulation mode and the non-modulation mode may be interchanged. Specifically, the modulation mode in the fourth embodiment is replaced with the non-modulation mode, and the non-modulation mode in the fourth embodiment is replaced with the modulation mode. That is, in the modulation mode, the constant-current source circuit does not operate, and there is no need to transmit currents through the first node AC1 and the second node AC2; and in the non-modulation mode, the constant-current source circuit is controlled to transmit currents through the first node AC1 and the second node AC2. Control logic in the embodiment herein of the present disclosure is the same as that in the fourth embodiment, which is thus not described herein any further.

Some embodiments of the present disclosure provide an ASK modulation method. Referring to FIG. 16, the method is applicable to the ASK modulation circuit as described above. The method may include one of step S11 and step S12.

In S11, within a first dead time period, controlling, by a logic control circuit, a discharging current to be transmitted from a first node to the ground, or controlling, by a logic control circuit, a discharging current to be transmitted from a first node to the ground and an injection current to be transmitted to a second node; or within a second dead time period, controlling, by a logic control circuit, an injection current to be transmitted to a first node, or an injection current to be transmitted to a first node and a discharging current to be transmitted from a second node to the ground.

In S12, within a first dead time period, controlling, by a logic control circuit, an injection current to be transmitted to a first node, or an injection current to be transmitted to a first node and a discharging current to be transmitted from a second node to the ground; or within a second dead time period, controlling, by a logic control circuit, a discharging current to be transmitted from a first node to the ground, or a discharging current to be transmitted from a first node to the ground and an injection current to be transmitted to a second node.

The first dead time period is a process where a voltage at the first node falls and a voltage at the second node rises, or the second dead time period is a process where a voltage at the first node rises and a voltage at the second node falls.

In some embodiments, S11 further includes: with respect to a full-bridge operating state: in a modulation mode, within the first dead time period, controlling the second switch and the third switch to switch from an off state to an on state, such that the first node transmits the discharging current to the ground via the second switch and the second constant-current source and the third constant-current source transmits the injection current to the second node via the third switch; or within the second dead time period, controlling the first switch and the fourth switch to switch from an off state to an on state, such that the first constant-current source transmits the injection current to the first node via the first switch and the second node transmits the discharging current to the ground via the fourth switch and the fourth constant-current source.

The method further includes: S13, in a non-modulation mode, controlling the first switch, the second switch, the third switch, and the fourth switch to be in the off state.

In some embodiments, S11 further includes: with respect to the full-bridge operating state: in the non-modulation mode, within the first dead time period, controlling the second switch and the third switch to switch from the off state to the on state, such that the first node transmits the discharging current to the ground via the second switch and the second constant-current source and the third constant-current source transmits the injection current to the second node via the third switch; or within the second dead time period, controlling the first switch and the fourth switch to switch from the off state to the on state, such that the first constant-current source transmits the injection current to the first node via the first switch and the second node transmits the discharging current to the ground via the fourth switch and the fourth constant-current source.

The method further includes: S13, in the modulation mode, controlling the first switch, the second switch, the third switch, and the fourth switch to be in the off state.

In some embodiments, S12 includes: with respect to the full-bridge operating state: in the modulation mode, within the first dead time period, controlling the first switch and the fourth switch to switch from the off state to the on state, such that the first constant-current source transmits the injection current to the first node via the first switch and the second node transmits the discharging current to the ground via the fourth switch and the fourth constant-current source; or within the second dead time period, controlling the second switch and the third switch to switch from the off state to the on state, such that the first node transmits the discharging current to the ground via the second switch and the second constant-current source and the third constant-current source transmits the injection current to the second node via the third switch.

The method further includes: S13, in a non-modulation mode, controlling the first switch, the second switch, the third switch, and the fourth switch to be in the off state.

In some embodiments, S12 further includes: with respect to the full-bridge operating state: in the non-modulation mode, within the first dead time period, controlling the first switch and the fourth switch to switch from the off state to the on state, such that the first constant-current source transmits the injection current to the first node via the first switch and the second node transmits the discharging current to the ground via the fourth switch and the fourth constant-current source; or within the second dead time period, controlling the second switch and the third switch to switch from the off state to the on state, such that the first node transmits the discharging current to the ground via the second switch and the second constant-current source and the third constant-current source transmits the injection current to the second node via the third switch.

The method further includes: S13, in the modulation mode, controlling the first switch, the second switch, the third switch, and the fourth switch to be in the off state.

In some embodiments, S11 further includes: with respect to a half-bridge operating state: in the modulation mode, within the first dead time period, controlling the second switch to switch from the off state to the on state, such that the first node transmits the discharging current to the ground via the second switch and the second constant-current source; or within the second dead time period, controlling the first switch to switch from the off state to the on state, such that the first constant-current source transmits the injection current to the first node via the first switch.

The method further includes: S13, in a non-modulation mode, controlling the first switch, the second switch, the third switch, and the fourth switch to be in the off state.

In some embodiments, S11 further includes: with respect to the half-bridge operating state: in the non-modulation mode, within the first dead time period, controlling the second switch to switch from the off state to the on state, such that the first node transmits the discharging current to the ground via the second switch and the second constant-current source; or within the second dead time period, controlling the first switch to switch from the off state to the on state, such that the first constant-current source transmits the injection current to the first node via the first switch.

The method further includes: S13, in the modulation mode, controlling the first switch, the second switch, the third switch, and the fourth switch to be in the off state.

In some embodiments, S12 further includes: with respect to the half-bridge operating state: in the modulation mode, within the first dead time period, controlling the first switch to switch from the off state to the on state, such that the first constant-current source transmits the injection current to the first node via the first switch; or within the second dead time period, controlling the second switch to switch from the off state to the on state, such that the first node transmits the discharging current to the ground via the second switch and the second constant-current source.

The method further includes: in S13, in a non-modulation mode, controlling the first switch, the second switch, the third switch, and the fourth switch to be in the off state.

In some embodiments, S12 further includes: with respect to the half-bridge operating state, in the non-modulation mode: within the first dead time period, controlling the first switch to switch from the off state to the on state, such that the first constant-current source transmits the injection current to the first node via the first switch; or within the second dead time period, controlling the second switch to switch from the off state to the on state, such that the first node transmits the discharging current to the ground via the second switch and the second constant-current source.

The method further includes: in S13, in the modulation mode, controlling the first switch, the second switch, the third switch, and the fourth switch to be in the off state.

In some embodiments, the method further includes: S14, within a non-dead time period, controlling the first switch, the second switch, the third switch, and the fourth switch to be in the off state, wherein the non-dead time period is a process where the voltage at the first node and the voltage at the second node both remain unchanged.

Some embodiments of the present disclosure provide a wireless charging receiver. The wireless charging receiver includes a receive coil, the rectifier circuit, the logic control circuit and the constant-current source circuit as described above.

The receive coil is electrically connected to the rectifier circuit, the logic control circuit is electrically connected to the constant-current source circuit, and the constant-current source circuit is electrically connected to the rectifier circuit.

The logic control circuit is configured to modulate a control signal using the ASK modulation method as described above, and transmit, via the receive coil, the modulated control signal to the transmit coil magnetically coupled to the receive coil, wherein the control signal is modulated by controlling the constant-current source circuit to change a current of the receive coil.

Some embodiments of the present disclosure provide a wireless charging receiver. The wireless charging receiver includes a receive coil, a rectifier, and a communication module, wherein the communication module includes a processor and a memory.

The memory is configured to store a computer program.

The processor is configured to run the computer program stored on the memory to perform the ASK modulation method applicable to the wireless charging receiver as described above.

The memory may include a random-access memory (RAM), or may also include a non-volatile memory, for example, at least one magnetic disk memory. Optionally, the memory may also be at least one storage device positioned away from the processor as described above.

It should be understood that the processor may be a general purpose processor, including a central processing unit (CPU), a network processor (NP), or the like, or may be a digital signal processor (DSP), an application specific integrated circuit (ASIC), a field-programmable gate array (FPGA), or another programmable logic device, a discrete gate or transistor logic device, or a discrete hardware component.

Some embodiments of the present disclosure provide a chip. The chip includes the ASK modulation circuit applicable to the wireless charging receiver as described above.

Some embodiments of the present disclosure provide an electronic device. The electronic device includes the chip as described above.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. An amplitude shift keying (ASK) modulation circuit, comprising: a logic control circuit, a rectifier circuit, and a constant-current source circuit; wherein
the rectifier circuit comprises a first bridge arm and a second bridge arm, the first bridge arm and the second bridge arm being connected in parallel, the first bridge arm comprising a first switching transistor and a second switch transistor, the second bridge arm comprising a third switching transistor and a fourth switching transistor, wherein the first switching transistor and the second switching transistor are connected in series, and the third switching transistor and the fourth switching transistor are connected in series;
the constant-current source circuit comprises a first constant-current assembly, a second constant-current assembly, a third constant-current assembly, and a fourth constant-current assembly, wherein the first constant-current assembly is connected in parallel between a first terminal and a second terminal of the first switching transistor, the second constant-current assembly is connected in parallel between a first terminal and a second terminal of the second switching transistor, the third constant-current assembly is connected in parallel between a first terminal and the second terminal of the third switching transistor, and the fourth constant-current assembly is connected in parallel between a first terminal and a second terminal of the fourth switching transistor;
a connection point between the second terminal of the first switching transistor and the first terminal of the second switching transistor acts as a first node, and a connection point between the second terminal of the third switching transistor and the first terminal of the fourth switching transistor acts as a second node; and
the logic control circuit is configured to: within a first dead time period, control the first node to transmit a discharging current to the ground via the second constant-current assembly, or control the first node to transmit a discharging current to the ground via the second constant-current assembly and the third constant-current assembly to transmit an injection current to the second node; or within a second dead time period, control the first constant-current assembly to transmit an injection current to the first node, or control the first constant-current assembly to transmit an injection current to the first node and the second node to transmit a discharging current to the ground via the fourth constant-current assembly;
or
the logic control circuit is further configured to: within a first dead time period, control the first constant-current assembly to transmit an injection current to the first node, or control the first constant-current assembly to transmit an injection current to the first node and the second node to transmit a discharging current to the ground via the fourth constant-current assembly; or within a second dead time period, control the first node to transmit a discharging current to the ground via the second constant-current assembly, or control the first node to transmit a discharging current to the ground via the second constant-current assembly and the third constant-current assembly to transmit an injection current to the second node;
wherein the first dead time period is a process where a voltage at the first node falls and a voltage at the second node rises, and the second dead time period is a process where a voltage at the first node rises and a voltage at the second node falls.

2. The ASK modulation circuit according to claim 1, wherein the first constant-current assembly comprises a first constant-current source and a first switch, wherein the first constant-current source and the first switch are connected in series; the second constant-current assembly comprises a second constant-current source and a second switch, wherein the second constant-current source and the second switch are connected in series; the third constant-current assembly comprises a third constant-current source and a third switch, wherein the third constant-current source and the third switch are connected in series; and the fourth constant-current assembly comprises a fourth constant-current source and a fourth switch, wherein the fourth constant-current source and the fourth switch are connected in series.

3. The ASK modulation circuit according to claim 2, wherein with respect to a full-bridge operating state:
in a modulation mode, the logic control circuit is configured to: within the first dead time period, control the second switch and the third switch to switch from an off state to an on state, such that the first node transmits the discharging current to the ground via the second switch and the second constant-current source and the third constant-current source transmits the injection current to the second node via the third switch; or within the second dead time period, control the first switch and the fourth switch to switch from an off state to an on state, such that the first constant-current source transmits the injection current to the first node via the first switch and the second node transmits the discharging current to the ground via the fourth switch and the fourth constant-current source; or
in a non-modulation mode, the logic control circuit is configured to control the first switch, the second switch, the third switch, and the fourth switch to be in an off state.

4. The ASK modulation circuit according to claim 2, wherein with respect to a full-bridge operating state:
in a non-modulation mode, the logic control circuit is configured to: within the first dead time period, control the second switch and the third switch to switch from an off state to an on state, such that the first node transmits the discharging current to the ground via the second switch and the second constant-current source and the third constant-current source transmits the injection current to the second node via the third switch; or within the second dead time period, control the first switch and the fourth switch to switch from an off state to an on state, such that the first constant-current source transmits the injection current to the first node via the first switch and the second node transmits the discharging current to the ground via the fourth switch and the fourth constant-current source; or
in a modulation mode, the logic control circuit is configured to control the first switch, the second switch, the third switch, and the fourth switch to be in an off state.

5. The ASK modulation circuit according to claim 2, wherein with respect to a full-bridge operating state:
in a modulation mode, the logic control circuit is configured to: within the first dead time period, control the first switch and the fourth switch to switch from an off state to an on state, such that the first constant-current source transmits the injection current to the first node via the first switch and the second node transmits the discharging current to the ground via the fourth switch and the fourth constant-current source; or within the second dead time period, control the second switch and the third switch to switch from an off state to an on state, such that the first node transmits the discharging current to the ground via the second switch and the second constant-current source and the third constant-current source transmits the injection current to the second node via the third switch; or
in a non-modulation mode, the logic control circuit is configured to control the first switch, the second switch, the third switch, and the fourth switch to be in an off state.

6. The ASK modulation circuit according to claim 2, wherein with respect to a full-bridge operating state:
in a non-modulation mode, the logic control circuit is configured to: within the first dead time period, control the first switch and the fourth switch to switch from an off state to an on state, such that the first constant-current source transmits the injection current to the first node via the first switch and the second node transmits the discharging current to the ground via the fourth switch and the fourth constant-current source; or within the second dead time period, control the second switch and the third switch to switch from an off state to an on state, such that the first node transmits the discharging current to the ground via the second switch and the second constant-current source and the third constant-current source transmits the injection current to the second node via the third switch; or
in a modulation mode, the logic control circuit is configured to control the first switch, the second switch, the third switch, and the fourth switch to be in an off state.

7. The ASK modulation circuit according to claim 2, wherein with respect to a half-bridge operating state:
in a modulation mode, the logic control circuit is configured to: within the first dead time period, control the second switch to switch from an off state to an on state, such that the first node transmits the discharging current to the ground via the second switch and the second constant-current source; or within the second dead time period, control the first switch to switch from an off state to an on state, such that the first constant-current source transmits the injection current to the first node via the first switch; or
in a non-modulation mode, the logic control circuit is configured to control the first switch, the second switch, the third switch, and the fourth switch to be in an off state.

8. The ASK modulation circuit according to claim 2, wherein with respect to a half-bridge operating state:
in a non-modulation mode, the logic control circuit is configured to: within the first dead time period, control the second switch to switch from an off state to an on state, such that the first node transmits the discharging current to the ground via the second switch and the second constant-current source; or within the second dead time period, control the first switch to switch from an off state to an on state, such that the first constant-current source transmits the injection current to the first node via the first switch; or
in a modulation mode, the logic control circuit is configured to control the first switch, the second switch, the third switch, and the fourth switch to be in an off state.

9. The ASK modulation circuit according to claim 2, wherein with respect to a half-bridge operating state:
in a modulation mode, the logic control circuit is configured to: within the first dead time period, control the first switch to switch from an off state to an on state, such that the first constant-current source transmits the injection current to the first node via the first switch; or within the second dead time period, control the second switch to switch from an off state to an on state, such that the first node transmits the discharging current to the ground via the second switch and the second constant-current source; or
in a non-modulation mode, the logic control circuit is configured to control the first switch, the second switch, the third switch, and the fourth switch to be in an off state.

10. The ASK modulation circuit according to claim 2, wherein with respect to a half-bridge operating state:
in a non-modulation mode, the logic control circuit is configured to: within the first dead time period, control the first switch to switch from an off state to an on state, such that the first constant-current source transmits the injection current to the first node via the first switch; or within the second dead time period, control the second switch to switch from an off state to an on state, such that the first node transmits the discharging current to the ground via the second switch and the second constant-current source; or
in a modulation mode, the logic control circuit is configured to control the first switch, the second switch, the third switch, and the fourth switch to be in an off state.

11. An amplitude shift keying (ASK) modulation method, applicable to an ASK modulation circuit, wherein the ASK modulation circuit comprises: a logic control circuit, a rectifier circuit, and a constant-current source circuit; wherein
the rectifier circuit comprises a first bridge arm and a second bridge arm, the first bridge arm and the second bridge arm being connected in parallel, the first bridge arm comprising a first switching transistor and a second switch transistor, the second bridge arm comprising a third switching transistor and a fourth switching transistor, wherein the first switching transistor and the second switching transistor are connected in series, and the third switching transistor and the fourth switching transistor are connected in series;
the constant-current source circuit comprises a first constant-current assembly, a second constant-current assembly, a third constant-current assembly, and a fourth constant-current assembly, wherein the first constant-current assembly is connected in parallel between a first terminal and a second terminal of the first switching transistor, the second constant-current assembly is connected in parallel between a first terminal and a second terminal of the second switching transistor, the third constant-current assembly is connected in parallel between a first terminal and the second terminal of the third switching transistor, and the fourth constant-current assembly is connected in parallel between a first terminal and a second terminal of the fourth switching transistor; and
a connection point between the second terminal of the first switching transistor and the first terminal of the second switching transistor acts as a first node, and a connection point between the second terminal of the third switching transistor and the first terminal of the fourth switching transistor acts as a second node;
wherein the method comprises:
within a first dead time period, controlling, by the logic control circuit, the first node to transmit a discharging current to the ground via the second constant-current assembly, or controlling, by the logic control circuit, the first node to transmit a discharging current to the ground via the second constant-current assembly and the third constant-current assembly to transmit an injection current to the second node; or within a second dead time period, controlling, by the logic control circuit, the first constant-current assembly to transmit an injection current to the first node, or controlling, by the logic control circuit, the first constant-current assembly to transmit an injection current to the first node and the second node to transmit a discharging current to the ground via the fourth constant-current assembly;
or
within a first dead time period, controlling, by the logic control circuit, the first constant-current assembly to transmit an injection current to the first node, or controlling, by the logic control circuit, the first constant-current assembly to transmit an injection current to the first node and the second node to transmit a discharging current to the ground via the fourth constant-current assembly; or within a second dead time period, controlling, by the logic control circuit, the first node to transmit a discharging current to the ground via the second constant-current assembly, or controlling, by the logic control circuit, the first node to transmit a discharging current to the ground via the second constant-current assembly and the third constant-current assembly to transmit an injection current to the second node;
wherein the first dead time period is a process where a voltage at the first node falls and a voltage at the second node rises, and the second dead time period is a process where a voltage at the first node rises and a voltage at the second node falls.

12. The method according to claim 11, wherein
the first constant-current assembly comprises a first constant-current source and a first switch, wherein the first constant-current source and the first switch are connected in series; the second constant-current assembly comprises a second constant-current source and a second switch, wherein the second constant-current source and the second switch are connected in series; the third constant-current assembly comprises a third constant-current source and a third switch, wherein the third constant-current source and the third switch are connected in series; and the fourth constant-current assembly comprises a fourth constant-current source and a fourth switch, wherein the fourth constant-current source and the fourth switch are connected in series; and
with respect to a full-bridge operating state, the method further comprises:
in a modulation mode, controlling, by the logic control circuit, within the first dead time period, the second switch and the third switch to switch from an off state to an on state, such that the first node transmits the discharging current to the ground via the second switch and the second constant-current source and the third constant-current source transmits the injection current to the second node via the third switch; or controlling, by the logic control circuit, within the second dead time period, the first switch and the fourth switch to switch from an off state to an on state, such that the first constant-current source transmits the injection current to the first node via the first switch and the second node transmits the discharging current to the ground via the fourth switch and the fourth constant-current source; or
in a non-modulation mode, controlling, by the logic control circuit, the first switch, the second switch, the third switch, and the fourth switch to be in an off state.

13. The method according to claim 11, wherein
the first constant-current assembly comprises a first constant-current source and a first switch, wherein the first constant-current source and the first switch are connected in series; the second constant-current assembly comprises a second constant-current source and a second switch, wherein the second constant-current source and the second switch are connected in series; the third constant-current assembly comprises a third constant-current source and a third switch, wherein the third constant-current source and the third switch are connected in series; and the fourth constant-current assembly comprises a fourth constant-current source and a fourth switch, wherein the fourth constant-current source and the fourth switch are connected in series; and
with respect to a full-bridge operating state, the method further comprises:
in a non-modulation mode, controlling, by the logic control circuit, within the first dead time period, the second switch and the third switch to switch from an off state to an on state, such that the first node transmits the discharging current to the ground via the second switch and the second constant-current source and the third constant-current source transmits the injection current to the second node via the third switch; or controlling, by the logic control circuit, within the second dead time period, the first switch and the fourth switch to switch from an off state to an on state, such that the first constant-current source transmits the injection current to the first node via the first switch and the second node transmits the discharging current to the ground via the fourth switch and the fourth constant-current source; or
in a modulation mode, controlling, by the logic control circuit, the first switch, the second switch, the third switch, and the fourth switch to be in an off state.

14. The method according to claim 11, wherein
the first constant-current assembly comprises a first constant-current source and a first switch, wherein the first constant-current source and the first switch are connected in series; the second constant-current assembly comprises a second constant-current source and a second switch, wherein the second constant-current source and the second switch are connected in series; the third constant-current assembly comprises a third constant-current source and a third switch, wherein the third constant-current source and the third switch are connected in series; and the fourth constant-current assembly comprises a fourth constant-current source and a fourth switch, wherein the fourth constant-current source and the fourth switch are connected in series; and
with respect to a full-bridge operating state, the method further comprises:
in a modulation mode, controlling, by the logic control circuit, within the first dead time period, the first switch and the fourth switch to switch from an off state to an on state, such that the first constant-current source transmits the injection current to the first node via the first switch and the second node transmits the discharging current to the ground via the fourth switch and the fourth constant-current source; or controlling, by the logic control circuit, within the second dead time period, the second switch and the third switch to switch from an off state to an on state, such that the first node transmits the discharging current to the ground via the second switch and the second constant-current source and the third constant-current source transmits the injection current to the second node via the third switch; or
in a non-modulation mode, controlling, by the logic control circuit, the first switch, the second switch, the third switch, and the fourth switch to be in an off state.

15. The method according to claim 11, wherein
the first constant-current assembly comprises a first constant-current source and a first switch, wherein the first constant-current source and the first switch are connected in series; the second constant-current assembly comprises a second constant-current source and a second switch, wherein the second constant-current source and the second switch are connected in series; the third constant-current assembly comprises a third constant-current source and a third switch, wherein the third constant-current source and the third switch are connected in series; and the fourth constant-current assembly comprises a fourth constant-current source and a fourth switch, wherein the fourth constant-current source and the fourth switch are connected in series; and
with respect to a full-bridge operating state, the method further comprises:
in a non-modulation mode, controlling, by the logic control circuit, within the first dead time period, the first switch and the fourth switch to switch from an off state to an on state, such that the first constant-current source transmits the injection current to the first node via the first switch and the second node transmits the discharging current to the ground via the fourth switch and the fourth constant-current source; or controlling, by the logic control circuit, within the second dead time period, the second switch and the third switch to switch from an off state to an on state, such that the first node transmits the discharging current to the ground via the second switch and the second constant-current source and the third constant-current source transmits the injection current to the second node via the third switch; or
in a modulation mode, controlling, by the logic control circuit, the first switch, the second switch, the third switch, and the fourth switch to be in an off state.

16. The method according to claim 11, wherein
the first constant-current assembly comprises a first constant-current source and a first switch, wherein the first constant-current source and the first switch are connected in series; the second constant-current assembly comprises a second constant-current source and a second switch, wherein the second constant-current source and the second switch are connected in series; the third constant-current assembly comprises a third constant-current source and a third switch, wherein the third constant-current source and the third switch are connected in series; and the fourth constant-current assembly comprises a fourth constant-current source and a fourth switch, wherein the fourth constant-current source and the fourth switch are connected in series; and
with respect to a half-bridge operating state, the method further comprises:
in a modulation mode, controlling, by the logic control circuit, within the first dead time period, the second switch to switch from an off state to an on state, such that the first node transmits the discharging current to the ground via the second switch and the second constant-current source; or controlling, by the logic control circuit, within the second dead time period, the first switch to switch from an off state to an on state, such that the first constant-current source transmits the injection current to the first node via the first switch; or
in a non-modulation mode, controlling, by the logic control circuit, the first switch, the second switch, the third switch, and the fourth switch to be in an off state.

17. The method according to claim 11, wherein
the first constant-current assembly comprises a first constant-current source and a first switch, wherein the first constant-current source and the first switch are connected in series; the second constant-current assembly comprises a second constant-current source and a second switch, wherein the second constant-current source and the second switch are connected in series; the third constant-current assembly comprises a third constant-current source and a third switch, wherein the third constant-current source and the third switch are connected in series; and the fourth constant-current assembly comprises a fourth constant-current source and a fourth switch, wherein the fourth constant-current source and the fourth switch are connected in series; and
with respect to a half-bridge operating state, the method further comprises:
in a non-modulation mode, controlling, by the logic control circuit, within the first dead time period, the second switch to switch from an off state to an on state, such that the first node transmits the discharging current to the ground via the second switch and the second constant-current source; or controlling, by the logic control circuit, within the second dead time period, the first switch to switch from an off state to an on state, such that the first constant-current source transmits the injection current to the first node via the first switch; or
in a modulation mode, controlling, by the logic control circuit, the first switch, the second switch, the third switch, and the fourth switch to be in an off state.

18. The method according to claim 11, wherein
the first constant-current assembly comprises a first constant-current source and a first switch, wherein the first constant-current source and the first switch are connected in series; the second constant-current assembly comprises a second constant-current source and a second switch, wherein the second constant-current source and the second switch are connected in series; the third constant-current assembly comprises a third constant-current source and a third switch, wherein the third constant-current source and the third switch are connected in series; and the fourth constant-current assembly comprises a fourth constant-current source and a fourth switch, wherein the fourth constant-current source and the fourth switch are connected in series; and
with respect to a half-bridge operating state, the method further comprises:
in a modulation mode, controlling, by the logic control circuit, within the first dead time period, the first switch to switch from an off state to an on state, such that the first constant-current source transmits the injection current to the first node via the first switch; or controlling, by the logic control circuit, within the second dead time period, the second switch to switch from an off state to an on state, such that the first node transmits the discharging current to the ground via the second switch and the second constant-current source; or
in a non-modulation mode, controlling, by the logic control circuit, the first switch, the second switch, the third switch, and the fourth switch to be in an off state.

19. The method according to claim 11, wherein
the first constant-current assembly comprises a first constant-current source and a first switch, wherein the first constant-current source and the first switch are connected in series; the second constant-current assembly comprises a second constant-current source and a second switch, wherein the second constant-current source and the second switch are connected in series; the third constant-current assembly comprises a third constant-current source and a third switch, wherein the third constant-current source and the third switch are connected in series; and the fourth constant-current assembly comprises a fourth constant-current source and a fourth switch, wherein the fourth constant-current source and the fourth switch are connected in series; and
with respect to a half-bridge operating state, the method further comprises:
in a non-modulation mode, controlling, by the logic control circuit, within the first dead time period, the first switch to switch from an off state to an on state, such that the first constant-current source transmits the injection current to the first node via the first switch; or controlling, by the logic control circuit, within the second dead time period, the second switch to switch from an off state to an on state, such that the first node transmits the discharging current to the ground via the second switch and the second constant-current source; or
in a modulation mode, controlling, by the logic control circuit, the first switch, the second switch, the third switch, and the fourth switch to be in an off state.

20. A wireless charging receiver, comprising: a receive coil, and a rectifier circuit, a logic control circuit, and a constant-current source circuit, wherein
the receive coil is electrically connected to the rectifier circuit, the logic control circuit is electrically connected to the constant-current source circuit, and the constant-current source circuit is electrically connected to the rectifier circuit;
the rectifier circuit comprises a first bridge arm and a second bridge arm, the first bridge arm and the second bridge arm being connected in parallel, the first bridge arm comprising a first switching transistor and a second switch transistor, and the second bridge arm comprising a third switching transistor and a fourth switching transistor, wherein the first switching transistor and the second switching transistor are connected in series, and the third switching transistor and the fourth switching transistor are connected in series;
the constant-current source circuit comprises a first constant-current assembly, a second constant-current assembly, a third constant-current assembly, and a fourth constant-current assembly, wherein the first constant-current assembly is connected in parallel between a first terminal and a second terminal of the first switching transistor, the second constant-current assembly is connected in parallel between a first terminal and a second terminal of the second switching transistor, the third constant-current assembly is connected in parallel between a first terminal and the second terminal of the third switching transistor, and the fourth constant-current assembly is connected in parallel between a first terminal and a second terminal of the fourth switching transistor;
a connection point between the second terminal of the first switching transistor and the first terminal of the second switching transistor acts as a first node, and a connection point between the second terminal of the third switching transistor and the first terminal of the fourth switching transistor acts as a second node; and
the logic control circuit is configured to: within a first dead time period, control the first node to transmit a discharging current to the ground via the second constant-current assembly, or control the first node to transmit a discharging current to the ground via the second constant-current assembly and the third constant-current assembly to transmit an injection current to the second node; or within a second dead time period, control the first constant-current assembly to transmit an injection current to the first node, or control the first constant-current assembly to transmit an injection current to the first node and the second node to transmit a discharging current to the ground via the fourth constant-current assembly;
or
the logic control circuit is further configured to: within a first dead time period, control the first constant-current assembly to transmit an injection current to the first node, or control the first constant-current assembly to transmit an injection current to the first node and the second node to transmit a discharging current to the ground via the fourth constant-current assembly; or within a second dead time period, control the first node to transmit a discharging current to the ground via the second constant-current assembly, or control the first node to transmit a discharging current to the ground via the second constant-current assembly and the third constant-current assembly to transmit an injection current to the second node;
wherein the first dead time period is a process where a voltage at the first node falls and a voltage at the second node rises, and the second dead time period is a process where a voltage at the first node rises and a voltage at the second node falls.
